(19) United States
(12) Patent Application Publication
(10) Pub. No.: US 2007/0059458 A1
(43) Pub. Date: Mar. 15, 2007

(54) Cellulose acylate film, optically compensatory film, polarizing plate and liquid crystal display

(75) Inventors: Yosuke Nishiura, Odawara-shi (JP); Takako Nishiura, Odawara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/517,242

(22) Filed: Sep. 8, 2006

(30) Foreign Application Priority Data
Sep. 9, 2005 (JP) P2005-262186

(51) Int. Cl. C09K 19/00

(52) U.S. Cl. 428/1.31

(57) ABSTRACT

A cellulose acylate film is provided and satisfies the following relationships (I) and (II). The cellulose acylate film has a residual sulfuric acid content of 0 ppm to 100 ppm and contains a release accelerator in an amount of 10 ppm to 2,000 ppm.
0≦Re(630)≦10 and |Rth(630)|≦25 (I)
|Re(400)−Re(700)|≦10 and |Rth(400)−Rth(700)|≦35 (II) Re(λ) is an in-plane retardation value at a wavelength of λ nm, and Rth(λ) is a thickness-direction retardation value at a wavelength of λ nm.

### BACKGROUND OF THE INVENTION

1. Field of the Invention

The present invention relates to a cellulose acylate film useful in liquid crystal displays and a method for preparing the solution dope thereof. The present invention also relates to an optical material such as optically compensatory film and polarizing plate and a liquid crystal display comprising such a cellulose acylate film.

2. Description of Background Art

A cellulose acylate film has heretofore been used for photographic support and various optical materials due to its toughness and fire retardance. In particular, in recent years, the cellulose acylate film has been widely used as an optical transparent film for liquid crystal display. Because of its high optical transparency and high optical isotropy, the cellulose acylate film is an excellent optical material for devices that handle polarization such as liquid crystal display and thus has been heretofore used as protective film for polarizer or support for optically compensatory film capable of improving display as viewed in oblique direction (viewing angle compensation).

A polarizing plate which is one of members of a liquid crystal display has a polarizer protective film stuck to at least one side of a polarizer. An ordinary polarizer is obtained by dyeing a stretched polyvinyl alcohol (PVA)-based film with iodine or a dichroic dye. In most cases, as the protective film for polarizer there is used a cellulose acylate film, particularly triacetyl cellulose film, which can be directly stuck to PVA. It is important that the protective film for polarizer is excellent in optical isotropy. The optical properties of the protective film for polarizer drastically govern the properties of the polarizing plate. It is also important that the protective film renders the polarizer durable and exhibits a good durability itself. Thus, it is required that the protective film undergo no coloration with time under high temperature and humidity conditions.

The recent liquid crystal displays, particularly IPS mode liquid crystal displays, have been required to have improvement in viewing angle properties and enhancement of durability. The optically transparent films such as protective film for polarizer and support for optically compensatory film have been required to be optically isotropic more stably. In order that the optical film might be optically isotropic, it is important that the retardation value represented by the product of the birefringence and the thickness of the optical resin film is small. In particular, it is necessary that not only the in-plane retardation (Re) but also the thickness-direction retardation (Rth) of the optical film be reduced to improve display as viewed in oblique direction. In some detail, when the optical properties of the optically transparent film are evaluated, it is required that Re as measured on the front side of the film be small and, even when measured at varying angles, Re show no change.

Although there have heretofore been cellulose acylate films having a reduced in-plane Re, it has been difficult to prepare a cellulose acylate film having a small Re change with angle, i.e., small Rth. It has thus been proposed that a polycarbonate-based film or thermoplastic cycloolefin film be used instead of cellulose acylate film to provide an optically transparent film having a small Re change with angle (as disclosed in JP-A-2001-318233 and JP-A-2002-328233; As products there have been propose ZEONOR (produced by ZEON CORPORATION) and ARTON (produced by JSR). These optically transparent films are excellent in most heat stability but are disadvantageous in that when used as protective film for polarizer, they leave something to be desired in stickability to PVA due to its hydrophobicity. These optically transparent films are disadvantageous also in that their entire in-plane optical properties are uneven. It has been keenly desired to further reduce the optical anisotropy of cellulose acylate film, which is excellent in stickability to PVA, to solve these problems. In some detail, an optically isotropic and optically transparent cellulose acylate film having substantially zero in-plane Re and a small retardation change with angle, i.e., substantially zero Rth has been desired.

In the production of cellulose acylate film, it is normally practiced to add a compound called plasticizer. Referring to the kind of plasticizers, there have been disclosed phosphoric acid triesters such as triphenyl phosphate and biphenyl diphenyl phosphate, and phthalic acid esters (as disclosed in “Institute of Plastic Material”, vol. 17, Nikkan Kogyo Shinbunsha, “Fiber-based resins”, page 121, 1970). Among these plasticizers, those having an effect of decreasing the optical anisotropy of cellulose acylate film have been known. For example, specific aliphatic acid esters have been disclosed (as disclosed in JP-A-2001-247717). However, these known compounds leave something to be desired in its effect of decreasing the optical anisotropy of cellulose acylate film. It is also disadvantageous in that when these compounds are incorporated in the film in a large amount, the surface conditions of the film are deteriorated, causing the occurrence of optical unevenness. It has been desired to provide a method for decreasing optical anisotropy without adding these compounds to the cellulose acylate film.

A cellulose acylate film is normally prepared by a solvent casting method. It has been desired to reduce the time required from the casting of the dope over the metallic support until the peeling of the film thus formed off the metallic support, thereby enhancing the productivity at the film forming step. In particular, it has been desired to enhance the productivity over the recent growing demand for cellulose acylate film. To this end, a high speed flow casting has been keenly desired. It is attributed to the fact that it is made difficult to peel the cellulose acylate film off the metallic support at the step of flow-casting a cellulose acylate over a band or drum which is a metallic support, drying or cooling the cellulose acylate thus casted to form a gel-like film having a high strength, peeling the film off the metallic support while being impregnated with an organic solvent, and then thoroughly drying the film, and the film thus peeled has weak self-supporting properties. As one of solutions to this problem, the use of an acid or salt thereof having an acid dissociation index pKa of from 1.93 to 4.50 (preferably from 2.0 to 4.4, more preferably from 2.2 to 4.3 (e.g., from 2.5 to 4.), particularly preferably from 2.6 to 4.3 (e.g., from 2.6 to 4.0)) is disclosed (see JP-A-10-3167701). However, this proposal has been found disadvantageous in that these acids form a minute salt with alkaline earth metals contained in the cellulose acylate in the cellulose acylate solution and the salt is then attached to the system at the prolonged flow casting step. On the other hand, it has been found effective to enhance the adaptability of the cellulose acylate solution to gelation in order to enhance the self-supporting properties of the film thus peeled. As one of methods for enhancing the adaptability to gelation, it is effective to add an alcohol to the cellulose acylate solution. However, this approach is also disadvantageous in that the cellulose acylate solution shows a deteriorated stability.

Recent liquid crystal displays have been required to have improvement in display tint. To this end, optically transparent films such as protective film for polarizer and support for optically compensatory film are required to have not only a smaller Re or Rth value in the visible light range of from 400 nm to 800 nm but also a smaller change of Re or Rth with wavelength, i.e., smaller wavelength dispersion of Re or Rth.

### SUMMARY OF THE INVENTION

An object of an illustrative, non-limiting embodiment of the invention is to provide a cellulose acylate film excellent in durability which exhibits a small optical anisotropy (Re, Rth) and thus is substantially optically anisotropic and exhibits a small wavelength dispersion of optical anisotropy at a high productivity.

Another object of an illustrative, non-limiting embodiment of the invention is to demonstrate that an optical material such as optically compensatory film and polarizing plate prepared from a cellulose acylate film having a small optical anisotropy, a small wavelength dispersion and an excellent durability exhibits excellent viewing angle properties and provide a liquid crystal display comprising same.

As a result of extensive studies, the present inventors found that the use of a compound which inhibits the in-plane direction and thickness-direction alignment in a polymer film makes it possible to sufficiently decrease the optical anisotropy of the film and the additional use of a highly acetylated cellulose acylate having an acetylation degree of preferably from 61.0 to 62.5 makes it possible to further decrease the optical anisotropy of the film. It was also found that a cellulose acylate film excellent in moist heat resistance can be produced at a high productivity by incorporating a release accelerator in the film and adjusting the content of sulfuric acid left in the film to a range of from 0 ppm to 100 ppm. It was further found that a cellulose acylate film having not only a high productivity but also a smaller optical anisotropy (particularly in-plane retardation: Re) and hence a substantial optical isotropy can be provided by reducing the peel resistance developed when the casted film is peeled off the surface of the band.

In addition to the aforementioned knowledge, the inventors further found that when the cellulose acylate film is produced in such a manner that the content of alkaline earth metal falls within a range of from 0 ppm to 60 ppm, the resistance of the film to peeling off the surface of the casting band can be further reduced, making it possible to further reduce the in-plane retardation as well as stain developed during the continuous production of cellulose acylate film, which is called “plate out”.

The inventors further found that an optically compensatory film having excellent viewing angle properties can be provided by adding an optically anisotropic layer to the aforementioned cellulose acylate film having a small optical anisotropy and a small wavelength dispersion.

The invention has been worked out on the basis of these findings. In some detail, the invention concerns the following cellulose acylate film, optically compensatory film, polarizing plate and liquid crystal display. The objects of the invention can be accomplished with these constitutions.

(1) A cellulose acylate film comprising a release accelerator in an amount of 10 ppm to 2,000 ppm, wherein the cellulose acylate film has a residual sulfuric acid content of 0 ppm to 100 ppm, and the cellulose acylate film satisfies relationships (I) and (II):
0≦Re(630)≦10 and |Rth(630)|≦25 (1)
|Re(400)−Re(700)|≦10 and |Rth(400)−Rth(700)|≦35 (II)
wherein Re(λ) is an in-plane retardation value at a wavelength of λ nm; and Rth(λ) is a thickness-direction retardation value at a wavelength of λ nm.
(2) The cellulose acylate film as defined in Clause (1), which has an alkaline earth metal content of 1 ppm to 60 ppm.
(3) The cellulose acylate film as defined in Clause (1) or (2), which is formed from a cellulose acylate having a residual sulfuric acid content of 0 ppm to 110 ppm.
(4) The cellulose acylate film as defined in any one of Clauses (1) to (3), which is formed from a cellulose acylate having an average acetylation degree of 61.0% to 62.5%.
(5) The cellulose acylate film as defined in any one of Clauses (1) to (4), which is formed from a cellulose acylate made of cotton linter.
(6) The cellulose acylate film as defined in any one of Clauses (1) to (5), comprising at least one compound satisfying relationships (III) and (IV):
(Rth(A)−Rth(0))/A≦−1.0 (III)
0.1≦A≦30 (IV)
wherein Rth(A) is Rth(630) of a film containing a compound lowering Rth in an amount of A % by mass (weight); Rth(0) is Rth(630) of a film free of the compound flowering Rth; and A is a content of the compound lowering Rth based on a weight of a raw material polymer of the cellulose acylate film.
(7) An optically compensatory film comprising: a cellulose acylate film as defined in any one of Clauses (1) to (6); and an optically anisotropic layer having Re(630) of 0 nm to 200 nm and |Rth(630)| of 0 nm to 400 nm.
(8) The optically compensatory film as defined in Clause (7), wherein the optically anisotropic layer comprises a layer formed from a discotic liquid crystal compound.
(9) The optically compensatory film as defined in Clause (7) or (8), wherein the optically anisotropic layer comprises a layer formed from a rod-shaped liquid crystal compound.
(10) The optically compensatory film as defined in any one of Clauses (7) to (9), wherein the optically anisotropic layer comprises a polymer film.
(11) A polarizing plate comprising: a polarizer; and a protective film, the protective film being a cellulose acylate film defined in any one of Clauses (1) to (6) or an optically compensatory film defined in Clauses (7) to (10).
(12) The polarizing plate as defined in Clause (11), comprising at least one of a hard coat layer, an anti-glare layer and an anti-reflection layer.
(13) A liquid crystal display comprising at least one of a cellulose acylate films defined in any one of Clauses (1) to (6), an optically compensatory film defined in any one of Clauses (7) to (10) and a polarizing plate defined in Clause (11) or (12).
(14) A VA or IPS liquid crystal display comprising at least one of a cellulose acylate film defined in any one of Clauses (1) to (6), an optically compensatory film defined in any one of Clauses (7) to (10) and a polarizing plate defined in Clause (11) or (12).

### DETAILED DESCRIPTION OF THE EXEMPLARY EMBODIMENTS

Although the invention will be described below with reference to the exemplary embodiments thereof, the following exemplary embodiments and modifications do not restrict the invention.

According to an exemplary embodiment of the invention, a cellulose acylate film having a small optical anisotropy was obtained at a high productivity. When the content of the alkaline earth metal and the Rth decreasing compound in the cellulose acylate film are predetermined to the above defined range, the aforementioned effect is more remarkably exerted. The use of the optically isotropic film of the invention makes it possible to provide an optical material such as optically compensatory film and polarizing plate excellent in viewing angle properties and a liquid crystal display comprising same.

Exemplary embodiments of the invention will be described in detail hereinafter. In the following description, the content of ingredients such as residual sulfuric acid content and trace amounts of metallic components in the cellulose acylate or cellulose acylate film is represented by “ppm” based on mass of cellulose acylate or cellulose acylate film according to the practice of the background art. This unit is the same as “mg/kg” based on cellulose acylate or cellulose acylate film.

“Residual Sulfuric Acid Content”

The term “residual sulfuric acid content” as used herein is meant to indicate the numerical value calculated as content of sulfuric acid left in cellulose acylate or cellulose acylate film. The term “residual sulfuric acid content” as used herein is meant to indicate generically sulfuric acids corresponding to sulfuric acid connected to cellulose (sulfuric acid component connected as sulfuric acid ester or sulfonic acid group), free sulfuric acid and sulfate which are occasionally referred to as “general sulfuric acid”. In the invention, additives having a sulfuric acid component (sulfuric acid ester, sulfonic acid group) can be used as peeling agent in the reaction system. In this case, too, sulfuric acid derived from the peeling agent is included in the residual sulfuric acid. On the other hand, sulfur-containing additives free of the aforementioned sulfuric acid components are not included in the residual sulfuric acid. The residual sulfuric acid content can be accurately calculated by subjecting the cellulose acylate and the cellulose acylate film sample to ICP emission spectroscopic analysis (ICP-OES). The content of sulfuric acid left in the cellulose acylate film can be calculated by dissolving the cellulose acylate in a good solvent such as methylene chloride, measuring the solution for sulfur content by ICP-OES, and then converting the measurements to sulfuric acid content. The content of sulfuric acid left in the cellulose acylate film, too, can be calculated by the same method as mentioned above. However, in the case where the film sample contains a sulfur-containing additive free of sulfuric acid component (that means sulfuric acid ester group or sulfonic acid group), the content of sulfur A in the film is measured at first. Subsequently, the additive is extracted from the film with a solvent such as THF, purified through liquid chromatography, and then measured for content. The content of sulfur B derived from sulfur-containing additive is calculated from the structural formula of the additive. The content of sulfur B is then subtracted from the content of sulfur A of the film to calculate the content of sulfuric acid left in the cellulose acylate film (converted from the content of sulfur). Thus, in the case where an additive having no sulfuric acid structure is used (as optical anisotropy decreasing agent, for example), the content of sulfur derived from the additive is not included in the residual sulfuric acid content.

When the total amount of sulfuric acids in the cellulose acylate decreases, the oxidative deterioration and coloration due to ageing with moist heat can be inhibited to enhance durability of the film. However, the peel resistance developed when the web obtained by initially drying the cellulose acylate solution is peeled off a metallic band rises. As a result, the web made of a cellulose acylate containing a solvent in a large amount undergoes longitudinal elongation and orientation and hence increased in-plane retardation during peeling to disadvantage. In particular, when the residual sulfuric acid content is 25 ppm or less, the peel resistance developed when the flow-casted film is peeled off the metallic band shows a remarkable rise and hence a drastic rise of in-plane retardation. The invention is characterized in that a release accelerator is used to avoid the problem of peel resistance while the content of sulfuric acid left in the film is adjusted to a range as low as 0 ppm to 100 ppm from the standpoint of inhibition of oxidative deterioration and coloration due to ageing with moist heat. The content of sulfuric acid left in the cellulose acylate film of the invention is preferably from 0 ppm to 100 ppm, more preferably from 0 ppm to 90 ppm, even more preferably from 0 ppm to 80 ppm, particularly preferably from 0 ppm to 50 ppm. In order to adjust the content of sulfuric acid left in the film to the above defined range, it is effective to use a cellulose acylate having a small residual sulfuric acid content as a raw material.

In a preferred embodiment of the invention, a cellulose acylate having a high acetylation degree is used to reduce optical anisotropy. However, it was made obvious that a cellulose acylate having a high acetylation degree tends to have a small residual sulfuric acid content and thus gives a raised peel resistance when a film is prepared therefrom. Accordingly, when a cellulose acylate having a high acetylation degree is used by making the use of the invention, the peel resistance of the film can be lowered while reducing the in-plane retardation of the film to great advantage.

As previously mentioned, the term “ppm” as used herein is conventionally used in the art. This value is based on mass of cellulose acylate film, which is identical to “mg/kg”.

“Content of Alkaline Earth Metal”

A cellulose acylate normally contains metallic components such as alkaline metal (e.g., potassium, sodium) and alkaline earth metal (e.g., calcium, magnesium, strontium, barium). In general, these metallic components have a high affinity for the surface of the metallic band and thus cause the deterioration of peel resistance when the web is peeled off the surface of the metallic band. On the other hand, in a cellulose acylate having a large amount of sulfuric acid components, these sulfuric acid components accelerate the hydrolysis reaction thereof and thus deteriorate the heat resistance, stability to heat resistance (yellow stain), etc. The metallic components contained in the cellulose acylate neutralize the sulfuric acid components in the cellulose acylate to form a complex that makes it difficult for hydrolysis reaction to occur, exerting an effect of enhancing the heat resistance of the cellulose acylate. Accordingly, the cellulose acylate of the invention contains sulfuric acid components in the minimum amount that doesn't deteriorate the peel resistance and metallic components (particularly alkaline earth metal) in a small amount to have a reduced peel resistance and an excellent heat resistance. In the invention, paying attention to the fact that among the metallic components, alkaline earth metal components are present more than alkaline metal components, it is intended to adjust the residual alkaline earth metal content in particular. The content of alkaline earth metal atoms can be measured by an X-ray photoelectric spectroscopic analyzer (XPS). In the invention, the alkaline earth metals in the cellulose acylate showed no relationship with acetylation degree. The less the content of alkaline earth metals (particularly Ca) is, the lower is the peel resistance and the more can be reduced the in-plane retardation Re. In the invention, the content of alkaline earth metals is preferably from 0 ppm to 60 ppm, more preferably from 0 ppm to 40 ppm, even more preferably from 1 ppm to 20 ppm. When the content of alkaline earth metals exceeds 70 ppm, the resulting cellulose acylate film exhibits a deteriorated peel resistance and hence a raised in-plane retardation Re to disadvantage. The content of alkaline earth metals of the invention is calculated on a cellulose acylate film sample. The content of alkaline earth metals in the cellulose acylate film can be adjusted mainly by adjusting the content of alkaline earth metals in the cellulose acylate which is a raw material.

The cellulose ester of the invention can be affected by trace amounts of metallic components. This is presumably attributed to water used in the production process. Components which can become insoluble nuclei are preferably present scarcely. Metallic ions such as iron, calcium and magnesium ions which can form a salt with a polymer decomposition product that can contain an organic acidic group to form unnecessary materials are preferably present scarcely. In actuality, however, mutual interaction among the various components or other factors have something to do with this phenomenon. Thus, it can be unequivocally said that these components are preferably present scarcely. However, when these components are present excessively, some problems occur.

The content of iron (Fe) component is preferably 1 ppm or less. This can apply also to the case where any of raw materials such as cotton linter and wood pulp is used. Thus, the content of iron component is preferably present scarcely.

The term “ppm” as used herein is conventionally used in the art. This value is based on mass of cellulose acylate film, which is identical to “mg/kg”.

Calcium (Ca) component is contained in underground water and river water. Water containing a large amount of calcium is hard water which can be drinking water as well. Calcium can easily form a coordination compound, i.e., complex with an acidic component such as carboxylic acid and sulfonic acid or many ligands to produce much unnecessary scum (insoluble sediment, turbidity) derived from calcium.

In practicality, the content of calcium (Ca) component is preferably as small as possible. However, the optimum calcium content differs from the case where cotton linter is used to the case where wood pulp is used. As previously mentioned, the term “ppm” as used herein is conventionally used in the art. This value is based on mass of cellulose acylate film, which is identical to “mg/kg”.

Like calcium, magnesium (Mg) component is contained much in underground water and causes the production of unnecessary materials. When the magnesium component is present much, it produces insoluble contents. Thus, it is preferred that the magnesium component be present excessively. However, it is not preferred from the standpoint of properties that the magnesium component be present too scarcely.

(Durability of Cellulose Acylate Film)

The term “durability” as used herein is meant to correspond to a phenomenon of fading/denaturation of the film of the invention used in a liquid crystal display developed when the liquid crystal display is used under high temperature conditions such as in private cars called “carbecue”. Accordingly, it means that the worse the durability of the film is, the more easily can be faded the film under high temperature conditions. In some detail, durability is measured by the following method. Five sheets of 40 mm square sample of cellulose ester film are allowed to stand in a 140C drying cell for 72 hours, and then visually observed for conditions. The results are then evaluated according to the following criterion.
G: A stack of five sheets of film is observed to show no coloration when seen through;
F: A stack of five sheets of film is observed to show slight coloration when seen through, but one sheet of film is observed to show no coloration when seen through;
P: A stack of five sheets of film is observed to show remarkable coloration and even one sheet of film is observed to show some coloration
   (Retardation, Re, Rth)

In the invention, Re and Rth represent the in-plane retardation and thickness-direction retardation at a wavelength of λ, respectively. Re can be measured by the incidence of light having a wavelength λ nm in the direction normal to the film using an automatic birefringence meter such as Type KOBRA 21ADH birefringence meter (produced by Ouji Scientific Instruments Co. Ltd.). Rth can be calculated by an automatic birefringence meter such as KOBRA 21ADH on the basis of retardation values measured in the total three directions, i.e., Reλ, retardation value measured by the incidence of light having a wavelength λ nm in the direction inclined at an angle of +40° from the direction normal to the film with the in-plane slow axis (judged from “KOBRA 21ADH”) as an inclined axis (rotary axis), retardation value measured by the incidence of light having a wavelength λ nm in the direction inclined at an angle of −40° from the direction normal to the film with the in-plane slow axis as an inclined axis (rotary axis). As the hypothetical average refractive index there may be used one disclosed in “Polymer Handbook”, John Wiley & Sons, Inc. and various catalogues of optical films. For the cellulose acylate films having an unknown average refractive index, an Abbe refractometer may be used. The average refractive index of main optical films are exemplified below.

Cellulose acylate (1.48), cycloolefin polymer (1.52), polycarbonate (1.59), polymethylene methacrylate (1.49), polystyrene (1.59). By inputting the hypothetic average refractive indexes and film thicknesses, the automatic birefringence meter such as KOBRA 21ADH calculates nₓ, n_{y} and n_{z}.

The optical anisotropy, particularly the in-plane retardation and the thickness-direction retardation, of the cellulose acylate film of the invention are preferably predetermined to satisfy the following relationship (IA) or (IB).
0≦Re(630)≦10 (IA)
|Rth(630)|≦25 (IB)

The aforementioned relationships (IA) and (IB) are preferably the following ones:
0≦Re(630)≦5 (IA′)
|Rth(630)|≦10 (IB′)

The aforementioned relationships (IA) and (IB) are particularly preferably the following ones:
0≦Re(630)≦3 (IA″)
|Rth(630)|≦5 (IB″)
(Retardation Wavelength Dispersion |Re(400)−Re(700)| and |Rth(400)−Rth(700)|)

In the invention, the wavelength dispersion of retardation was determined from the absolute value of the difference in Re and Rth between at a wavelength of 400 nm and at a wavelength of 700 nm calculated by the aforementioned method.

The smaller the wavelength dispersion of retardation of the film is, the smaller is the tint change as viewed in oblique direction and the better is the viewability of the display device prepared from the film.

The optical anisotropy, particularly the in-plane retardation and thickness-direction retardation at a wavelength of 400 nm and 700 nm, of the cellulose acylate film are preferably predetermined to satisfy the following relationship (IIA) or (IIB).
|Re(400)−Re(700)|≦10 (IIA)
|Rth(400)−Rth(700)|≦35 (IIB)

The aforementioned relationships (IIA) and (IIB) are preferably the following ones:
|Re(400)−Re(700)|≦7 (IIA′)
|Rth(400)−Rth(700)|≦25 (IIB′)

The aforementioned relationships (IIA) and (IIB) are particularly preferably the following ones:
|Re(400)−Re(700)|≦5 (IIA″)
|Rth(400)−Rth(700)|≦15 (IIB″)
(Cotton as Raw Material of Cellulose Acylate)

As the cellulose from which the cellulose acylate to be used in the invention is prepared there is used cotton linter, wood pulp (broad leaf pulp, conifer pulp) or the like. Any cellulose acylate obtained from these celluloses may be used. If necessary, these cellulose acylates may be used in admixture. For the details of these celluloses as raw material, reference can be made to Maruzawa and Uda, “Purasuchikku Zairyo Koza (17)-Senisokeijushi (Institute of Plastic Materials (17)-Cellulose-based Resin)”, Nikkan Kogyo Shinbunsha, 1970 and Kokai Giho 2001-1745, Japan Institute of Invention and Innovation, pp. 7-8.

In the invention, a cellulose acylate derived from cotton linter having a small content of hemicelluloses (e.g., xylan, glucomannan) which lowers peelability is preferably used.

(Acyl Substituent in Cellulose Acylate)

The cellulose acylate of the invention prepared from the aforementioned cellulose as raw material will be described hereinafter. The cellulose acylate of the invention may be made from a cellulose having its hydroxyl group acylated. The acyl group as substituent may range from acetyl group, which has two carbon atoms, to one having 22 carbon atoms. In the cellulose acylate of the invention, the degree of substitution of hydroxyl group in cellulose and the substituents on cellulose are not specifically limited. The degree of substitution and the average acetylation degree can be determined by measuring the degree of bonding of acetic acid and/or C₃-C₂₂ aliphatic acid which replaces the hydroxyl group in cellulose and then subjecting the measurements to calculation. The measurement can be made according to ASTM D-817-91.

As mentioned above, in the cellulose acylate of the invention, the average degree of acetylation of hydroxyl group in cellulose is not specifically limited but is preferably from 61.0 to 62.5, more preferably from 61.5 to 62.5, even more preferably from 62.0 to 62.5. The use of a cotton having an average cellulose acylate acetylation degree as higher than ever as 61.0 to 62.5 makes it possible to further reduce Re and Rth and hence reduce the required added amount of the compound for inhibiting the alignment in the film in-plane direction and thickness direction more than ever.

Among acetic acid and/or C₃-C₂₂ aliphatic acid which replaces the hydroxyl group in cellulose, the C₂-C₂₂ acryl group is not specifically limited and may be an aliphatic acyl group or allylacyl group. Referring to the form of substitution on cellulose unit, a single acryl group or a mixed ester of two or more acyl groups may be used. Examples of these acyl groups include alkylcarbonylester, alkenylcarbonylester, aromatic carbonylester and aromatic alkylcarbonylester of cellulose. These esters each may have substituted groups. Preferred examples of these acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, and cinnamoyl. Preferred among these acyl groups are acetyl, propionyl, butanoyl, dodecanoyl, octadecanoyl, t-butanoyl, oleoyl, benzoyl, naphthylcarbonyl, and cinnamoyl. More desirable among these acyl groups are acetyl, propionyl, and butanoyl.

It was made obvious that among the aforementioned acyl substituents which replace the hydroxyl group in cellulose, those substantially comprising at least two of acetyl group, propionyl group and butanoyl group can lower the optical anisotropy of the cellulose acylate film if its total substitution degree is from 2.50 to 3.00.

(Residual Sulfuric Acid Content of Cellulose Acylate Film)

The cellulose acylate film of the invention is characterized by the incorporation of residual sulfuric acid in an amount of from 0 ppm to 100 ppm. As a result, an effect can be exerted of reducing the resistance of a web having much residual solvent content to peeling from the support without any release agent during film making and hence drastically enhancing the productivity. One of methods for adjusting the content of sulfuric acid left in the cellulose acylate film within a specified range is to adjust the content of sulfuric acid left in the cellulose acylate to be used as a raw material.

Accordingly, the use of a cellulose acylate having a small residual sulfuric acid content as a raw material cotton makes it possible to attain the invention. The content of sulfuric acid left in the cellulose acylate is preferably from 0 ppm to 110 ppm, more preferably from 0 ppm to 100 ppm, even more preferably from 0 ppm to 90 ppm, particularly preferably from 0 ppm to 55 ppm.

(Polymerization Degree of Cellulose Acylate)

The polymerization degree of the cellulose acylate which is preferably used in the invention is from 180 to 700 as calculated in terms of viscosity-average polymerization degree. The polymerization degree of the cellulose acylate is preferably from 180 to 550, more preferably from 180 to 400, particularly preferably from 180 to 350. When the polymerization degree of the cellulose acylate is too high, the dope solution of cellulose acylate is too high to prepare a film by flow casting. When the polymerization degree of the cellulose acylate is too low, the film thus prepared exhibits a lowered strength. The average polymerization degree can be measured by the intrinsic viscosity method proposed by Uda et al (Kazuo Uda and Hideo Saito, “Journal of the Society of Fiber Science and Technology, Japan”, vol. 19, No. 1, pp. 105, 120, 1962). For details of this method, reference can be made to JP-A-9-95538.

The molecular weight distribution of the cellulose acylate which is preferably used in the invention is evaluated by gel permeation chromatography. The cellulose acylate to be used herein preferably has a small polydispersibility index Mw/Mn (Mw: weight-average molecular weight; Mn: number-average molecular weight) and a sharp molecular weight distribution. In some detail, Mw/Mn is preferably from 1.0 to 4.0, more preferably from 2.0 to 3.5, most preferably from 2.3 to 3.3.

When low molecular components have been removed, the resulting cellulose acylate exhibits a raised average molecular weight (polymerization degree) but a lower viscosity than ordinary cellulose acylates and thus is useful. The cellulose acylate having little low molecular components can be obtained by removing low molecular components from a cellulose acylate synthesized by an ordinary method. The removal of low molecular components from a cellulose acylate can be carried out by washing the cellulose acylate with a proper organic solvent. In order to prepare a cellulose acylate having little low molecular components, it is preferred that the amount of a sulfuric acid catalyst to be used in acetylation reaction be adjusted to a range of from 0.5 to 25 parts by mass, more preferably from 0.5 to 17.5 parts by mass, even more preferably from 0.5 to 15 parts by mass based on 100 parts by mass of cellulose. When the amount of a sulfuric acid catalyst falls within the above defined range, a cellulose acylate which is desirable also in molecular weight distribution (uniform molecular weight distribution) can be synthesized.

In the production of the cellulose acylate of the invention, the cellulose acylate preferably has a water content of 2% by weight or less, more preferably 1% by weight or less, particularly preferably 0.7% by weight or less. In general, a cellulose acylate contains water and is known to have a water content of from 2.5% to 5% by weight. In order to adjust the water content of the cellulose acylate of the invention to the above defined range, it is necessary that the cellulose acylate be dried. The drying method is not specifically limited so far as the desired water content can be attained. For the details of the cotton from which these cellulose acylates of the invention are prepared and their synthesis methods, reference can be made to Kokai Giho 2001-1745, Japan Institute of Invention and Innovation, pp. 7-12, Mar. 15, 2001.

The cellulose acylates of the invention may be used singly or in combination of two or more thereof so far as the substituents, the substitution degree, the polymerization degree, the molecular weight distribution, etc. fall within the above defined ranges.

(Additives to Cellulose Acylate)

In the invention, the cellulose acylate solution may comprise various additives (e.g., compound decreasing optical anisotropy, release accelerator, wavelength dispersion adjustor, ultraviolet inhibitor, plasticizer, deterioration inhibitor, particulate material, optical property adjustor) incorporated therein depending on the purpose at the various preparation steps. These additives will be further described hereinafter. These additives may be added at any time during the preparation of the dope but may be added at an additive step of adding them during the final preparation step of preparing the dope.

(Release Accelerator)

The release accelerator, which is particularly important in the invention, will be further described hereinafter. The release accelerator needs to be a compound selected from the group consisting of partial esterification product of polybasic acid having an acid dissociation index pKa of from 1.93 to 4.50 in aqueous solution and alkaline metal salt and alkaline earth metal salt thereof. The term “partial ester” as used herein is meant to indicate a product of esterification of a part of polybasic acid. In the case where the polybasic acid is citric acid, the partial ester thereof means citric acid monoester or citric acid diester. In the invention, a mixture of partial esters is preferably used. The inventors have used various acids (e.g., oxalic acid, succinic acid, citric acid) as release accelerator. These acids form an alkaline metal salt or alkaline metal salt which is precipitated in a solution.

The kind of release accelerators which can be used will be exemplified below with its pKa, but the release accelerators which can be used in the invention are not limited thereto. Examples of these release accelerators include aliphatic polyvalent carboxylic acids (malonic acid monoethyl (2.65), malonic acid monomethyl (2.65), citric acid monopropyl (4.99), glutaric acid monomethyl (4.13), adipic acid monomethyl (4.26), pimelic acid monoethyl (4.31), azelaic acid monomethyl (4.39), fumaric acid monobutyl (2.85)), oxycarboxylic acids (tartaric acid monoethyl (2.89), tartaric acid diethyl (2.82-2.99), citric acid monoethyl (2.87), citric acid diethyl ester (2.87), citric acid methyl ethyl ester (2.87)), aromatic polyvalent carboxylic acids (phthalic acid monoethyl (2.75), isophthalic acid monopropyl (3.50), terephthalic acid monoethyl (3.54)), heterocyclic polyvalent carboxylic acids (e.g., monoethyl 2,6-pyridinedicarboxylate (2.09)), and amino acids (glutamic acid monoethyl (2.18)).

The aforementioned release accelerator may be used in combination with sulfonic acid or phosphoric acid-based material to expect the releasability of the film. These materials are preferably in the form of surface active agent from the standpoint of solubility. In some detail, materials disclosed in JP-A-61-243837 can be used to advantage. Specific examples of these materials include C₁₂H₂₅O—P(═O)—(OK)₂, C₁₂H₂₅OCH₂CG₂O—P(═O)—(OK)₂, and (iso-C₉H₉)₂—C₆H₃—O—(CH₂CH₂O)₃—(CH₂)₄SO₃Na.

The acid may be used in the form of free acid or in the form of alkaline metal salt or alkaline earth metal salt. Examples of the alkaline metal employable herein include lithium, potassium, and sodium. Examples of the alkaline earth metal employable herein include calcium, magnesium, barium, and strontium. Preferred among these alkaline metals is sodium. Preferred among these alkaline earth metals are calcium and magnesium. However, alkaline metals are preferred to alkaline earth metals. These alkaline metals or alkaline earth metals may be used singly or in combination of two or more thereof. These alkaline metals and alkaline earth metals may be used in combination.

The total content of the aforementioned acids and metal salts thereof is predetermined such that the releasability and transparency of the film cannot be impaired. For example, the total content of the aforementioned acids and metal salts thereof can be selected from the range of from about 1×10⁻⁹ to 3×10⁻⁵ mols, preferably from about 1×10⁻⁸ to 2×10⁻⁵ mols (e.g., 5×10⁻⁷ to 1.5×10⁻⁵ mols), more preferably from about 1×10⁻⁷ to 1×10⁻⁵ mols (e.g., 5×10⁻⁶ to 8×10⁻⁶ mols), normally from about 5×10⁻⁷ to 5×10⁻⁶ mols (e.g., normally from about 6×10⁻⁷ to 3×10⁻⁶ mols) per g of cellulose acylate.

In the invention, the content of the release accelerator in the cellulose acylate film is preferably from 10 ppm to 2,000 ppm, more preferably from 10 ppm to 200 ppm, even more preferably from 10 ppm to 100 ppm.

(Structural Characteristics of Compound for Adjusting Optical Anisotropy of Cellulose Acylate Film)

The compound for adjusting the optical anisotropy of the cellulose acylate film will be further described. The term “compound for adjusting optical anisotropy” as used herein is meant to indicate generally compounds for increasing the absolute value of retardation and compounds for decreasing the absolute value of retardation. The inventors used a compound for inhibiting the alignment of cellulose acylate in the in-plane direction and thickness-direction in the film to sufficiently decrease the optical anisotropy of the film and hence reduce Re to zero and Rth to close to zero. The invention will be described with reference to the compound reducing (or decreasing) optical anisotropy (occasionally referred to as “optical anisotropy decreasing agent”) in particular.

The compound decreasing optical anisotropy is thoroughly compatible with the cellulose acylate and has neither a rod-shaped structure nor a planar structure itself to advantage. In some detail, when the compound has a plurality of planar functional groups such as aromatic group, these functional groups are preferably present on a non-planar surface rather than on the same planar surface.

It is preferred that at least one of compounds for decreasing the optical anisotropy, particularly film thickness-direction retardation Rth, of the cellulose acylate film of the invention be incorporated in such an amount that the following relationships (III) and (IV) can be satisfied.
(Rth(A)−Rth(0))/A≦−1.0 (III)
0.1≦A≦30 (IV)

The aforementioned relationships (III) and (IV) are preferably the following ones:
(Rth(A)−Rth(0))/A≦−2.0 (III′)
0.5≦A≦25 (IV′)

The aforementioned relationships (III) and (IV) are particularly preferably the following ones:
(Rth(A)−Rth(0))/A≦−3.0 (III″)
1.0≦A≦20 (IV″)
(Log P Value)

In order to prepare the cellulose acylate film of the invention, a compound having an octanol/water distribution coefficient (log P value) of from 0 to 7 is preferably used among the aforementioned compounds for inhibiting the alignment of cellulose acylate in in-plane direction and thickness-direction in the film to decrease the optical anisotropy of the film. A compound having a log P value of more than 7 exhibits a poor compatibility with cellulose acylate and thus can easily cause clouding and dusting of the film. Further, a compound having a log P value of less than 0 exhibits a high hydrophilicity and thus can deteriorate the water resistance of the cellulose acylate film. The aforementioned compound more preferably has a log P value of from 1 to 6, particularly preferably from 1.5 to 5.

For the measurement of octanol/water distribution coefficient (log P value), the flask shaking method disclosed in JIS Z7260-107 (2000) can be employed.

The octanol/water distribution coefficient (log P value) can be estimated by a computational chemistry or empirical method instead of measured. Preferred examples of the computational chemistry employable herein include Crippen's fragmentation method (J. Chem. Inf. Comput. Sci., 27, 21 (1987).), Viswanadhan's fragmentation method (J. Chem. Inf. Comput. Sci., 29, 163 (1989).), and Broto's fragmentation method (Eur. J. Med. Chem.-Chim. Theor., 19, 71 (1984).). More desirable among these computational methods is Crippen's fragmentation method (J. Chem. Inf. Comput. Sci., 27, 21 (1987).). Whether or not a compound falls within the scope of the invention if the log P value of the compound differs by the measuring method or computational method is preferably judged by Crippen's fragmentation method.

(Compound Decreasing Optical Anisotropy)

The compound decreasing optical anisotropy may or may not contain an aromatic group.

The compound decreasing optical anisotropy preferably has a molecular weight of from not smaller than 150 to not greater than 3,000, more preferably from not smaller than 170 to not greater than 2,000, particularly preferably from not smaller than 200 to not greater than 1,000. The compound decreasing optical anisotropy may have a specific monomer structure or an oligomer or polymer structure having a plurality of such monomer units connected to each other so far as its molecular weight falls within the above defined range.

The compound decreasing optical anisotropy preferably stays liquid at 25° C. or is a solid having a melting point of from 25° C. to 250° C., more preferably stays liquid at 25° C. or is a solid having a melting point of from 25° C. to 200° C. The compound decreasing optical anisotropy preferably undergoes no evaporation at the dope flow casting step and the drying step during the preparation of cellulose acylate film.

The compounds for decreasing optical anisotropy may be used singly or in admixture of two or more thereof in arbitrary proportion.

The compound decreasing optical anisotropy may be added at any time during the preparation of the dope or at the end of the process for preparing the dope.

The average percent content of the compound decreasing optical anisotropy in the region of the cellulose acylate film ranging from the surface of at least one side thereof to a point of 10% of the total thickness thereof from the surface is from 80% to 99% of that of the central portion thereof. For the determination of the content of the compound of the invention, the content of the compound in the surface and the central portion of the film can be measured by the method involving the use of infrared absorption spectrum disclosed in JP-A-8-57879.

Specific examples of the compound for lowering the optical anisotropy of the cellulose acylate film which is preferably used in the invention will be given below, but the invention is not limited thereto.

The compound of the formula (1) will be further described hereinafter.

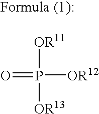

In the formula (1), R¹¹ to R¹³ each independently represent a C₁-C₂₀ aliphatic group. R¹¹ to R¹³ may be connected to each other to form rings.

R¹¹ to R¹³ will be further described hereinafter. R¹¹ to R¹³ each are preferably a C₁-C₂₀, more preferably a C₁-C₁₆, particularly preferably a C₁-C₁₂ aliphatic group. The aliphatic group is preferably an aliphatic hydrocarbon group, more preferably an alkyl group (including chain-like, branched and cyclic alkyl groups), alkenyl group or alkynyl group. Examples of the alkyl group include methyl, ethyl, n-propyl, isopropyl, n-butyl, isobutyl, sec-butyl, t-butyl, n-pentyl, t-amyl, n-hexyl, n-octyl, decyl, dodecyl, eicosyl, 2-ethylhexyl, cyclopentyl, cyclohexyl, cycloheptyl, 2,6-dimethyl cyclohexyl, 4-t-butylcyclohexyl, cyclopentyl, 1-adamantyl, 2-adamantyl, and bicyclo[2.2.2]octane-3-il. Examples of the alkenyl group include vinyl, allyl, prenyl, gelanyl, oleyl, 2-cyclopentene-1-il, and 2-cyclohexene-1-il. Examples of the alkynyl group include ethynyl group, and propargyl group.

The aliphatic groups represented by R¹¹ to R¹³ each may be substituted. Examples of the substituents on the aliphatic group include halogen atoms (e.g., fluorine, chlorine, bromine, iodine), alkyl groups (straight-chain, branched or cyclic alkyl group, including bicycloalkyl group or active methine group), alkenyl groups, alkynyl groups, aryl groups, heterocyclic groups (regardless of substitution position), acyl groups, alkoxycarbonyl groups, aryloxycarbonyl groups, heterocyclic oxycarbonyl groups, carbamoyl groups, N-acylcarbamoyl groups, N-sulfonyl carbamoyl groups, N-carbamoylcarbamoyl groups, N-sulfamoylcarbamoyl groups, carbazoyl groups, carboxyl groups and salts thereof, oxazolyl groups, oxamoyl groups, cyano groups, carbon imidoyl groups, formyl groups, hydroxyl groups, alkoxy groups (including ethyleneoxy group or propyleneoxy group units), aryloxy groups, heterocyclic oxy groups, acyloxy groups, (alkoxy or aryloxy)carbonyloxy groups, carbamoyloxy groups, sulfonyloxy groups, amino groups, (alkyl, aryl or heterocyclic) amino groups, acylamino groups, sulfonamide groups, ureido groups, thioureido groups, imido groups, semicarbazide groups, ammonio groups, oxamoylamino groups, N-(alkyl or aryl)sulfonylureido groups, N-acylureido groups, N-acylsulfamoylamino groups, quaternized nitrogen-containing heterocyclic groups (e.g., pyridinio, imidazolio, quinolinio, isoquinolinio), isocyano groups, imino groups, (alkyl or aryl)sulfonyl groups, (alkyl or aryl)sulfinyl groups, sulfo groups and salts thereof, sulfamoyl groups, N-acylsulfamoyl groups, N-sulfonylsulfamoyl groups and salts thereof, phosphino groups, phosphinyl groups, phosphinyloxy groups, phosphinylamino groups, and silyl groups.

These groups may be further combined to form a composite substituent. Examples of these substituents include ethoxyethoxyethyl group, hydroxyethoxyethyl group, and ethoxycarbonylethyl group. R¹¹ to R¹³ each may contain a phosphoric acid ester group as a substituent. The compound of the formula (1) may contain a plurality of phosphoric acid ester group in the same molecule.

The compounds of the formulae (2) and (3) will be described hereinafter.

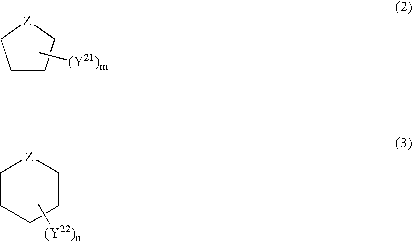

In the formulae (2) and (3), Z represents a carbon atom, oxygen atom, sulfur atom or —NR²⁵— (in which R²⁵ represents a hydrogen atom or alkyl group. The 5- or 6-membered ring containing Z may have substituents. A plurality of substituents may be connected to each other to form rings. Examples of the 5- or 6-membered ring containing Z include tetrahydrofurane, tetrahydropyran, tetrahydrothiophene, thian, pyrrolidine, piperidine, indoline, isoindoline, chromane, isochromane, tetrahydro-2-flanone, tetrahydro-2-pyrone, 4-butane lactam, and 6-hexanolactam.

The 5- or 6-membered ring containing Z comprises a lactone structure or lactam structure, i.e., cyclic ester or cyclic amide structure having oxo group connected to carbon atom adjacent to Z. Examples of the cyclic ester or cyclic amide structure include 2-pyrrolidone, 2-piperidone, 5-pentanolide, and 6-hexanolide.

R²⁵ represents a hydrogen atom or a preferably C₁-C₂₀, more preferably C₁-C₁₆, particularly preferably a C₁-C₁₂ alkyl group (including chain-like, branched or cyclic alkyl group). Examples of the alkyl group represented by R²⁵ include methyl, ethyl, n-propyl, isopropyl, n-butyl, isobutyl, sec-butyl, t-butyl, n-pentyl, t-amyl, n-hexyl, n-octyl, decyl, dodecyl, eicosyl, 2-ethylhexyl, cyclopentyl, cyclohexyl, cycloheptyl, 2,6-dimethyl cyclohexyl, 4-t-butylcyclohexyl, cyclopentyl, 1-adamanthyl, 2-adamanthyl, and bicyclo[2.2.2]octane-3-il. The alkyl group represented by R²⁵ may further have substituents. Examples of these substituents include groups which may substitute on R¹¹ to R¹³.

Y²¹ and Y²² each independently represent an ester group, alkoxycarbonyl group, amide group or carbamoyl group. The ester group is preferably a C₁-C₂₀, more preferably a C₁-C₁₆, particularly preferably a C₁-C₁₂ ester group. Examples of the ester group include acetoxy, ethylcarbonyloxy, propylcarbonyloxy, n-butylcarbonyl oxy, iso-butylcarbonyloxy, t-butylcarbonyloxy, sec-butylcarbonyloxy, n-pentylcarbonyloxy, t-amylcarbonyl oxy, n-hexylcarbonyloxy, cyclohexylcarbonyloxy, 1-ethylpentylcarbonyloxy, n-heptylcarbonyloxy, n-nonyl carbonyloxy, n-undecylcarbonyloxy, benzylcarbonyloxy, 1-naphthalenecarbonyloxy, 2-naphthalenecarbonyloxy, and 1-adamantanecarbonyloxy. The alkoxycarbonyl group is preferably a C₁-C₂₀, more preferably a C₁-C₁₆, particularly preferably a C₁-C₁₂ alkoxycarbonyl group. Examples of the alkoxycarbonyl group include methoxy carbonyl, ethoxy carbonyl, n-propyl carbonyl, isopropyloxy carbonyl, n-butoxy carbonyl, t-butoxy carbonyl, is-butyloxy carbonyl, sec-butyloxy carbonyl, n-pentyloxy carbonyl, t-amyloxy carbonyl, n-hexyloxy carbonyl, cyclohexyloxy carbonyl, 2-ethylhexyloxy carbonyl, 1-ethylproopyloxy carbonyl, n-octyloxy carbonyl, 3,7-dimethyl-3-octyloxy carbonyl, 3,5,5-trimethylhexyloxy carbonyl, 4-t-butylcyclohexyloxy carbonyl, 2,4-dimethylpentyl-3-oxycarbonyl, 1-adamantaneoxy carbonyl, 2-adamantaneoxy carbonyl, dicyclopentadienyloxy carbonyl, n-decyloxy carbonyl, n-dodecyloxy carbonyl, n-tetradecyloxy carbonyl, and n-hexanedecyloxy carbonyl.

The amide group is preferably a C₁-C₂₀, more preferably a C₁-C₁₆, particularly preferably a C₁-C₁₂ amide group. Examples of the amide group include acetamide, ethyl carboxamide, n-propyl carboxamide, isopropyl carboxamide, n-butyl carboxamide, t-butyl carboxamide, iso-butyl carboxamide, sec-butyl carboxamide, n-pentyl carboxamide, t-amyl carboxamide, n-hexyl carboxamide, cyclohexyl carboxamide, 1-ethyl pentyl carboxamide, 1-ethylpropyl carboxamide, n-heptyl carboxamide, n-octyl carboxamide, 1-adamantane carboxamide, 2-adamantane carboxamide, n-nonyl carboxamide, n-dodecyl carboxamide, n-pentacarboxamide, and n-hexadecyl carboxamide.

The carbamoyl group is preferably a C₁-C₂₀, more preferably a C₁-C₁₆, particularly preferably a C₁-C₁₂ carbamoyl group. Examples of the carbamoyl group include methyl carbamoyl, dimethyl carbamoyl, ethyl carbamoyl, diethyl carbamoyl, n-propyl carbamoyl, isopropyl carbamoyl, n-butyl carbamoyl, t-butyl carbamoyl, iso-butyl carbamoyl, sec-butyl carbamoyl, n-pentyl carbamoyl, t-amyl carbamoyl, n-hexyl carbamoyl, cyclohexyl carbamoyl, 2-ethylhexyl carbamoyl, 2-ethylbutyl carbamoyl, t-octyl carbamoyl, n-heptyl carbamoyl, n-octyl carbamoyl, 1-adamantane carbamoyl, 2-adamantane carbamoyl, n-decyl carbamoyl, n-dodecyl carbamoyl, n-tetradecyl carbamoyl, and n-hexadecyl carbamoyl. Y²¹ and Y²² may be connected to each other to form a ring. Y²¹ and Y²² may further have substituents. Examples of these substituents include groups which may substitute on R¹¹ to R¹³.

The compounds of the formulae (4) to (12) will be further described hereinafter.

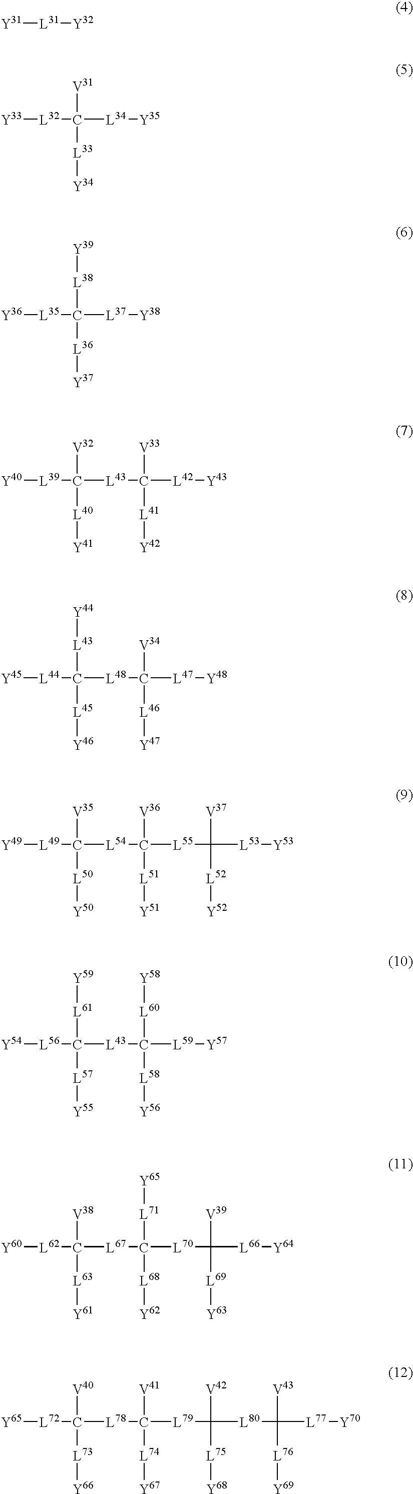

In the formulae (4) to (12), Y³¹ to Y⁷⁰ each independently represent an ester, alkoxycarbonyl, amide, carbamoyl or hydroxyl group. The ester group preferably has from 1 to 20 carbon atoms, more preferably from 1 to 16 carbon atoms, particularly preferably from 1 to 12 carbon atoms. Examples of these ester groups include acetoxy, ethylcarbonyloxy, propylcarbonyloxy, n-butyl carbonyloxy, iso-butylcarbonyoxy, t-butylcarbonyloxy, sec-butylcarbonyloxy, n-pentylcarbonyloxy, t-amyl carbonyloxy, n-hexylcarbonyloxy, cyclohexyl carbonyloxy, 1-ethylpentylcarbonyloxy, n-heptyl carbonyloxy, n-nonylcarbonyloxy, n-undecyl carbonyloxy, benzylcarbonyloxy, 1-naphthalenecarbonyloxy, 2-naphthalenecarbonyloxy, and 1-adamantanecarbonyloxy.

The alkoxycarbonyl group is preferably a C₁-C₂₀, more preferably a C₁-C₁₆, particularly preferably a C₁-C₁₂ alkoxycarbonyl group. Examples of the alkoxycarbonyl group include methoxycarbonyl, ethoxycarbonyl, n-propyl oxycarbonyl, isopropyloxycarbonyl, n-butoxycarbonyl, t-butoxycarbonyl, iso-butyloxycarbonyl, sec-butyloxy carbonyl, n-pentyloxycarbonyl, t-amyloxycarbonyl, n-hexyloxycarbonyl, cyclohexyloxycarbonyl, 2-ethylhexyl oxycarbonyl, 1-ethylpropyloxycarbonyl, n-octyloxy carbonyl, 3,7-dimethyl-3-octyloxycarbonyl, 3,5,5-trimethylhexyloxycarbonyl, 4-t-butylcylohexyloxy carbonyl, 2,4-dimethylpentyl-3-oxycarbonyl, 1-adamantaneoxycarbonyl, 2-adamantaneoxycarbonyl, dicyclopentanedienyloxycarbonyl, n-decyloxycarbonyl, n-dodecyloxycarbonyl, n-tetradecyloxycarbonyl, and n-hexadecyloxycarbonyl.

The amide group is preferably a C₁-C₂₀, more preferably a C₁-C₁₆, particularly preferably a C₁-C₁₂ amide group. Examples of the amide group include acetamide, ethyl carboxamide, n-propyl carboxamide, isopropyl carboxamide, n-butyl carboxamide, t-butyl carboxamide, iso-butyl carboxamide, sec-butyl carboxamide, n-pentyl carboxamide, t-amyl carboxamide, n-hexyl carboxamide, cyclohexyl carboxamide, 1-ethyl pentyl caroxamide, 1-ethylpropyl carboxamide, n-heptyl carboxamide, n-octyl carboxamide, 1-adamantane carboxamide, 2-adamantane carboxamide, n-nonyl carboxamide, n-dodecyl carboxamide, n-pentacarboxamide, and n-hexadecyl carboxamide.

The carbamoyl group is preferably a C₁-C₂₀, more preferably a C₁-C₁₆, particularly preferably a C₁-C₁₂ carbamoyl group. Examples of the carbamoyl group include methyl carbamoyl, dimethyl carbamoyl, ethyl carbamoyl, diethyl carbamoyl, n-propyl carbamoyl, isopropyl carbamoyl, n-butyl carbamoyl, t-butyl carbamoyl, iso-butyl carbamoyl, sec-butyl carbamoyl, n-pentyl carbamoyl, t-amyl carbamoyl, n-hexyl carbamoyl, cyclohexyl carbamoyl, 2-ethylhexyl carbamoyl, 2-ethylbutyl carbamoyl, t-octyl carbamoyl, n-heptyl carbamoyl, n-octyl carbamoyl, 1-adamantane carbamoyl, 2-adamantane carbamoyl, n-decyl carbamoyl, n-dodecyl carbamoyl, n-tetradecyl carbamoyl, and n-hexadecyl carbamoyl. Y³¹ to Y⁷⁰ may further have substituents. Examples of these substituents include the aforementioned groups which may substitute on R¹¹ to R¹³.

V³¹ to V⁴³ each independently represent a hydrogen atom or a preferably C₁-C₂₀, more preferably a C₁-C₁₆, particularly preferably a C₁-C₁₂ aliphatic group. The aliphatic group is preferably an aliphatic hydrocarbon group, more preferably an alkyl group (including chain-like, branched and cyclic alkyl groups), alkenyl group or alkynyl group. Examples of the alkyl group include methyl, ethyl, n-propyl, isopropyl, n-butyl, isobutyl, sec-butyl, t-butyl, n-pentyl, t-amyl, n-hexyl, n-octyl, decyl, dodecyl, eicosyl, 2-ethylhexyl, cyclopentyl, cyclohexyl, cycloheptyl, 2,6-dimethyl cyclohexyl, 4-t-butylcyclohexyl, cyclopentyl, 1-adamantyl, 2-adamantyl, and bicyclo[2.2.2]octane-3-il. Examples of the alkenyl group include vinyl, allyl, prenyl, gelanyl, oleyl, 2-cyclopentene-1-il, and 2-cyclohexene-1-il. V³¹ to V⁴³ may further have substituents. Examples of these substituents include groups which may substitute on R¹¹ to R¹³.

L³¹ to L⁸⁰ each independently represent a divalent saturated connecting group having from 0 to 40 atoms and from 0 to 20 carbon atoms. The fact that the number of atoms in each of L³¹ to L⁸⁰ is 0 means that the group at the both ends of the connecting group itself forms a single bond. Preferred examples of L³¹ to L⁷⁷ include alkylene groups (e.g., methylene, ethylene, propylene, trimethylene, tetramethylene, pentamethylene, hexamethylene, methylethylene, ethylethylene), divalent cyclic groups (e.g., cis-1,4-cyclohexylene, trans-1,4-cyclohexylene, 1,3-cyclopentylidene), ethers, thioethers, amides, sulfones, sulfoxides, sulfides, sulfonamides, ureilenes, and thioureilenes. These divalent groups may be connected to each other to form a divalent composite substituent. Examples of the composite substituent include KCH₂)₂O(CH₂)₂—, —(CH₂)₂O(CH₂)₂O(CH₂)—, —(CH₂)₂S(CH₂)—, and —(CH₂)₂O₂C(CH₂)₂—. L³¹ to L⁸⁰ may further have substituents. Examples of these substituents include groups which may substitute on R¹¹ to R¹³.

Preferred examples of the compounds formed by the combination of Y³¹ to Y⁷⁰, V³¹ to V⁴³ and L³¹ to L⁸⁰ in the formulae (4) to (12) include citric acid esters (e.g., triethyl O-acetylcitrate, tributyl O-acetylcitrate, acetyltriethyl citrate, acetyltributyl citrate, tri(ethyloxycarbonyl methylene)ester O-acetylcitrate), oleic acid esters (e.g., ethyl oleate, butyl oleate, 2-ethylhexyl oleate, phenyl oleate, cyclohexyl oleate, octyl oleate), ricinoleic acid esters (e.g., methylacetyl ricinoleate), sebacic acid esters (e.g., dibutyl sebacate), carboxylic acid esters of glycerin (e.g., triacetin, tributylin), glycolic acid esters (e.g., butyl phthalyl butyl glycolate, ethyl phthalyl ethyl glycolate, methyl phthalyl ethyl glycolate, butyl phthalyl butyl glycolate, methyl phthalyl methyl glycolate, propyl phthalyl propyl glycolate, butyl phthalyl butyl glycolate, octyl phthalyl octyl glycolate), carboxylic cid esters of pentaerythritol (e.g., pentaerythritol tetraacetate, pentaerythritol tetrabutyrate), carboxylic acid esters of dipentaerythritol (e.g., dipentaerthritol hexaacetate, dipentaerythritol hexabutyrate, dipentaerythritol tetraacetate), carboxylic acid esters of trimethylolpropane (e.g., trimethylolpropane triacetate, trimethylolpropane diacetate monopropionate, trimethylolpropane tripropionate, trimethylolpropane tributyrate, trimethylolpropane tripivaloate, trimethylolpropane tri(t-butylacetate), trimethylolpropane 2-ethylhexanate, trimethylolpropane tetra(2-ethylhexanate), trimethylolpropane diacetate monooctanate, trimethylolpropane trioctanate, trimethylolpropane tri (cyclohexanecarboxylate)), glycerolesters disclosed in JP-A-11-246704, diglycerolesters disclosed in JP-A-2000-63560, and citric acid esters, pyrrolidonecarboxylic acid esters (e.g., methyl 2-pyrrolidone-5-carboxylate, ethyl 2-pyrrolidone-5-carboxylate, butyl 2-pyrrolidone-5-carboxylate, 2-ethylhexyl 2-pyrrolidone-5-carboxylate), cyclohexanedicarboxylic acid esters (e.g., butyl cis-1,2-cyclohexanedicarboxylate, dibutyl trans-1,2-cyclohexanedicarboxylate, dibutyl cis-1,4-cyclohexanedicarboxylate, dibutyl trans-1,4-cyclohexanedicarboxylate) and xylytolcarboxylic acid esters (e.g., xylytol pentaacetate, xylytol tetraacetate, xylitol pentapropionate) disclosed in JP-A-11-92574.

Examples of the compounds represented by the formulae (1) to (12) of the invention will be given below, but the invention is not limited thereto. For the compound (1), Compounds C-1 to C-76 will be exemplified below. For the compounds (2) to (12), Compounds C-201 to C-231 and C-401 to C-448 will be exemplified below. The value of log P set forth in the tables below and the parenthesis were determined by Crippen's fragmentation method (J. Chem. Inf. Comut. Sci., 27, 21 (1987)).

| compound | R¹ | R² | R³ | logP |
|---|---|---|---|---|
| C-1 | CH₃ | C₂H₆ | C₂H₅ | 1.24 |
| C-2 | C₂H₅ | C₂H₆ | C₂H₆ | 1.58 |
| C-3 | C₃H₇ | C₃H₇ | C₃H₇ | 2.99 |
| C-4 | i-C₃H₇ | i-C₃H₇ | i-C₃H₇ | 2.82 |
| C-5 | C₄H₉ | C₄H₉ | C₄H₉ | 4.18 |
| C-6 | i-C₄H₉ | i-C₄H₉ | i-C₄H₉ | 4.2 |
| C-7 | s-C₄H₉ | s-C₄H₉ | s-C₄H₉ | 4.23 |
| C-8 | t-C₄H₉ | t-C₄H₉ | t-C₄H₉ | 3.06 |
| C-9 | C₅H₁₁ | C₅H₁₁ | C₅H₁₁ | 5.37 |
| C-10 | CH₂C(CH₃)₃ | CH₂C(CH₃)₃ | CH₂C(CH₃)₃ | 5.71 |
| C-11 | c-C₅H₉ | c-C₅H₉ | c-C₅H₉ | 4.12 |
| C-12 | 1-ethylpropyl | 1-ethylpropyl | 1-ethylpropyl | 5.63 |
| C-13 | C₆H₁₃ | C₆H₁₃ | C₆H₁₃ | 6.55 |
| C-14 | c-C₈H₁₁ | c-C₈H₁₁ | c-C₆H₁₁ | 5.31 |
| C-15 | C₇H₁₅ | C₇H₁₅ | C₇H₁₅ | 7.74 |
| C-16 | 4-methylcyclohexyl | 4-methylcyclohexyl | 4-methylcyclohoxyl | 6.3 |
| C-17 | 4-t-butylcyclohexyl | 4-t-butylcyclohexyl | 4-t-butylcyclohexyl | 9.78 |
| C-18 | C₈H₁₇ | C₈H₁₇ | C₈H₁₇ | 8.93 |
| C-19 | 2-ethylhexyl | 2-ethylhexyl | 2-ethylhexyl | 8.95 |
| C-20 | 3-methylbutyl | 3-methylbutyl | 3-methylbutyl | 5.17 |
| C-21 | 1,3-dimethylbutyl | 1,3-dimethylbutyl | 1,3-dimethylbutyl | 6.41 |
| C-22 | 1-isopropyl-2-methylpropyl | 1-isopropyl-2-methylpropyl | 1-isopropyl-2-methylpropyl | 8.05 |
| C-23 | 2-ethylbutyl | 2-ethylbutyl | 2-ethylbutyl | 6.57 |
| C-24 | 3,5,5-trimethylhexyl | 3,5,5-trimethylhexyl | 3,5,5-trimethylhexyl | 9.84 |
| C-25 | cyclohexylmethyl | cyclohexylmethyl | cyclohexylmethyl | 6.25 |
| C-26 | CH₃ | CH₃ | 2-ethylhexyl | 3.35 |
| C-27 | CH₃ | CH₃ | 1-adamantyl | 2.27 |
| C-28 | CH₃ | CH₃ | C₁₂H₂₅ | 4.93 |
| C-29 | C₂H₅ | C₂H₅ | 2-ethylhexyl | 4.04 |
| C-30 | C₂H₅ | C₂H₅ | 1-adamantyl | 2.96 |
| C-31 | C₂H₅ | C₂H₅ | C₁₂H₂₆ | 5.62 |
| C-32 | C₄H₉ | C₄H₉ | cyclohexyl | 4.55 |
| C-33 | C₄H₉ | C₄H₉ | C₆H₁₃ | 4.97 |
| C-34 | C₄H₉ | C₄H₉ | C₈H₁₇ | 5.76 |
| C-35 | C₄H₉ | C₄H₉ | 2-ethylhexyl | 5.77 |
| C-36 | C₄H₉ | C₄H₉ | C₁₀H₂₁ | 6.55 |
| C-37 | C₄H₉ | C₄H₉ | C₁₂H₂₅ | 7.35 |
| C-38 | C₄H₉ | C₄H₉ | 1-adamantyl | 4.69 |
| C-39 | C₄H₉ | C₄H₉ | C₁₆H₃₃ | 8.93 |
| C-40 | C₄H₉ | C₄H₉ | dicyclopentadienyl | 4.68 |
| C-41 | C₆H₁₃ | C₆H₁₃ | C₁₄H₂₉ | 9.72 |
| C-42 | C₆H₁₃ | C₆H₁₃ | C₈H₁₇ | 7.35 |
| C-43 | C₆H₁₃ | C₆H₁₃ | 2-ethylhexyl | 7.35 |
| C-44 | C₆H₁₃ | C₆H₁₃ | C₁₀H₂₁ | 8.14 |
| C-45 | C₆H₁₃ | C₆H₁₃ | C₁₂H₂₅ | 8.93 |
| C-46 | C₆H₁₃ | C₆H₁₃ | 1-adamantyl | 6.27 |
| C-47 | 4-chlorobutyl | 4-chlorobutyl | 4-chlorobutyl | 4.18 |
| C-48 | 4-chlorohexyl | 4-chlorohexyl | 4-chlorohexyl | 6.65 |
| C-49 | 4-bromobutyl | 4-bromobutyl | 4-bromobutyl | 4.37 |
| C-50 | 4-bromohexyl | 4-broutohexyl | 4-bromohexyl | 6.74 |
| C-51 | (CH₂)₂OCH₂CH₃ | (CH₂)₂OCH₂CH₃ | (CH₂)₂OCH₂CH₃ | 1.14 |
| C-52 | C₈H₁₇ | C₈H₁₇ | (CH₂)₂O(CH₂)₂OCH₂CH₃ | 6.55 |
| C-53 | C₆H₁₃ | C₆H₁₃ | (CH₂)₂O(CH₂)₂OCH₂CH₃ | 4.96 |
| C-54 | C₄H₉ | C₄H₉ | (CH₂)₂O(CH₂)₂OCH₂CH₃ | 3.38 |
| C-55 | C₄H₉ | C₅H₉ | (CH₂)₂O(CH₂)₂OCH₂OH | 2.59 |
| C-56 | C₆H₁₃ | C₆H₁₃ | (CH₂)₂O(CH₂)₂OCH₂OH | 4.18 |
| C-57 | C₈H₁₇ | C₈H₁₇ | (CH₂)₂O(CH₂)₂OCH₂OH | 5.76 |
| C-58 | C₄H₉ | (CH₂)₂O(CH₂)₂OCH₂OH | (CH₂)₂O(CH₂)₂OCH₂OH | 2.2 |
| C-59 | C₄H₉ | C₄H₉ | CH₂CH═CH₂ | 4.19 |
| C-60 | C₄H₉ | CH₂CH═CH₂ | CH₂CH═CH₂ | 3.64 |
| C-61 | (CH₂)₂CO₂CH₂CH₃ | (CH₂)₂CO₂CH₂CH₃ | (CH₂)₂CO₂CH₂CH₃ | 1.1 |
| C-62 | (CH₂)₂CO₂(CH₂)₃CH₃ | (CH₂)₂CO₂(CH₂)₃CH₃ | (CH₂)₂CO₂(CH₂)₃CH₃ | 3.69 |
| C-63 | (CH₂)₂CONH(CH₂)₃CH₃ | (CH₂)₂CONH(CH₂)₃CH₃ | (CH₂)₂CONH(CH₂)₃CH₃ | 1.74 |
| C-64 | C₄H₉ | C₄H₉ | (CH₂)₄OP═O(OC₄H₉)₂ | 6.66 |
| C-65 | C₄H₉ | C₄H₉ | (CH₂)₃OP═O(OC₄H₉)₂ | 6.21 |
| C-66 | C₄H₉ | C₄H₉ | (CH₂)₂OP═O(OC₄H₉)₂ | 6.16 |
| C-67 | C₄H₉ | C₄H₉ | (CH₂)₂O(CH₂)₂OP═O(OC₄H₉)₂ | 5.99 |
| C-68 | C₆H₁₃ | C₆H₁₃ | (CH₂)₂O(CH₂)₂OP═O(OC₄H₉)₂ | 7.58 |
| C-69 | C₆H₁₃ | C₆H₁₃ | (CH₂)₄OP═O(OC₄H₉)₂ | 8.25 |
| C-70 | c-C₆H₁₃ | c-C₆H₁₃ | (CH₂)₂O(CH₂)₂OP═O(OC₄H₉)₂ | 6.35 |
| C-71 | C₆H₁₂Cl | C₆H₁₂Cl | (CH₂)₂O(CH₂)₂OP═O(OC₄H₉)₂ | 7.18 |
| C-72 | C₄H₈Cl | C₄H₈Cl | (CH₂)₂O(CH₂)₂OP═O(OC₄H₉)₂ | 5.6 |
| C-73 | C₄H₈Cl | C₄H₈Cl | (CH₂)₂O(CH₂)₂OP═O(OC₄H₈Cl)₂ | 5.59 |
| C-74 | C₄H₉ | C₄H₉ | 2-tetrahydrofuranyl | 3.27 |
| C-75 | C₄H₉ | 2-tetrahydrofuranyl | 2-tetrahydrofuranyl | 2.36 |
| C-76 | 2-tetrahydrofuranyl | 2-tetrahydrofuranyl | 2-tetrahydrofuranyl | 1.45 |

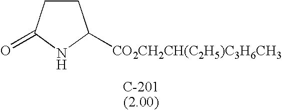

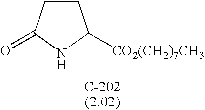

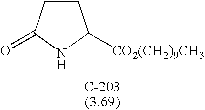

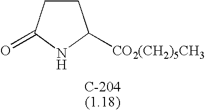

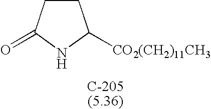

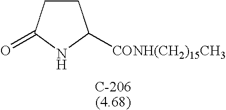

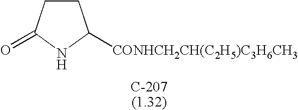

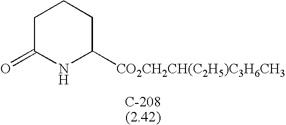

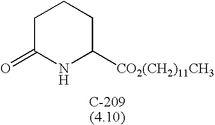

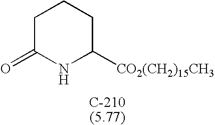

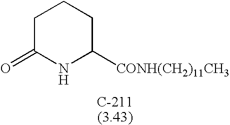

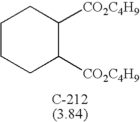

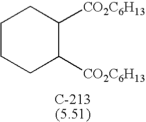

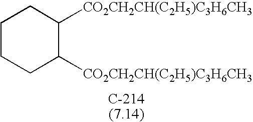

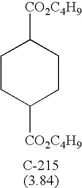

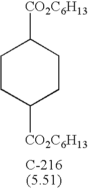

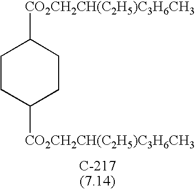

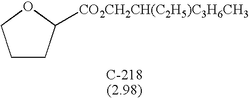

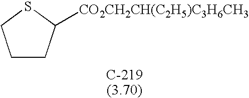

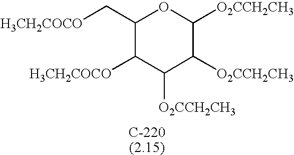

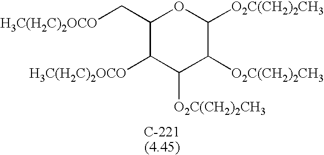

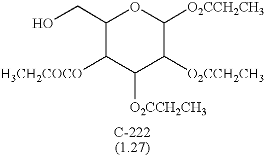

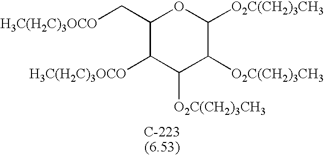

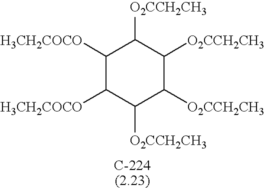

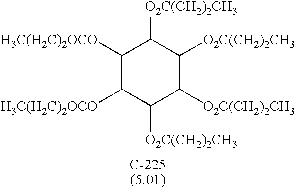

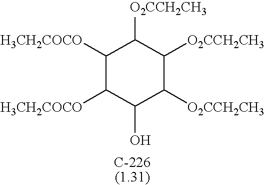

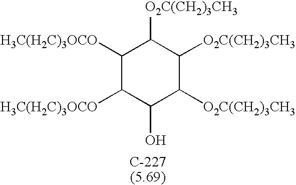

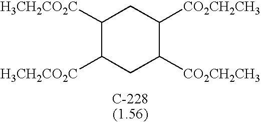

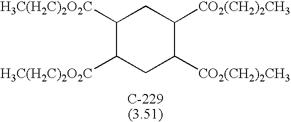

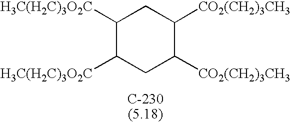

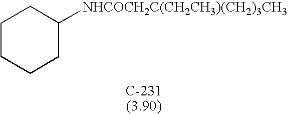

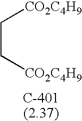

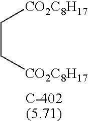

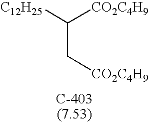

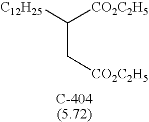

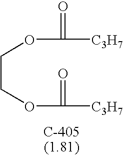

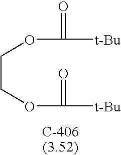

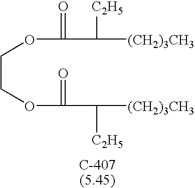

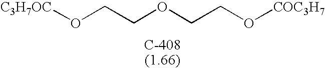

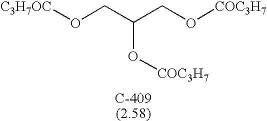

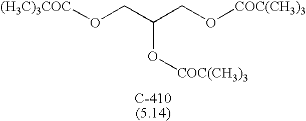

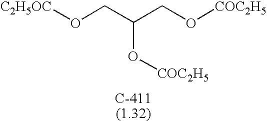

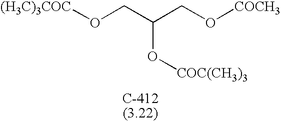

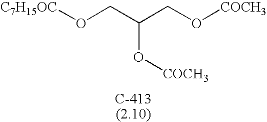

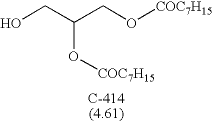

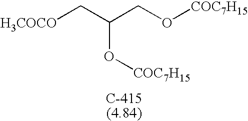

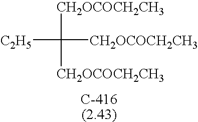

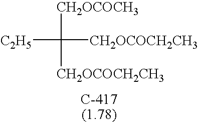

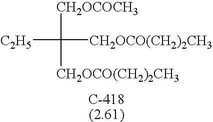

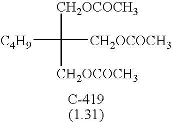

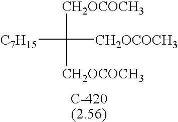

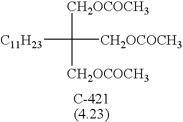

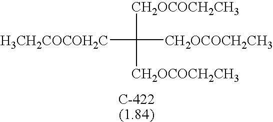

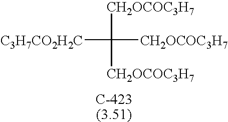

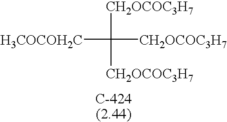

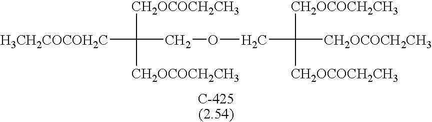

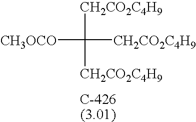

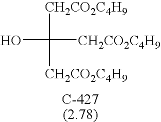

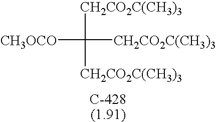

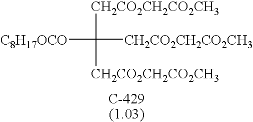

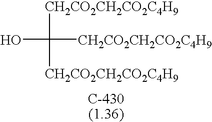

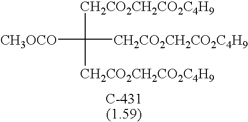

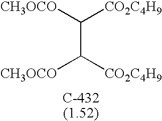

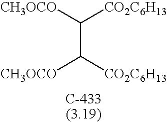

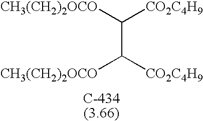

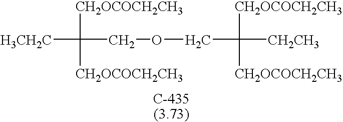

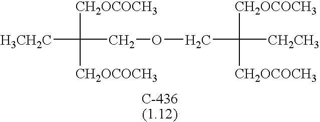

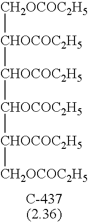

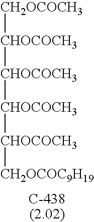

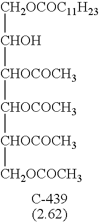

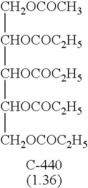

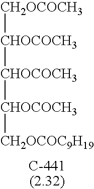

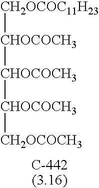

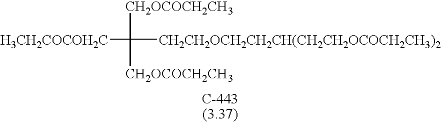

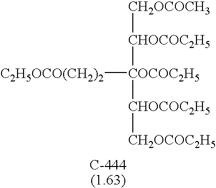

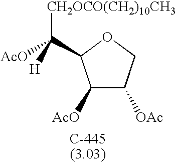

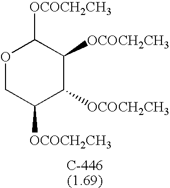

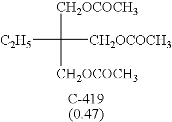

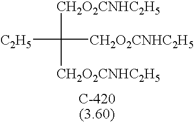

The compounds of the formulae (13) and (14) will be further described hereinafter.

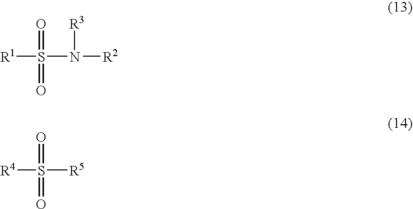

In the formula (13), R¹ represents an alkyl or aryl group and R² and R³ each independently represent a hydrogen atom or an alkyl or aryl group. It is particularly preferred that the total sum of the number of carbon atoms in R¹, R² and R³ be 10 or more. In the formula (14), R⁴ and R⁵ each independently represent an alkyl or aryl group. The total sum of the number of carbon atoms in R⁴ and R⁵ is 10 or more. The alkyl and aryl groups each may have substituents. Preferred examples of these substituents include fluorine atoms, alkyl groups, aryl groups, alkoxy groups, sulfone groups, and sulfonamide groups. Particularly preferred among these substituents are alkyl groups, aryl groups, alkoxy groups, sulfone groups and sulfonamide groups.

The aforementioned alkyl group may be straight-chain, branched or cyclic. The alkyl group preferably has from 1 to 25 carbon atoms, more preferably from 6 to 25 atoms, particularly preferably from 6 to 20 carbon atoms (e.g., methyl, ethyl, propyl, isopropyl, butyl, isobutyl, t-butyl, amyl, isoamyl, t-amyl, hexyl, cyclohexyl, heptyl, octyl, bicyclooctyl, nonyl, adamanthyl, decyl, t-octyl, undecyl, dodecyl, tridecyl, tetradecyl, pentadecyl, hexadecyl, heptadecyl, octadecyl, nonadecyl, didecyl). The aforementioned aryl group preferably has from 6 to 30 carbon atoms, particularly preferably from 6 to 24 carbon atoms (e.g., phenyl, biphenyl, terphenyl, naphthyl, binaphthyl, triphenylphenyl). Preferred examples of the compounds represented by the formula (13) or (14) will be given below, but the invention is not limited thereto.

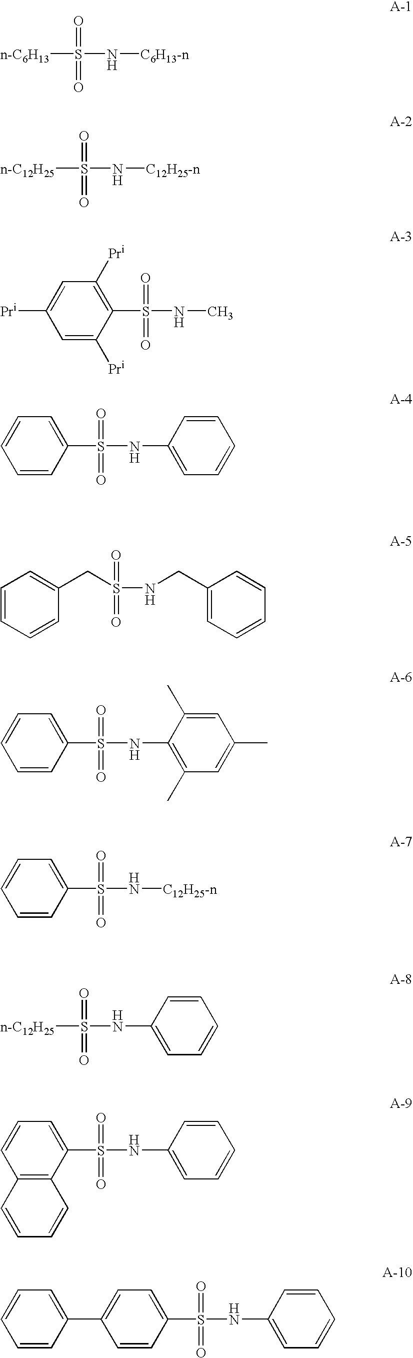

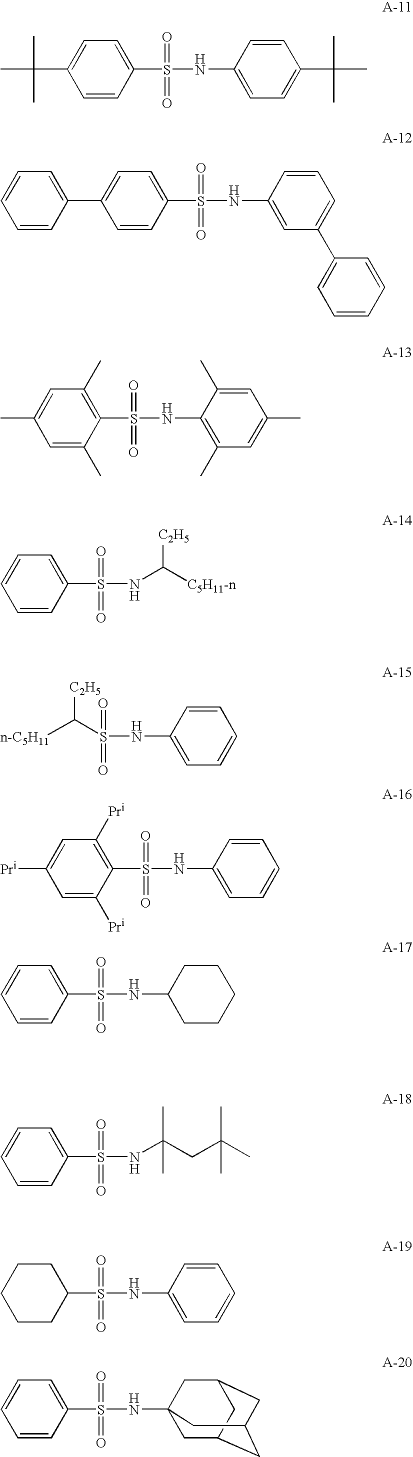

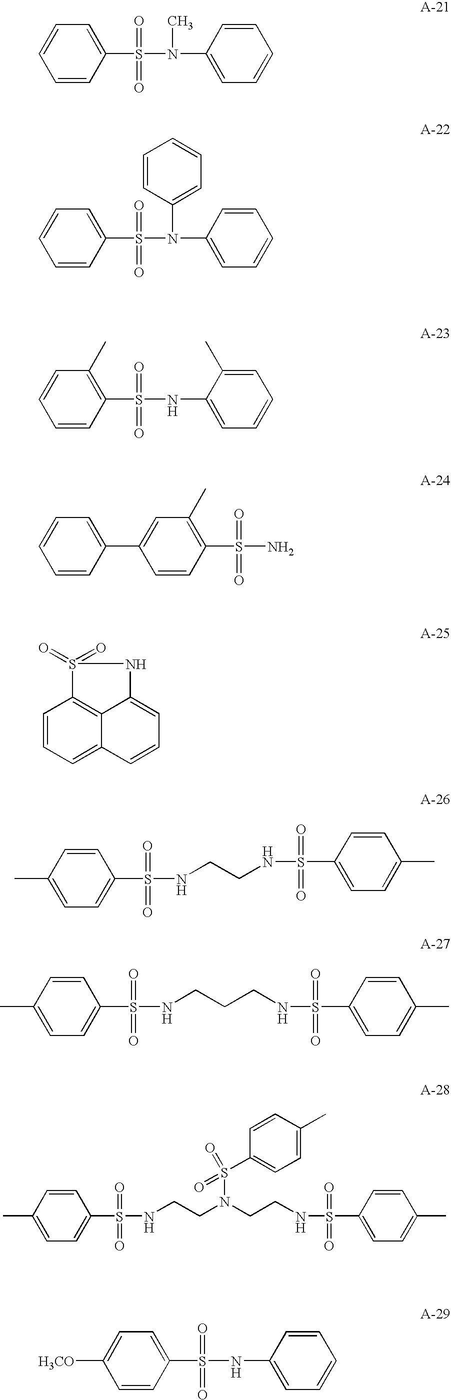

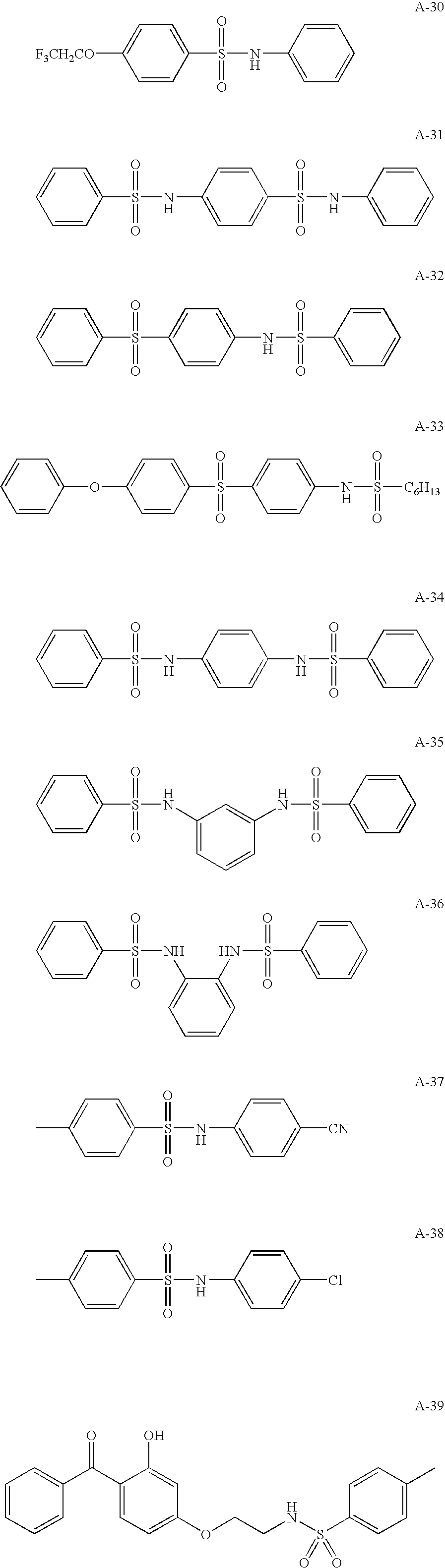

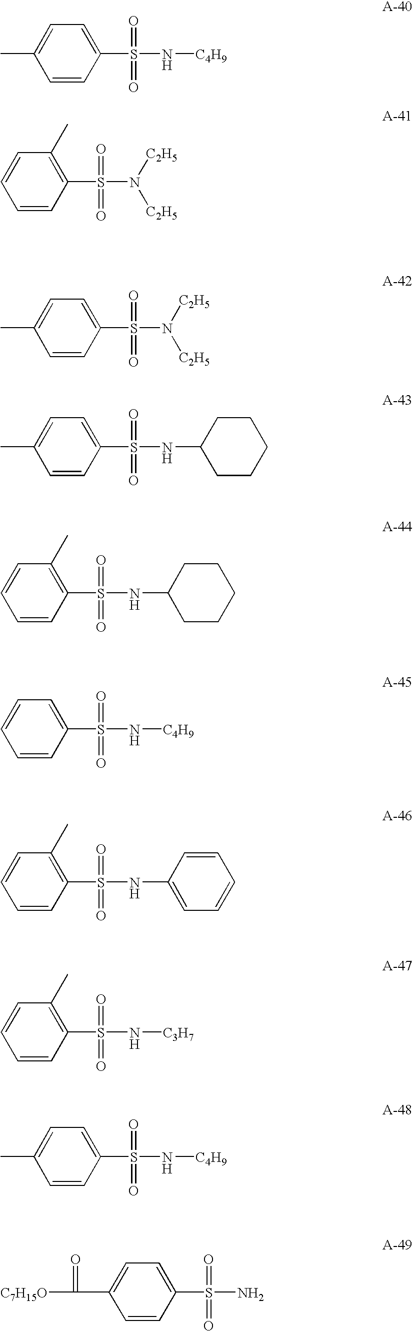

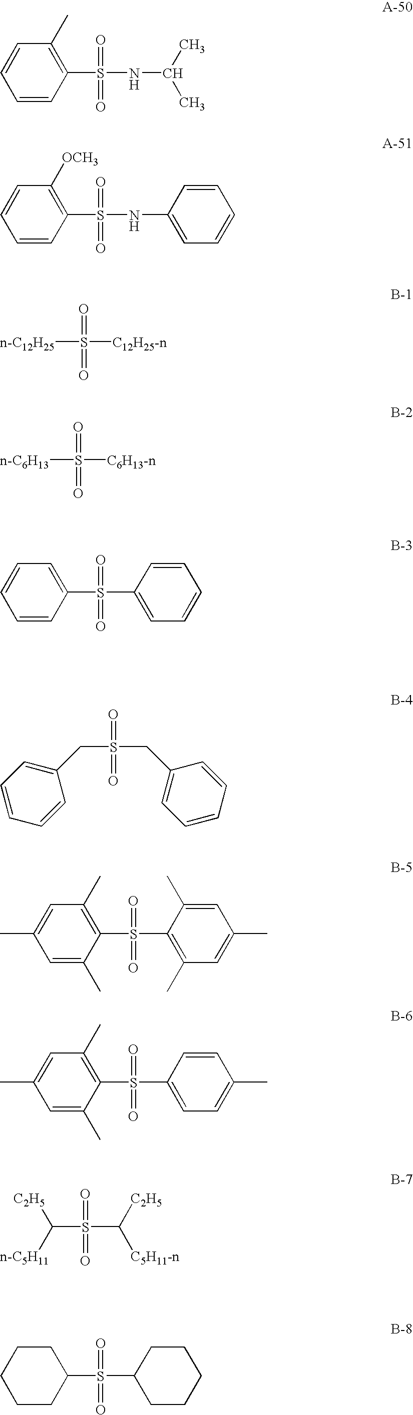

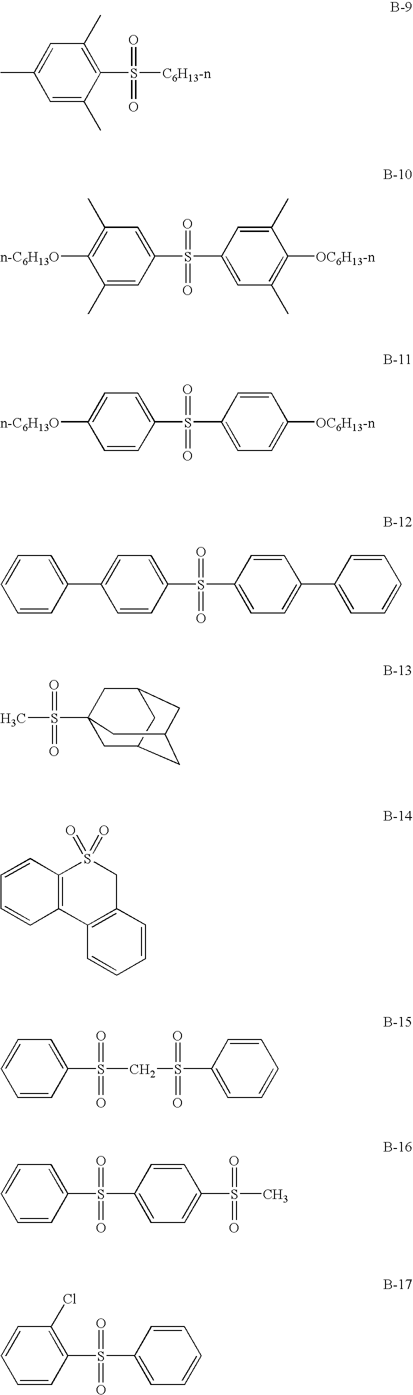

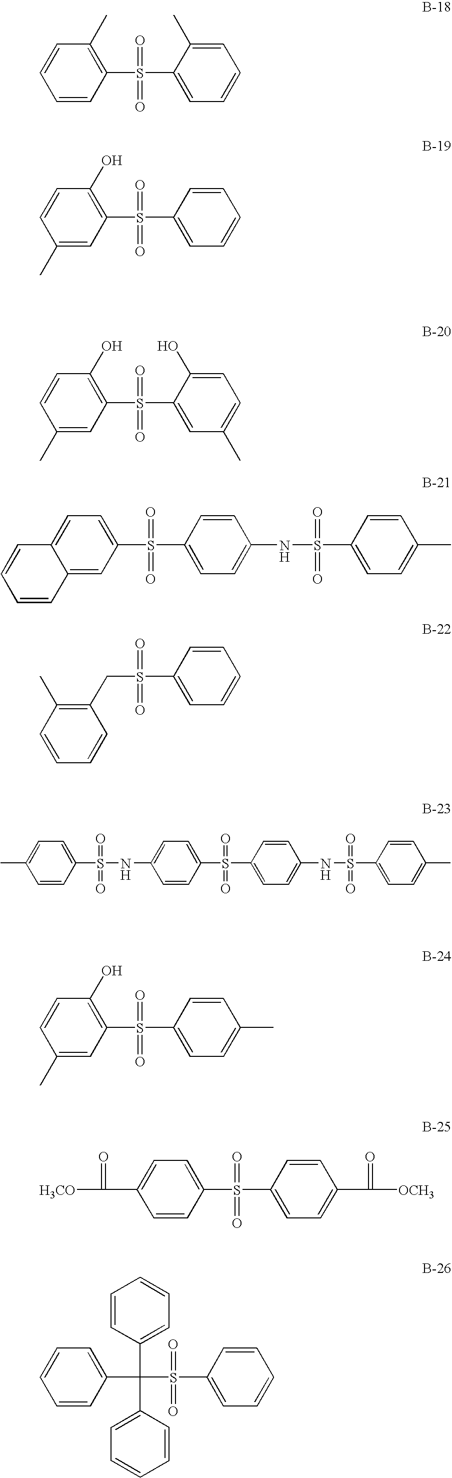

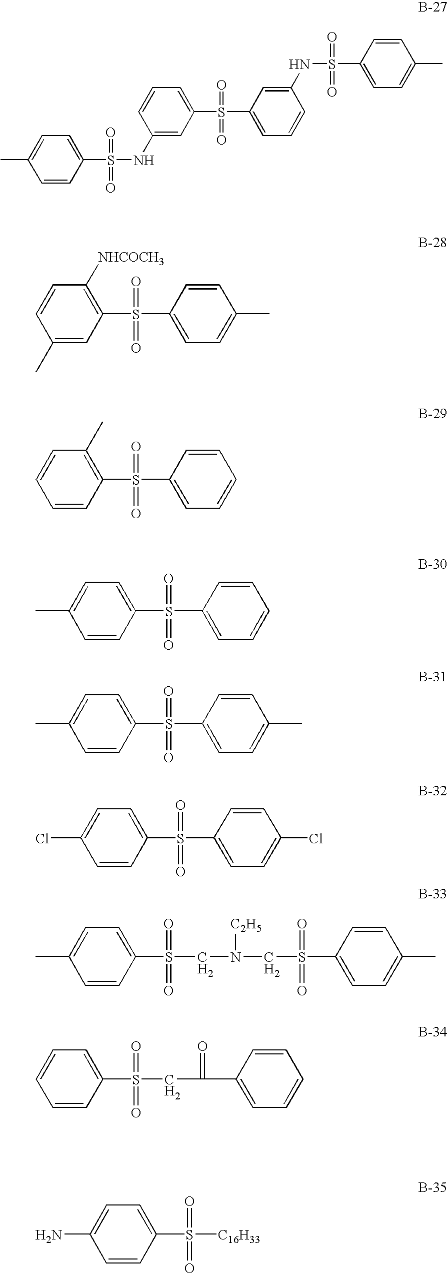

The compound of the formula (15) will be further described hereinafter.

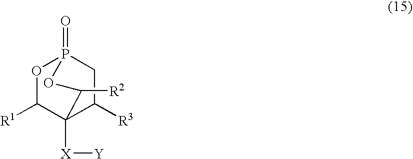

In the formula (15), R¹, R² and R³ each preferably independently represent a hydrogen atom or a C₁-C₅ alkyl group (e.g., methyl, ethyl, propyl, isopropyl, butyl, amyl, isoamyl). It is particularly preferred that at least one of R¹, R² and R³ be a C₁-C₃ alkyl group (e.g., methyl, ethyl, propyl, isopropyl). X is preferably a divalent connecting group formed by one or more groups selected from the group consisting of single bond, —O—, —CO—, alkylene group (preferably a C₁-C₆, more preferably a C₁-C₃ alkylene group such as methylene, ethylene and propylene) and arylene group (preferably a C₆-C₂₄, more preferably C₆-C₁₂ arylene group such as phenylene, biphenylene and naphthylene), particularly preferably a divalent connecting group formed by one or more groups selected from the group consisting of —O—, alkylene group and arylene group.

Y represents a hydrogen atom, an alkyl group (preferably a C₂-C₂₅, more preferably a C₂-C₂₀ alkyl group such as ethyl, isopropyl, t-butyl, hexyl, 2-ethylhexyl, t-octyl, dodecyl, cyclohexyl, dicyclohexyl and adamanthyl), an aryl group (preferably a C₆-C₂₄, more preferably a C₆-C₁₈ aryl group such as phenyl, biphenyl, terphenyl and naphthyl) or an aralkyl group (preferably a C₇-C₃₀, more preferably a C₇-C₂₀ aralkyl group such as benzyl, cresyl, t-butylphenyl, diphenyl and triphenyl methyl), particularly preferably an alkyl, aryl or aralkyl group.

Referring to the combination of —X—Y, the total sum of the number of carbon atoms in —X—Y is preferably from 0 to 40, more preferably from 1 to 30, most preferably from 1 to 25. Preferred examples of the compound represented by the formula (14) will be given below, but the invention is not limited thereto.

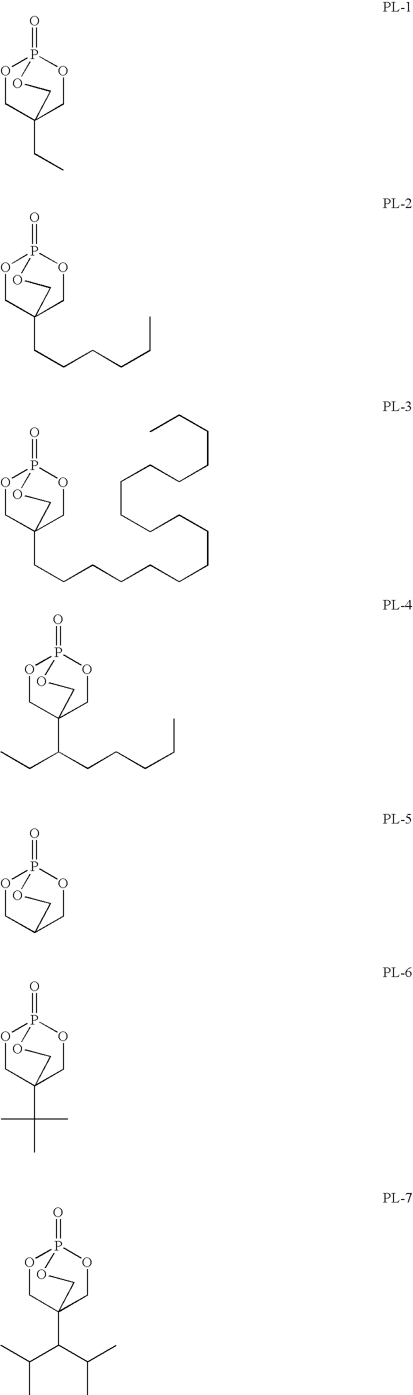

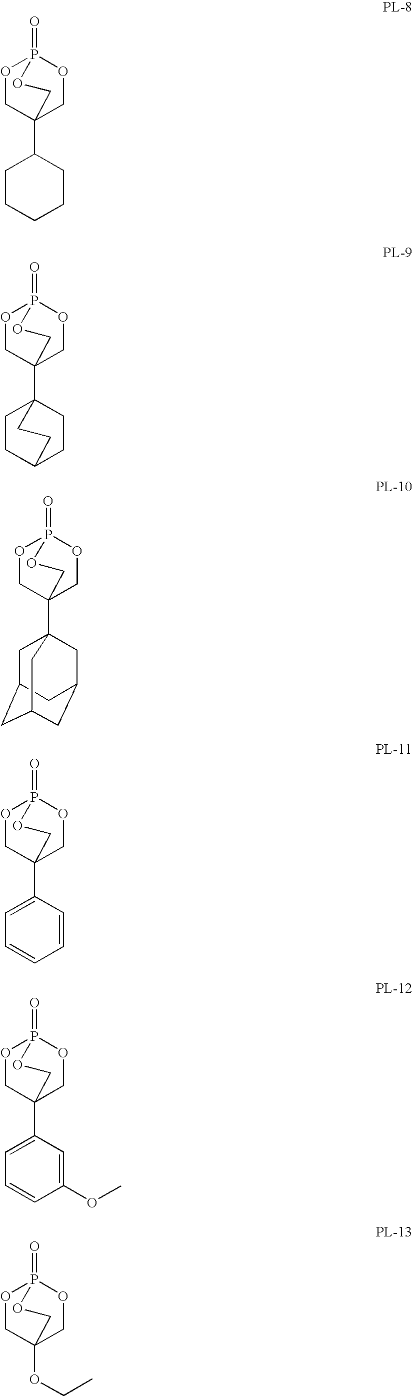

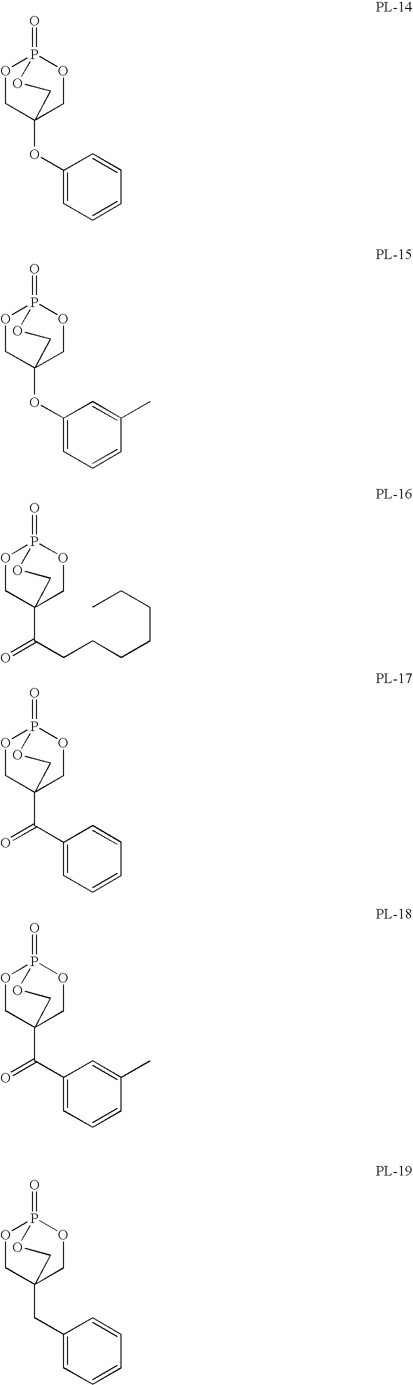

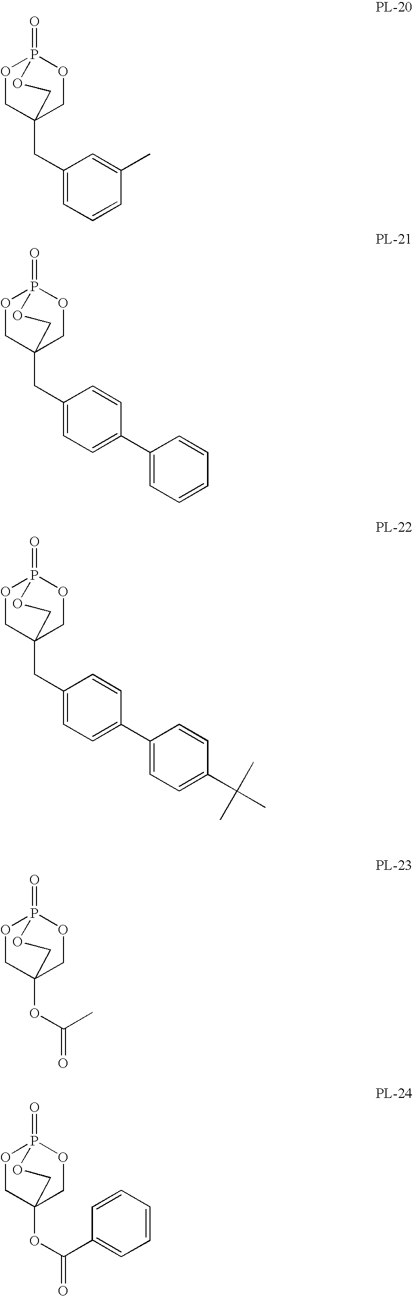

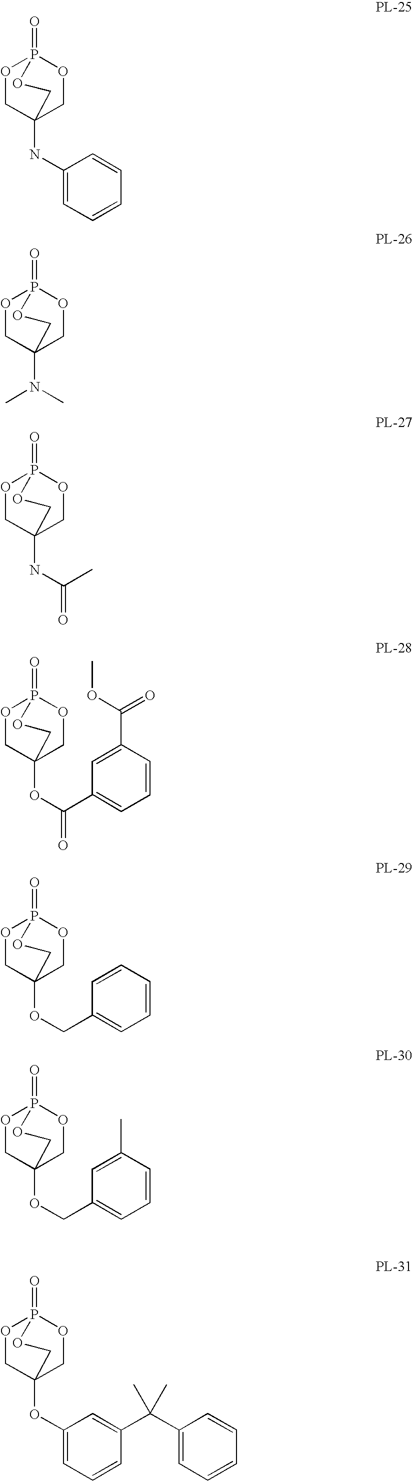

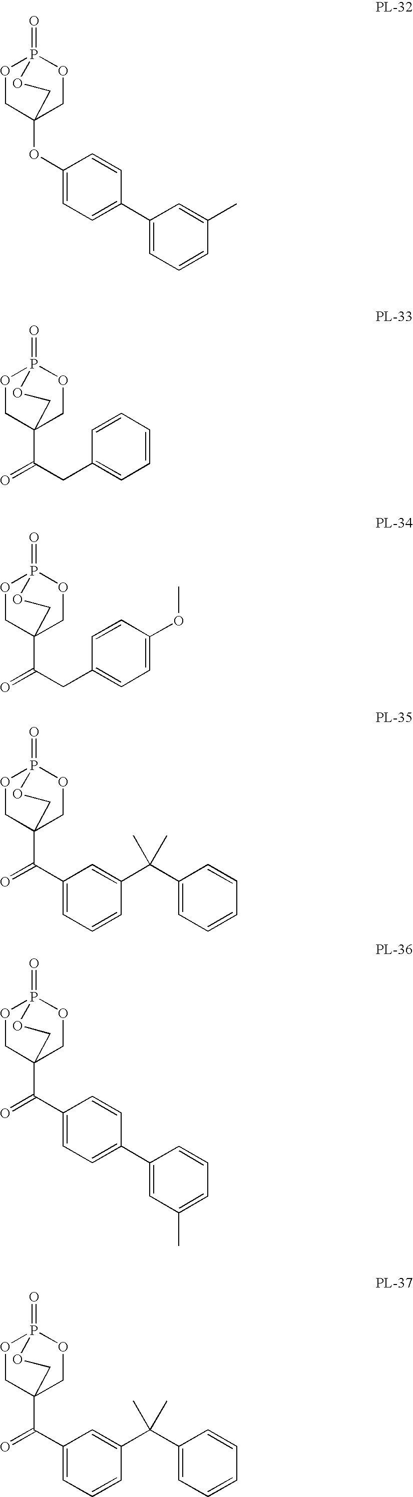

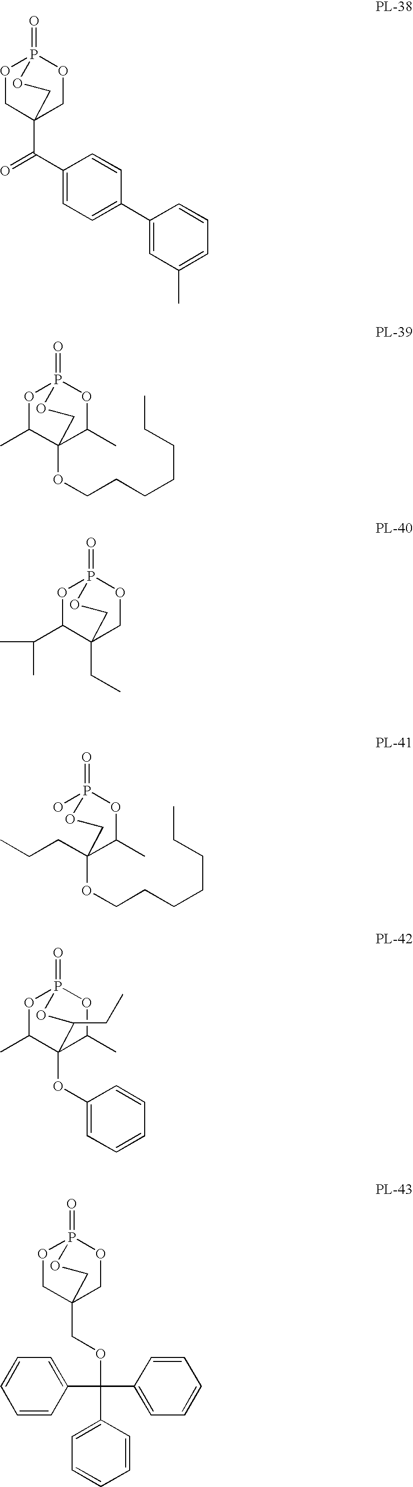

The compound of the formula (16) will be further described hereinafter.

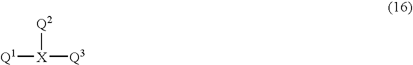

Q¹, Q² and Q³ each independently represent a 5- or 6-membered ring group which may be a hydrocarbon ring group or heterocyclic group. The ring group may be monocyclic or may form a condensed ring with other rings. The hydrocarbon ring is preferably a substituted or unsubstituted cyclohexane ring or cyclopentane ring or an aromatic hydrocarbon ring, more preferably aromatic hydrocarbon ring. The heterocyclic group is preferably a 5- or 6-membered ring containing at least one of oxygen atom, nitrogen atom and sulfur atom. The heterocyclic group is more preferably an aromatic heterocyclic group having at least one of oxygen atom, nitrogen atom and sulfur atom.

Q¹, Q² and Q³ each are preferably an aromatic hydrocarbon ring or aromatic heterocyclic group. The aromatic hydrocarbon ring is preferably a C₆-C₃₀ monocyclic or bicyclic aromatic hydrocarbon ring (e.g., benzene ring, naphthalene ring), more preferably a C₆-C₂₀ aromatic hydrocarbon ring, even more preferably a C₆-C₁₂ aromatic hydrocarbon ring. The aromatic hydrocarbon ring is still more preferably a benzene ring.

The aromatic heterocyclic group is preferably an aromatic heterocyclic group containing oxygen atom, nitrogen atom or sulfur atom. Specific examples of the heterocyclic group include furane, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthaladine, naphthylidine, quinoxaline, quinazoline, cinnoline, pteridine, acrydine, phenanthroline, phenazine, tetrazole, benzimidazole, benzoxazole, benzthiazole, benzotriazole, and tetrazaindene. Preferred among these aromatic heterocyclic groups are pyridine, triazine, and quinoline. Q¹, Q² and Q³ each are more preferably an aromatic hydrocarbon ring group, even more preferably benzene ring. Q¹, Q² and Q³ each may have substituents. Examples of these substituents include substituents T described later.

X represents B, C—R (in which R represents a hydrogen atom or substituent), N, P or P═O, preferably B, C—R (in which R represents an aryl group, substituted or unsubstituted amino group, alkoxy group, aryloxy group, acylamino group, alkoxycarbonylamino group, aryloxycarbonylamino group, sulfonylamino group, hydroxyl group, mercapto group, halogen atom (e.g., fluorine atom, chlorine atom, bromine atom, iodine atom) or carboxyl group, more preferably aryl group, alkoxy group, aryloxy group, hydroxyl group or halogen atom, even more preferably alkoxy group or hydroxyl group, particularly preferably hydroxyl group) or N, more preferably C—R or N, particularly preferably C—R.

The compound of the formula (16) is preferably a compound represented by the following formula (17). 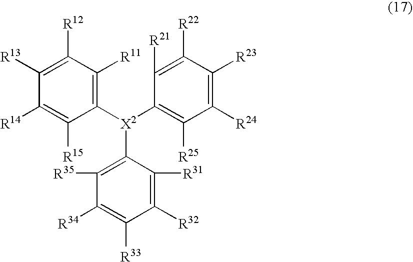
wherein X² represents B. C—R (in which R represents a hydrogen atom or substituent) or N; and R¹¹, R¹², R¹³, R¹⁴, R¹⁵, R²¹, R²², R²³, R²⁴, R²⁵, R³¹, R³², R³³, R³⁴ and R³⁵ each represent a hydrogen atom or substituent.

X represents B. C—R (in which R represents a hydrogen atom or substituent), N, P or P═O, preferably B. C—R (in which R represents an aryl group, substituted or unsubstituted amino group, alkoxy group, aryloxy group, acylamino group, alkoxycarbonylamino group, aryloxycarbonylamino group, sulfonylamino group, hydroxyl group, mercapto group, halogen atom (e.g., fluorine atom, chlorine atom, bromine atom, iodine atom) or carboxyl group, more preferably aryl group, alkoxy group, aryloxy group, hydroxyl group or halogen atom, even more preferably alkoxy group or hydroxyl group, particularly preferably hydroxyl group), N or P═O, more preferably C—R or N, particularly preferably C—R.

R¹¹, R¹², R¹³, R¹⁴, R¹⁵, R²¹, R²², R²³, R²⁴, R²⁵, R³¹, R³², R³³, R³⁴ and R³⁵ each represent a hydrogen atom or substituent. Examples of the substituents employable herein include the substituent T described later. R¹¹, R¹², R¹³, R¹⁴, R¹⁵, R²¹, R²², R²³, R²⁴, R²⁵, R³¹, R³², R³³, R³⁴ and R³⁵ each are an alkyl group, alkenyl group, alkynyl group, aryl group, substituted or unsubstituted amino group, alkoxy group, aryloxy group, acyl group, alkoxycarbonyl group, aryloxycarbonyl group, acyloxy group, acylamino group, alkoxycarbonylamino group, aryloxycarbonylamino group, sulfonylamino group, sulfamoyl group, carbamoyl group, alkylthio group, arylthio group, sulfonyl group, sulfinyl group, ureido group, phosphoric acid amide group, hydroxyl group, mercapto group, halogen atom (e.g., fluorine atom, chlorine atom, bromine atom, iodine atom), cyano group, sulfo group, carboxyl group, nitro group, hydroxamic acid group, sulfino group, hydrazino group, imino group, heterocyclic group (preferably a C₁-C₃₀, more preferably a C₁-C₁₂ heterocyclic group containing nitrogen atom, oxygen atom or sulfur atom as hetero atom, e.g., imidazolyl, pyridyl, quinolyl, furyl, piperidyl, morpholino, benzooxazolyl, benzimidazolyl, benzthiazolyl) or silyl group, more preferably alkyl group, aryl group, substituted or unsubstituted amino group, alkoxy group or aryloxy group, even more preferably alkyl group, aryl group or alkoxy group.

These substituents may be further substituted. Two or more of these substituents, if any, may be the same or different. If possible, these substituents may be connected to each other to form a ring.

The aforementioned substituent T will be further described hereinafter. Examples of the substituent T include alkyl groups (preferably a C₁-C₂₀, more preferably a C₁-C₁₂, particularly preferably a C₁-C₈ alkyl group, e.g., methyl, ethyl, iso-propyl, tert-butyl, n-octyl, n-decyl, n-hexadecyl, cyclopropyl, cyclopentyl, cyclohexyl), alkenyl groups (preferably a C₂-C₂₀, more preferably a C₂-C₁₂, particularly preferably a C₂-C₈ alkenyl group, e.g., vinyl, allyl, 2-butenyl, 3-pentenyl), alkynyl groups (preferably a C₂-C₂₀, more preferably a C₂-C₁₂, particularly preferably a C₂-C₈ alkynyl group, e.g., propargyl, 3-pentinyl group), aryl groups (preferably a C₆-C₃₀, more preferably a C₆-C₂₀, particularly preferably a C₆-C₁₂ aryl group, e.g., phenyl, p-methylphenyl, naphthyl), substituted or unsubstituted amino groups (preferably a C₀-C₂₀, more preferably a C₀-C₁₂, particularly preferably a C₀-C₈ alkoxy group, e.g., methoxy, ethoxy, butoxy), alkoxy groups (preferably a C₁-C₂₀, more preferably a C₁-C₁₂, particularly preferably a C₁-C₈ alkoxy group, e.g., methoxy, ethoxy, butoxy), aryloxy groups (preferably a C₆-C₂₀, more preferably a C₆-C₁₆, particularly preferably a C₆-C₁₂ aryloxy group, e.g., phenyloxy, 2-naphthyloxy), acyl groups (preferably a C₁-C₂₀, more preferably a C₁-C₁₆, particularly preferably a C₁-C₁₂ acyl group, e.g., acetyl, benzoyl, formyl, pivaloyl), alkoxycarbonyl groups (preferably a C₂-C₂₀, more preferably a C₂-C₁₆, particularly preferably a C₂-C₁₂ alkoxycarbonyl group, e.g., methoxycarbonyl, ethoxycarbonyl), aryloxycarbonyl groups (preferably a C₇-C₂₀, more preferably a C₇-C₁₆, particularly preferably a C₇-C₁₀ aryloxycarbonyl group, e.g., phenoxycarbonyl group), acyloxy groups (preferably a C₂-C₂₀, more preferably a C₂-C₁₆, particularly preferably a C₂-C₁₀ acyloxy group, e.g., acetoxy, benzoyloxy), acylamino groups (preferably a C₂-C₂₀, more preferably a C₂-C₁₆, particularly preferably a C₂-C₁₀ acrylamino group, e.g., acetylamino, benzoylamino), alkoxycarbonylamino groups (preferably a C₂-C₂₀, more preferably a C₂-C₁₆, particularly preferably a C₂-C₁₀ alkoxycarbonylamino group, e.g., methoxycarbonylamino), aryloxycarbonylamino groups (preferably a C₇-C₂₀, more preferably a C₇-C₁₆, particularly preferably C₇-C₁₂ aryloxycarbonylamino group, e.g., phenyloxycarbonyl amino), sulfonylamino groups (preferably a C₁-C₂₀, more preferably a C₁-C₁₆, particularly preferably a C₁-C₁₂ sulfonylamino group, e.g., methanesulfonylamino, benzenesulfonylamino), sulfamoyl groups (preferably a C₀-C₂₀, more preferably a C₀-C₁₆, particularly preferably a C₀-C₁₂ sulfamoyl group, e.g., sulfamoyl, methyl sulfamoyl, dimethyl sulfamoyl, phenyl sulfamoyl), carbamoyl groups (preferably a C₁-C₂₀, more preferably a C₁-C₁₆, particularly preferably a C₁-C₁₂ carbamoyl group, e.g., carbamoyl, methyl carbamoyl, diethyl carbamoyl, phenyl carbamoyl), alkylthio groups (preferably a C₁-C₂₀, more preferably a C₁-C₁₆, particularly preferably a C₁-C₁₂ alkylthio group, e.g., methylthio, ethylthio), arylthio groups (preferably a C₆-C₂₀, more preferably a C₆-C₁₆, particularly preferably a C₆-C₁₂ arylthio group, e.g., phenylthio), sulfonyl groups (preferably a C₁-C₂₀, more preferably a C₁-C₁₆, particularly preferably a C₁-C₁₂ sulfonyl group, e.g., mesyl, tosyl), sulfinyl groups (preferably a C₁-C₂₀, more preferably a C₁-C₁₆, particularly preferably a C₁-C₁₂ sulfinyl group, e.g., methanesulfinyl, benzenesulfinyl), ureido groups (preferably a C₁-C₂₀, more preferably a C₁-C₁₆, particularly preferably a C₁-C₁₂ ureido group, e.g., ureido, methylureido, phenylureido), phosphoric acid amide groups (preferably a C₁-C₂₀, more preferably a C₁-C₁₆, particularly preferably a C₁-C₁₂ phosphoric acid amide group, e.g., diethylphosphoric acid amide, phenylphosphoric acid amide), hydroxyl groups, mercapto groups, halogen atoms (e.g., fluorine atom, chlorine atom, bromine atom, iodine atom), cyano groups, sulfo groups, carboxyl groups, nitro groups, hydroxamic acid groups, sulfino groups, hydrazino groups, imino groups, heterocyclic groups (preferably a C₁-C₃₀, more preferably a C₁-C₁₂ heterocyclic group containing nitrogen atom, oxygen atom or sulfur atom as hetero atom, e.g., imidazolyl, pyridyl, furyl, piperidyl, morpholino, benzooxazolyl, benzimidazolyl, benzthiazolyl), and silyl groups (preferably a C₃-C₄₀, more preferably a C₃-C₃₀, particularly preferably a C₃-C₂₄ silyl group, e.g., trimethylsilyl, triphenylsilyl). These substituents may be further substituted. Two or more of these substituents, if any, may be the same or different. If possible, these substituents may be connected to each other to form a ring.

The compound represented by the formula (16) will be further described with reference to specific examples thereof, but the invention is not limited thereto.

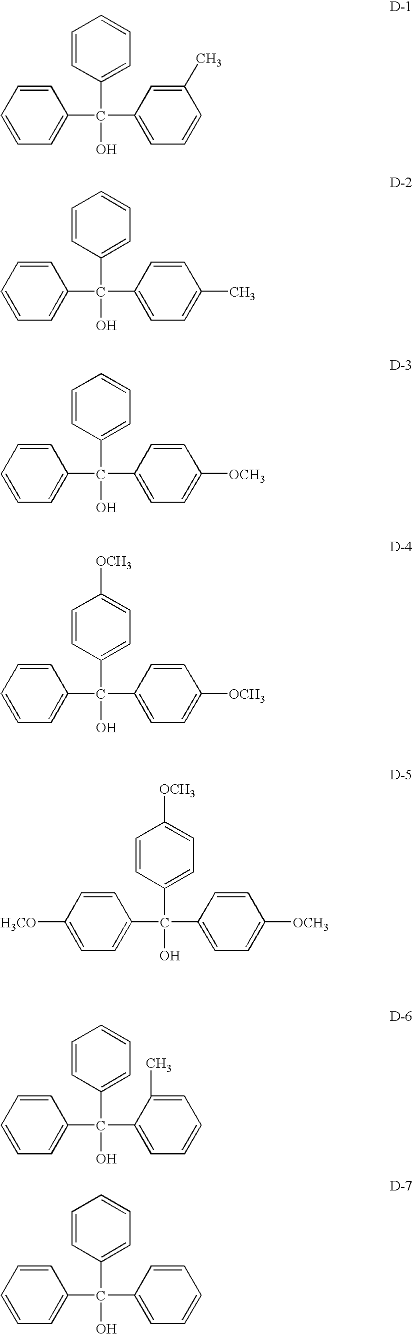

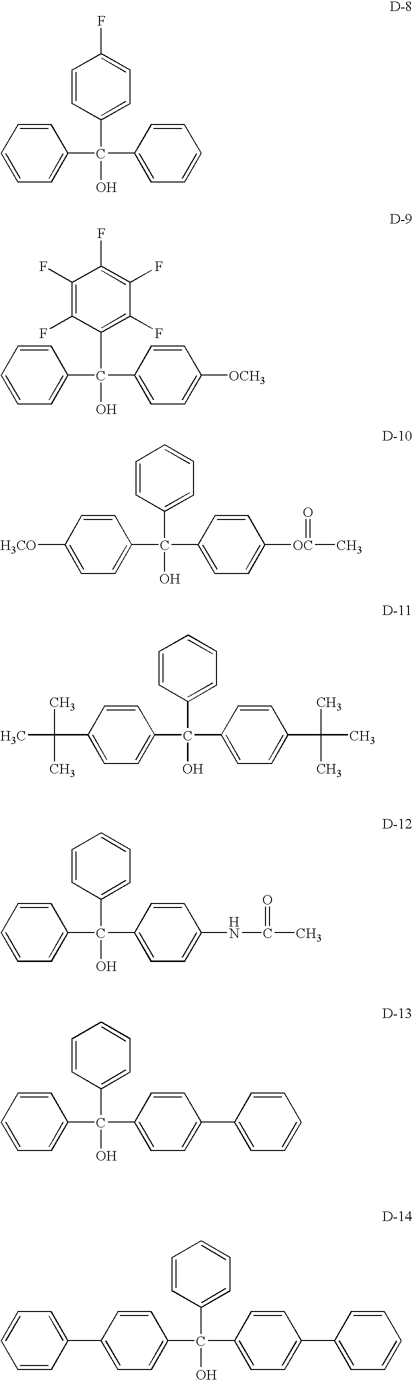

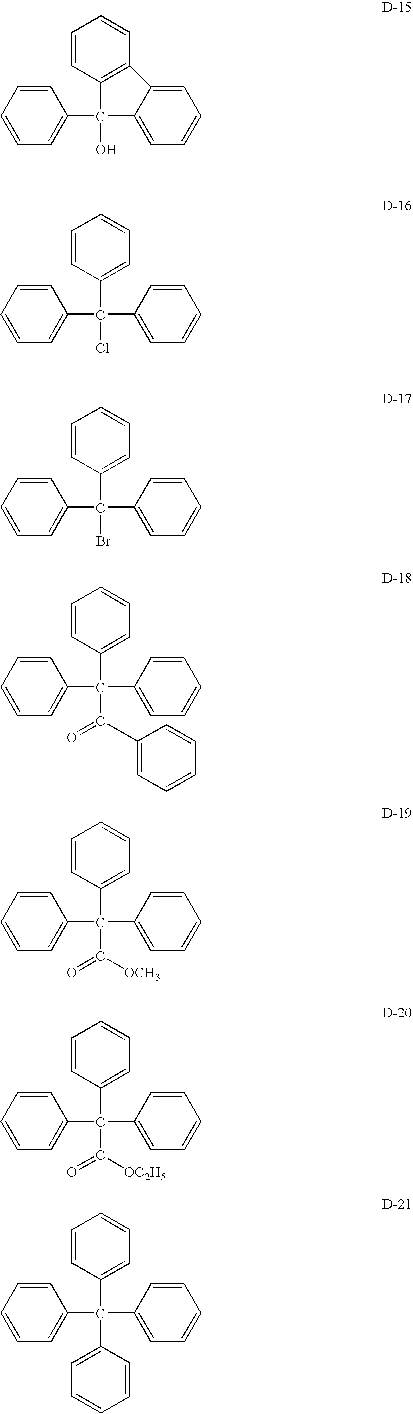

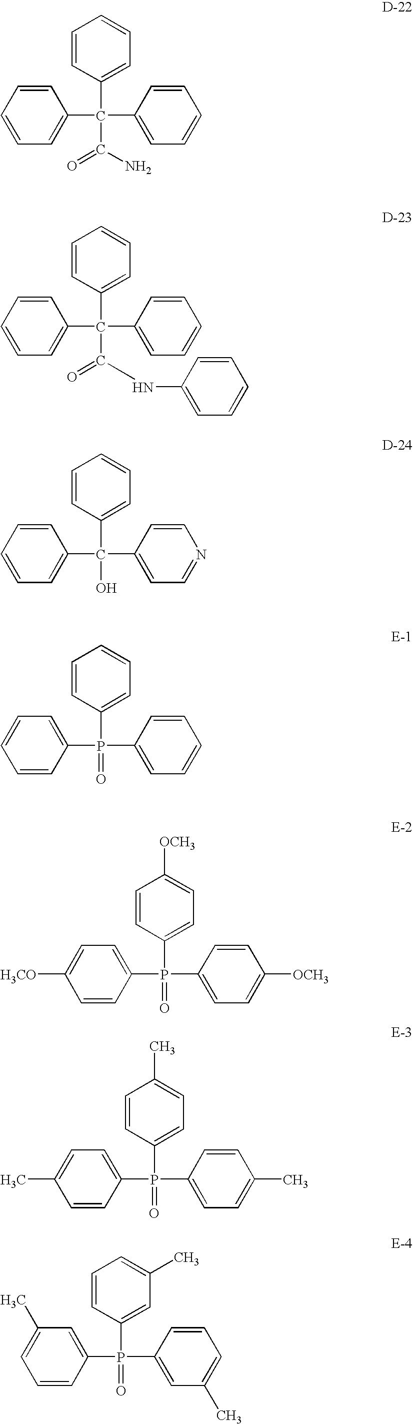

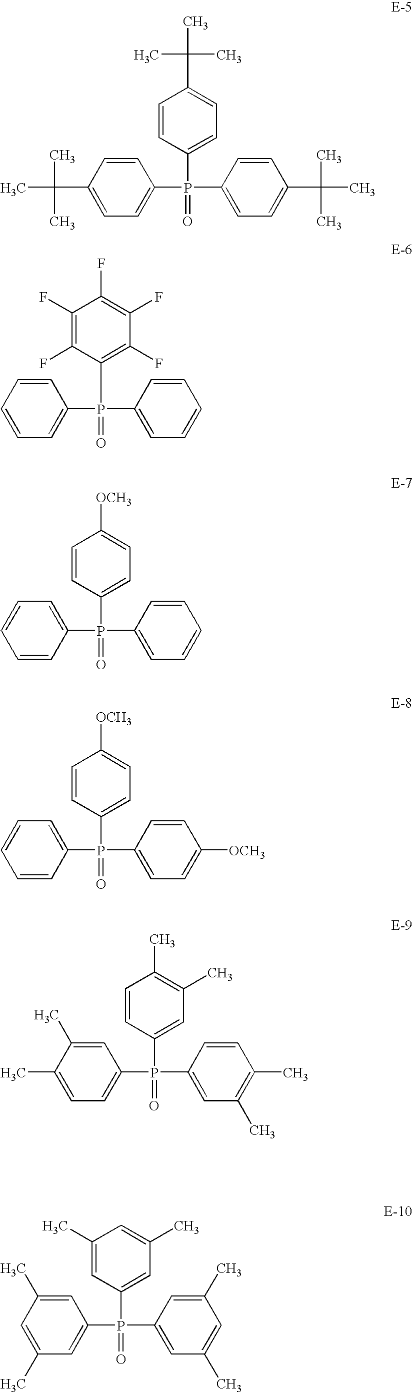

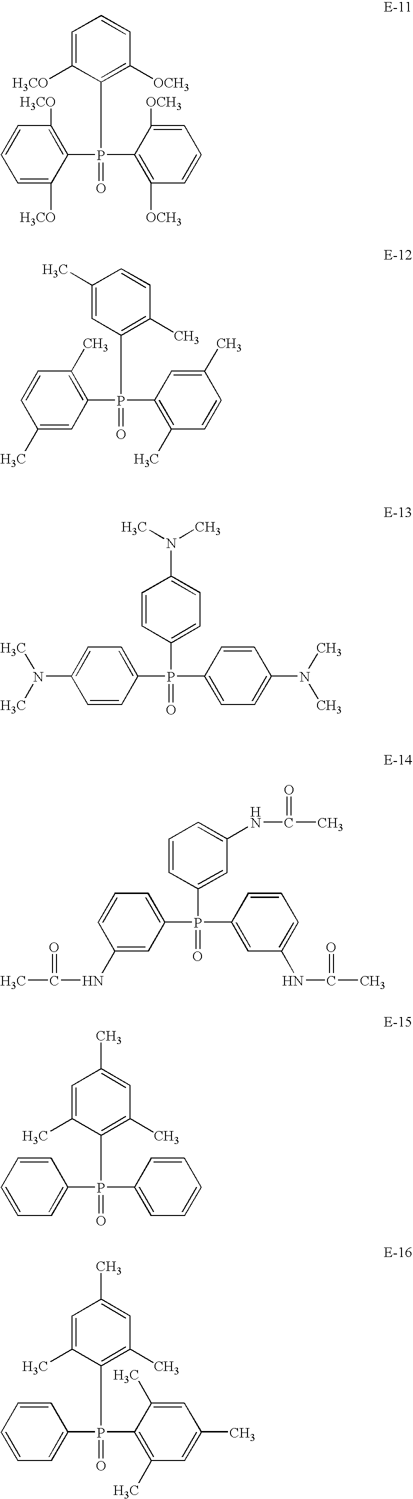

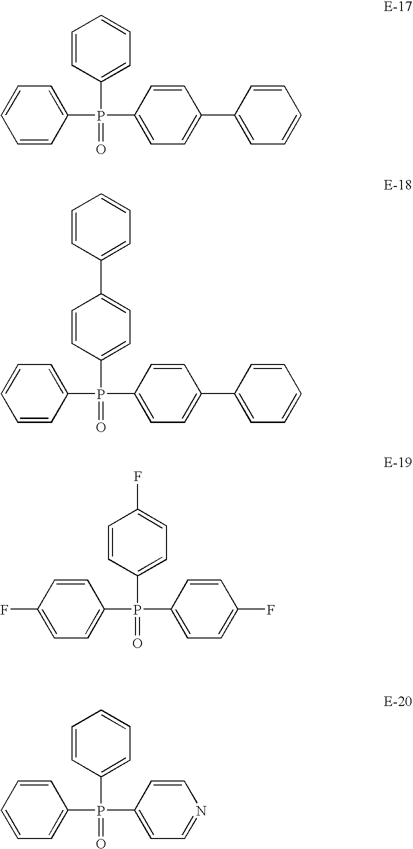

The compound represented by the formula (17) of the invention will be further described hereinafter.

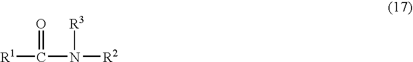

In the formula (17), R¹ represents an aryl group. R² and R³ each independently represent an alkyl or aryl group, with the proviso that at least one of R² and R³ is an aryl group. When R² is an aryl group, R³ is an alkyl or aryl group, preferably an alkyl group. The alkyl group may be straight-chain, branched or cyclic. The alkyl group preferably has from 1 to 20 carbon atoms, more preferably from 1 to 15 carbon atoms, most preferably from 1 to 12 carbon atoms. The aryl group preferably has from 6 to 36 carbon atoms, more preferably from 6 to 24 carbon atoms.

The compound represented by the formula (18) of the invention will be further described hereinafter.

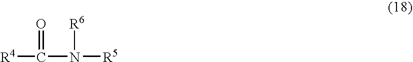

In the formula (18), R⁴, R⁵ and R⁶ each independently represent an alkyl group. The alkyl group may be straight-chain, branched or cyclic. R⁴ is preferably a cyclic alkyl group. More preferably, at least one of R⁵ and R⁶ is a cyclic alkyl group. The alkyl group preferably has from 1 to 20 carbon atoms, more preferably from 1 to 15 carbon atoms, most preferably from 1 to 12 carbon atoms. The cyclic alkyl group is particularly preferably a cyclohexyl group.

The alkyl and aryl groups in the formulae (17) and (18) each may have substituents. Preferred examples of these substituents include halogen atoms (e.g., chlorine, bromine, fluorine, iodine), alkyl groups, aryl groups, alkoxy groups, aryloxy groups, acyl groups, alkoxycarbonyl groups, aryloxycarbonyl groups, acyloxy groups, sulfonylamino groups, hydroxyl groups, cyano groups, amino groups, and acylamino groups. More desirable among these substituents are halogen atoms, alkyl groups, aryl groups, alkoxy groups, aryloxy groups, sulfonylamino groups, and acylamino groups. Particularly preferred among these substituents are alkyl groups, aryl groups, sulfonylamino groups, and acylamino groups.

The amount of the compounds represented by the formulae (17) and (18) of the invention each are preferably from 1 to 30 parts by mass, more preferably from 2 to 30 parts by mass, even more preferably from 2 to 25 parts by mass, most preferably from 2 to 20 parts by mass based on 100 parts by mass of cellulose.

Preferred examples of the compounds represented by the formulae (17) and (18) will be given below, but the invention is not limited thereto.

In the following examples, those with symbol (A-*) indicate specific examples of the compound represented by the formula (17) and those with symbol (B-*) indicate specific examples of the compound represented by the formula (18).

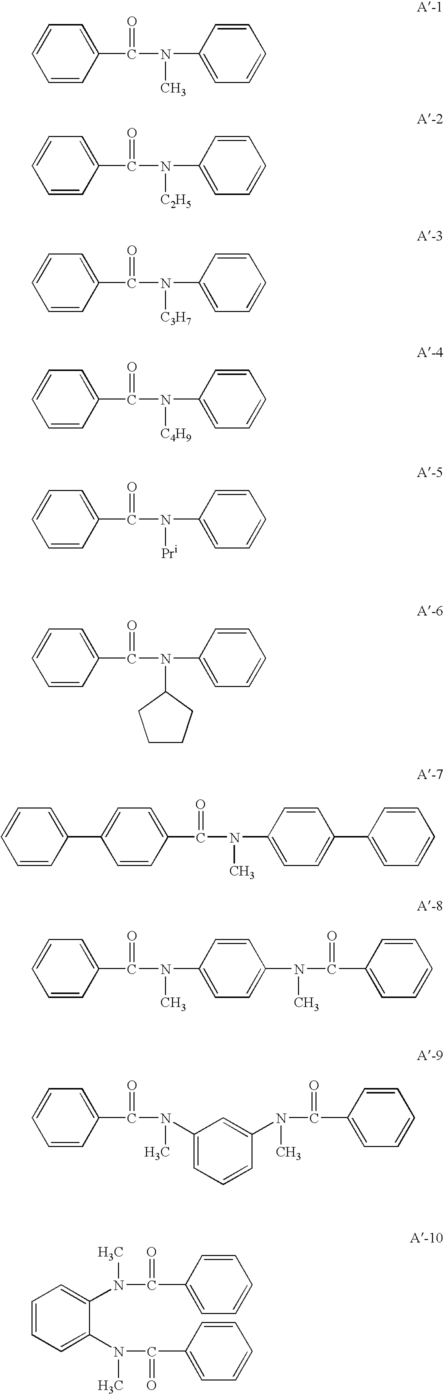

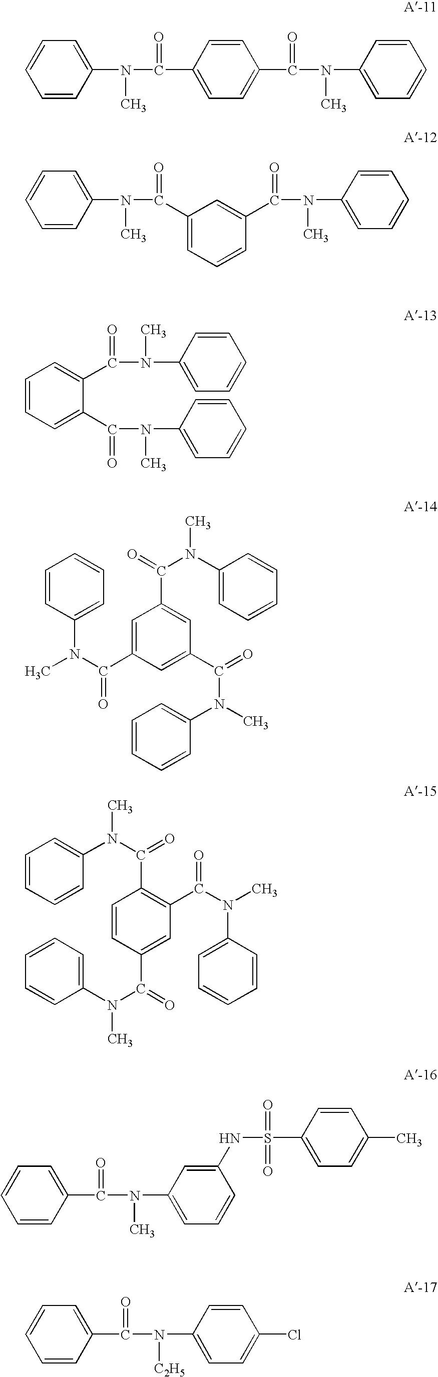

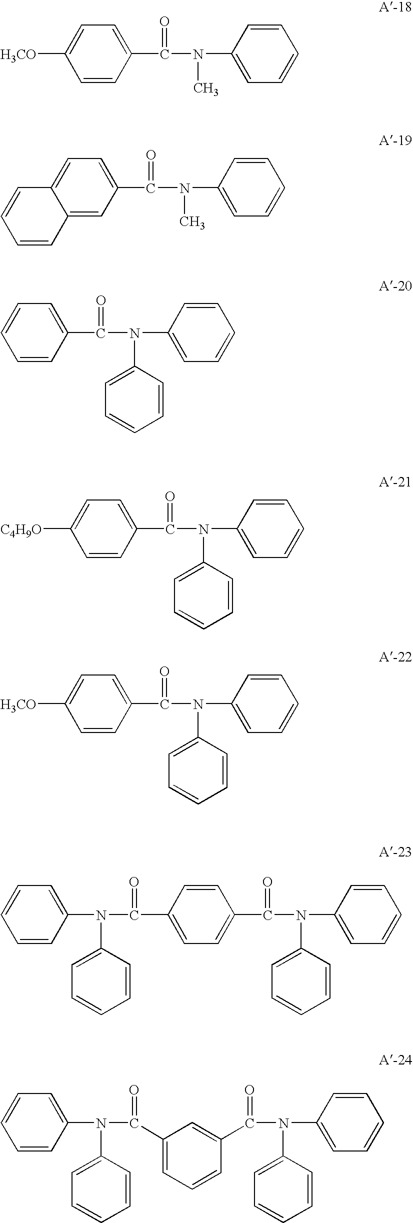

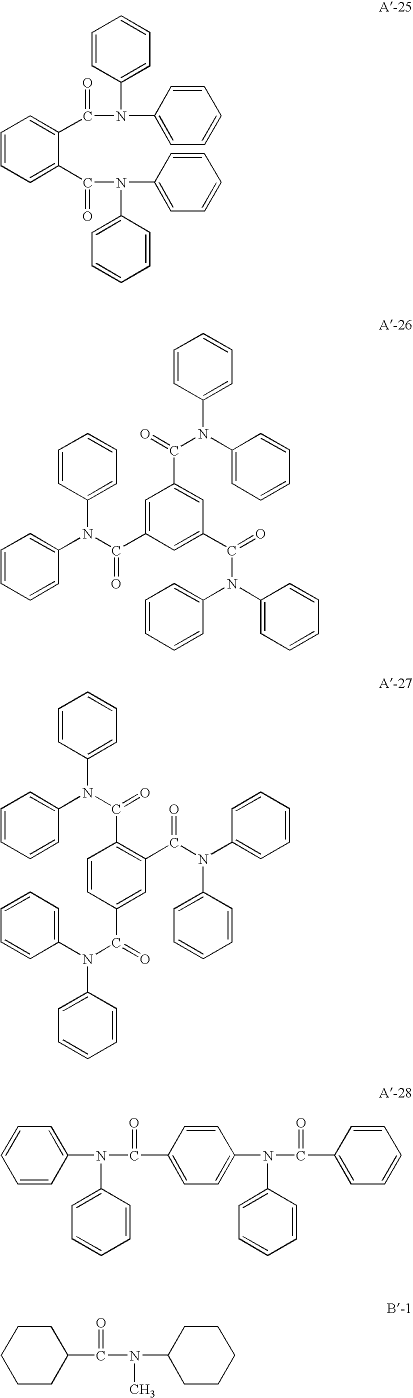

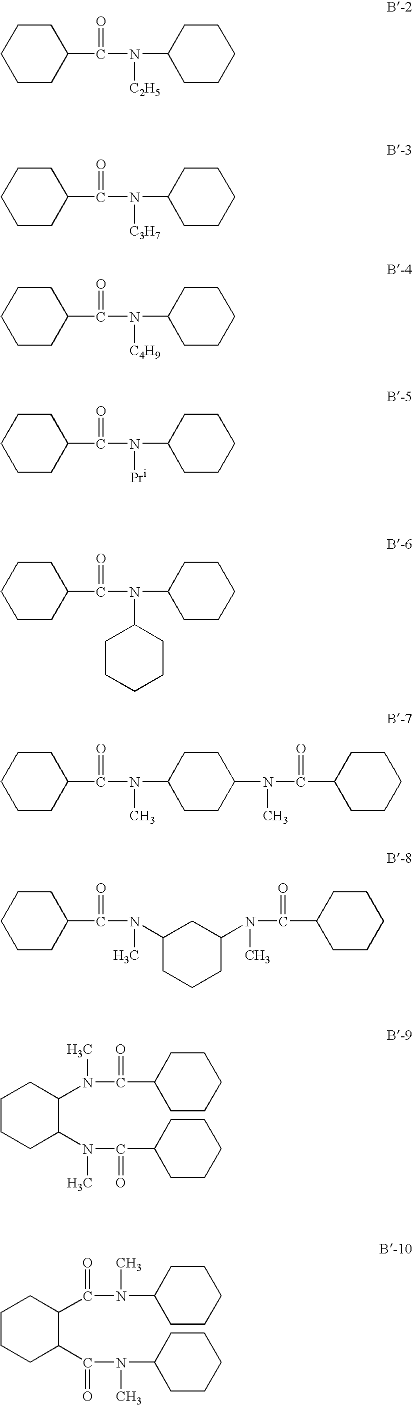

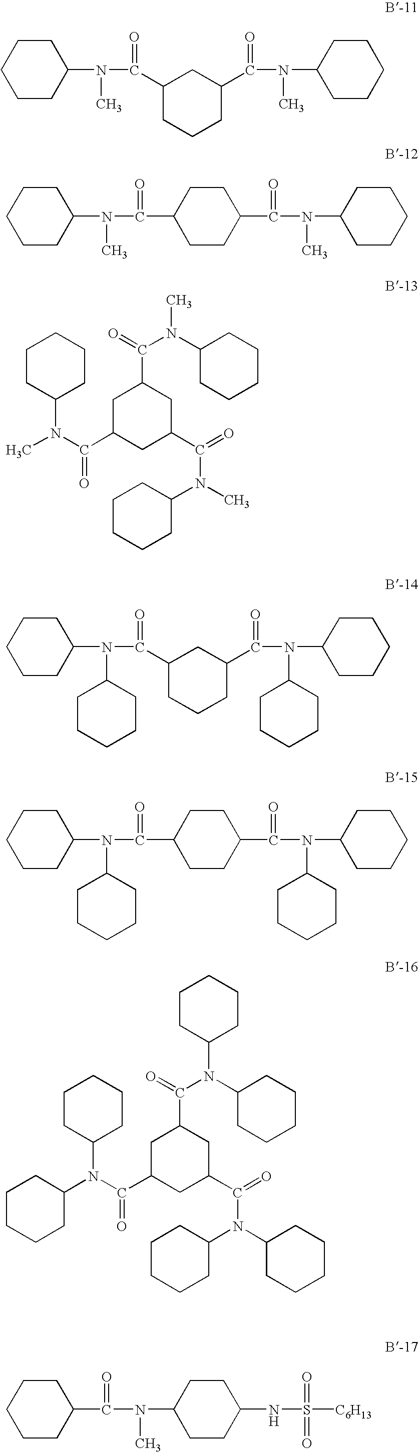

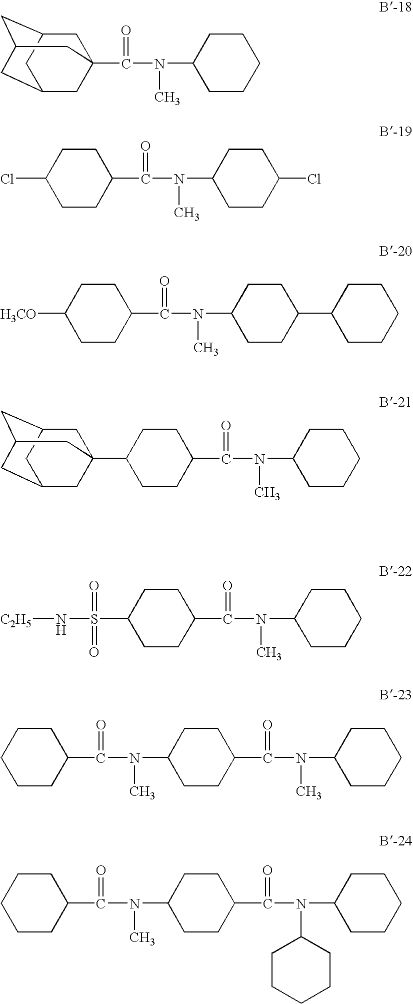

All the aforementioned compounds can be produced by any known method. In some detail, the compounds of the formulae (17) and (18) can be obtained by the dehydration condensation reaction of carboxylic acid with amine in the presence of a condensing agent (e.g., dicyclohexylcarbone diimide (DCC)) or the substitution reaction of carboxylic acid chloride derivative with amine derivative.

The compound represented by the following formula (19) will be described hereinafter. 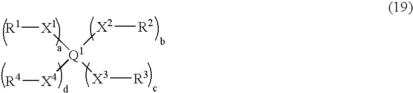
wherein R¹, R², R³ and R⁴ each represent a hydrogen atom or a substituted or unsubstituted aliphatic or aromatic group; X¹, X², X³ and X⁴ each represent a divalent connecting group formed by one or more groups selected from the group consisting of single bond, —CO— and —NR⁵— (in which R⁵ represents a substituted or unsubstituted aliphatic or aromatic group); the suffixes a, b, c and d each represent an integer of 0 or more, with the proviso that the sum of a, b, c and d is 2 or more; and Q¹ represents an organic group having a valency of (a+b+c+d).

The compound represented by the formula (19) is preferably a compound represented by the following formula (20). 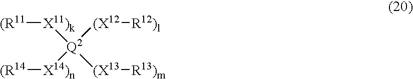
wherein R¹¹, R¹², R¹³ and R¹⁴ each represent a hydrogen atom or a substituted or unsubstituted aliphatic or aromatic group; X¹¹, X¹², X¹³ and X¹⁴ each represent a divalent connecting group formed by one or more groups selected from the group consisting of single bond, —CO— and —N—R— (in which R⁵ represents a substituted or unsubstituted aliphatic or aromatic group); the suffixes k, l, m and n each represent an integer of 0 or 1, with the proviso that the sum of k, l, m and n is 2, 3 or 4; and Q² represents an organic group having a valency of from 2 to 4.

The compound represented by the formula (19) is preferably a compound represented by the following formula (21).
R²¹—Y¹-L-Y²—R²² (21)
wherein R²¹ and R²² each represent a substituted or unsubstituted aliphatic or aromatic group; Y¹ and Y² each represent CONR²³— or —NR²⁴CO— (in which R²³ and R²⁴ each represent a substituted or unsubstituted aliphatic or aromatic group); and L¹ represents a divalent organic group formed by one or more groups selected from the group consisting of —O—, —S—, —SO—, —SO₂—, —CO— and —NR²⁵ (in which R²⁵ represents a hydrogen atom or a substituted or unsubstituted aliphatic or aromatic group), alkylene group and arylene group.

The compound represented by the formula (19) is preferably a compound represented by the following formula (22). 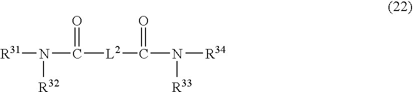
wherein R³¹, R³², R³³ and R³⁴ each represent a substituted or unsubstituted aliphatic or aromatic group; and L² represents a divalent organic group formed by one or more groups selected from the group consisting of —O—, —S—, —SO—, —SO₂—, —CO— and —NR³⁵ (in which R³⁵ represents a hydrogen atom or a substituted or unsubstituted aliphatic or aromatic group), alkylene group and arylene group.

The compound represented by the formula (19) is preferably a compound represented by the following formula (23). 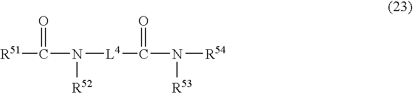
wherein R⁵¹, R⁵², R⁵³ and R⁵⁴ each represent a substituted or unsubstituted aliphatic or aromatic group; and L⁴ represents a divalent organic group formed by one or more groups selected from the group consisting of —O—, —S—, —SO—, —SO₂—, —CO— and —NR⁵⁵ (in which R⁵⁵ represents a hydrogen atom or a substituted or unsubstituted aliphatic or aromatic group), alkylene group and arylene group.

The compound represented by the formula (19) of the invention will be further described hereinafter.

In the formula (19), R¹, R², R³ and R⁴ each represent a hydrogen atom or a substituted or unsubstituted aliphatic or aromatic group, preferably aliphatic group. The aliphatic group may be straight-chain, branched or cyclic, preferably cyclic. Examples of the substituents which may be on the aliphatic and aromatic groups include the substituents T exemplified later. However, the aliphatic and aromatic groups are preferably unsubstituted. X¹, X², X³ and X⁴ each represent a divalent connecting group formed by one or more groups selected from the group consisting of single bond, —CO— and —NR⁵— (in which R⁵ represents a substituted or unsubstituted aliphatic or aromatic group, preferably unsubstituted aliphatic or aromatic group and/or aliphatic group). The combination of X¹, X², X³ and X⁴ is not specifically limited but is preferably selected from —CO— and —NR⁵—. The suffixes a, b, c and d each represent an integer of 0 or more, with the proviso that the sum of a, b, c and d is 2 or more. The sum of a, b, c and d is preferably from 2 to 8, more preferably from 2 to 6, even more preferably from 2 to 4. Q¹ represents an organic group (excluding cyclic group) having a valency of (a+b+c+d). The valency of Q¹ is preferably from 2 to 8, more preferably from 2 to 6, most preferably from 2 to 4.

The term “organic group” as used herein is meant to indicate a group composed of organic compound.

The compound represented by the formula (19) is preferably a compound represented by the formula (20).

In the formula (20), R¹¹, R¹², R¹³ and R¹⁴ each represent a hydrogen atom or a substituted or unsubstituted aliphatic or aromatic group, preferably aliphatic group. The aliphatic group may be straight-chain, branched or cyclic, preferably cyclic. Examples of the substituents which may be on the aliphatic and aromatic groups include the substituents T exemplified later. However, the aliphatic and aromatic groups are preferably unsubstituted. X¹¹, X¹², X¹³ and X¹⁴ each independently represent a divalent connecting group formed by one or more groups selected from the group consisting of single bond, —CO— and —NR¹⁵— (in which R¹⁵ represents a substituted or unsubstituted aliphatic or aromatic group, preferably unsubstituted aliphatic or aromatic group and/or aliphatic group). The combination of X¹¹, X¹², X¹³ and X¹⁴ is not specifically limited but is preferably selected from —CO— and —NR¹⁵—. The suffixes k, l, m and n each represent an integer of 0 or more, with the proviso that the sum of k, l, m and n is 2, 3 or 4. Q¹ represents an organic group (excluding cyclic group) having a valency of (a+b+c+d). Q¹ represents an organic group having a valency of from 2 to 4 (excluding cyclic organic groups). The valency of Q¹ is preferably from 2 to 4, more preferably from 2 or 3.

The compound of the formula (19) is preferably a compound represented by the formula (21).

In the formula (21), R²¹ and R²² each represent a substituted or unsubstituted aliphatic or aromatic group, preferably aliphatic group. The aliphatic group may be straight-chain, branched or cyclic, preferably cyclic. Examples of the substituents which may be on the aliphatic and aromatic groups include the substituents T exemplified later. However, the aliphatic and aromatic groups are preferably unsubstituted. Y¹ and Y² each independently represent a —CONR²³— or —NR²⁴CO— (in which R²³ and R²⁴ each represent a substituted or unsubstituted aliphatic or aromatic group, preferably unsubstituted aliphatic or aromatic group and/or aliphatic group). L¹ represents a divalent organic group (excluding cyclic group) formed by one or more groups selected from the group consisting of —O—, —S—, —SO—, —SO₂—, —CO—, —NR²⁵—, alkylene group and arylene group. The combination of L¹ is not specifically limited but is preferably selected from —O—, —S—, —NR²⁵— and alkylene group, more preferably from —O—, —S— and alkylene group, most preferably from —O—, —S— and alkylene group.

The compound of the formula (19) is preferably a compound represented by the formula (22).

In the formula (22), R³¹, R³², R³³ and R³⁴ each represent a substituted or unsubstituted aliphatic or aromatic group, preferably aliphatic group. The aliphatic group may be straight-chain, branched or cyclic, preferably cyclic. Examples of the substituents which may be on the aliphatic and aromatic groups include the substituents T exemplified later. However, the aliphatic and aromatic groups are preferably unsubstituted. L² represents a divalent organic group formed by one or more groups selected from the group consisting of —O—, —S—, —SO—, —SO₂—, —CO—, —NR³⁵— (in which R³⁵ represents a substituted or unsubstituted aliphatic or aromatic group, preferably unsubstituted aliphatic or aromatic group and/or aliphatic group), alkylene group and arylene group. The combination of L² is not specifically limited but is preferably selected from —O—, —S—, —NR³⁵— and alkylene group, more preferably from —O—, —S— and alkylene group, most preferably from —O—, —S— and alkylene group.

The compound of the formula (19) is preferably a compound represented by the formula (23).

In the formula (23), R⁴¹, R⁴², R⁴³ and R⁴⁴ each represent a substituted or unsubstituted aliphatic or aromatic group, preferably aliphatic group. The aliphatic group may be straight-chain, branched or cyclic, preferably cyclic. Examples of the substituents which may be on the aliphatic and aromatic groups include the substituents T exemplified later. However, the aliphatic and aromatic groups are preferably unsubstituted. L³ represents a divalent organic group formed by one or more groups selected from the group consisting of —O—, —S—, —SO—, —SO₂—, —CO—, —NR⁴⁵— (in which R⁴⁵ represents a substituted or unsubstituted aliphatic or aromatic group, preferably unsubstituted aliphatic or aromatic group and/or aliphatic group), alkylene group and arylene group. The combination of L³ is not specifically limited but is preferably selected from —O—, —S—, —NR⁴⁵— and alkylene group, more preferably from —O—, —S— and alkylene group, most preferably from —O—, —S— and alkylene group.

The compound of the formula (19) is preferably a compound represented by the formula (24).

In the formula (24), R⁵¹, R⁵², R⁵³ and R⁵⁴ each represent a substituted or unsubstituted aliphatic or aromatic group, preferably aliphatic group. The aliphatic group may be straight-chain, branched or cyclic, preferably cyclic. Examples of the substituents which may be on the aliphatic and aromatic groups include the substituents T exemplified later. However, the aliphatic and aromatic groups are preferably unsubstituted. L⁴ represents a divalent organic group formed by one or more groups selected from the group consisting of —O—, —S—, —SO—, —SO₂—, —CO—, —NR⁵⁵— (in which R⁵⁵ represents a substituted or unsubstituted aliphatic or aromatic group, preferably unsubstituted aliphatic or aromatic group and/or aliphatic group), alkylene group and arylene group. The combination of L⁴ is not specifically limited but is preferably selected from —O—, —S—, —NR⁵⁵— and alkylene group, more preferably from —O—, —S— and alkylene group, most preferably from —O—, —S— and alkylene group.

The substituted or unsubstituted aliphatic groups which have been described as substituents on the compounds of the formulae (19) and (20) to (24) will be further described hereinafter. The aliphatic group may be straight-chain, branched or cyclic. The aliphatic group preferably has from 1 to 25 carbon atoms, more preferably from 6 to 25 atoms, particularly preferably from 6 to 20 carbon atoms. Specific examples of the aliphatic group include methyl group, ethyl group, propyl group, n-propyl group, isopropyl group, cyclopropyl group, n-butyl group, isobutyl group, tert-butyl group, amyl group, isoamyl group, tert-amyl group, n-hexyl group, cyclohexyl group, n-heptyl group, n-octyl group, bicyclooctyl group, adamanthyl group, n-decyl group, tert-octyl group, dodecyl group, hexadecyl group, octadecyl group, and didecyl group.

The substituted or unsubstituted aromatic groups which have been described as substituents on the compounds of the formulae (19) and (20) to (24) will be further described hereinafter. The aromatic group may be an aromatic hydrocarbon group or aromatic heterocyclic group, preferably an aromatic hydrocarbon group. The aromatic hydrocarbon group preferably has from 6 to 24 carbon atoms, more preferably from 6 to 12 carbon atoms. Specific examples of the aromatic hydrocarbon ring include benzene, naphthalene, anthracene, biphenyl, and terphenyl. Particularly preferred among these aromatic hydrocarbon groups are benzene, naphthalene and biphenyl. The aromatic hydrocarbon group preferably contains at least one of oxygen atom, nitrogen atom and sulfur atom. Specific examples of the heterocyclic group include furane, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthaladine, naphthylidine, quinoxaline, quinazoline, cinnoline, pteridine, acrydine, phenanthroline, phenazine, tetrazole, benzimidazole, benzoxazole, benzthiazole, benzotriazole, and tetrazaindene. Preferred among these aromatic heterocyclic groups are pyridine ring, triazine ring, and quinoline ring.

The substituents T on the compounds of the aforementioned formulae will be further described hereinafter.

Examples of the substituent T include alkyl groups (preferably a C₁-C₂₀, more preferably a C₁-C₁₂, particularly preferably a C₁-C₈ alkyl group, e.g., methyl, ethyl, isopropyl, tert-butyl, n-octyl, n-decyl, n-hexadecyl, cyclopropyl, cyclopentyl, cyclohexyl), alkenyl groups (preferably a C₂-C₂₀, more preferably a C₂-C₁₂, particularly preferably a C₂-C₈ alkenyl group, e.g., vinyl, allyl, 2-butenyl, 3-pentenyl), alkynyl groups (preferably a C₂-C₂₀, more preferably a C₂-C₁₂, particularly preferably a C₂-C₈ alkynyl group, e.g., propargyl, 3-pentynyl), aryl groups (preferably a C₆-C₃₀, more preferably a C₆-C₂₀, particularly preferably a C₆-C₁₂ aryl group, e.g., phenyl, biphenyl, naphthyl), amino groups (preferably a C₀-C₂₀, more preferably a C₀-C₁₀, particularly preferably a C₀-C₆ amino group, e.g. amino, methylamino, dimethylamino, diethylamino, dibenzylamino), alkoxy groups (preferably a C₁-C₂₀, more preferably a C₁-C₁₂, particularly preferably a C₁-C₈ alkoxy group, e.g., methoxy, ethoxy, butoxy), aryloxy groups (preferably a C₆-C₂₀, more preferably a C₆-C₁₆, particularly preferably a C₆-C₁₂ aryloxy group, e.g., phenyloxy, 2-naphthyloxy), acyl groups (preferably a C₁-C₂₀, more preferably a C₁-C₁₆, particularly preferably a C₁-C₁₂ acyl group, e.g., acetyl, benzoyl, formyl, pivaloyl), alkoxycarbonyl groups (preferably a C₂-C₂₀, more preferably a C₂-C₁₆, particularly preferably a C₂-C₁₂ alkoxycarbonyl group, e.g., methoxycarbonyl, ethoxycarbonyl), aryloxycarbonyl groups (preferably a C₇-C₂₀, more preferably a C₇-C₁₆, particularly preferably a C₇-C₁₀ aryloxycarbonyl group, e.g., phenyloxycarbonyl), acyloxy groups (preferably a C₂-C₂₀, more preferably a C₂-C₁₆, particularly preferably a C₂-C₁₀ acyloxy group, e.g., acetoxy, benzoyl), acylamino groups (preferably a C₂-C₂₀, more preferably a C₂-C₁₆, particularly preferably a C₂-C₁₀ acylamino group, e.g., acetylamino, benzoylamino), alkoxycarbonylamino groups (preferably a C₂-C₂₀, more preferably a C₂-C₁₆, particularly preferably a C₂-C₁₂ alkoxycarbonylamino group, e.g., methoxycarbonylamino), aryloxycarbonylamino groups (preferably a C₇-C₂₀, more preferably a C₇-C₁₆, particularly preferably a C₇-C₁₂ aryloxycarbonylamino, e.g., phenyloxycarbonylamino), sulfonylamino groups (preferably a C₁-C₂₀, more preferably a C₁-C₁₆, particularly preferably a C₁-C₁₂ sulfonylamino group, e.g., methanesulfonylamino, benzenesulfonylamino), sulfamoyl groups (preferably a C₀-C₂₀, more preferably a C₀-C₁₆, particularly preferably a C₀-C₁₂ sulfamoyl group, e.g., sulfamoyl, methyl sulfamoyl, dimethyl sulfamoyl, phenyl sulfamoyl), carbamoyl groups (preferably a C₁-C₂₀, more preferably a C₁-C₁₆, particularly preferably a C₁-C₁₂ carbamoyl group, e.g., carbamoyl, methyl carbamoyl, diethyl carbamoyl, phenyl carbamoyl), alkylthio groups (preferably a C₁-C₂₀, more preferably a C₁-C₁₆, particularly preferably a C₁-C₁₂ alkylthio group, e.g., methylthio, ethylthio), arylthio groups (preferably a C₆-C₂₀, more preferably a C₆-C₁₆, particularly preferably a C₆-C₁₂ arylthio, e.g., phenylthio), sulfonyl groups (preferably a C₁-C₂₀, more preferably C₁-C₁₆, particularly preferably a C₁-C₁₂ sulfonyl group, e.g., mesyl, tosyl), sulfinyl groups (preferably a C₁-C₂₀, more preferably a C₁-C₁₆, particularly preferably a C₁-C₁₂ sulfinyl group, e.g., methanesulfinyl, benzenesulfinyl), ureido groups (preferably a C₁-C₂₀, more preferably a C₁-C₁₆, particularly preferably a C₁-C₁₂ ureido group, e.g., ureido, methylureido, phenylureido), phosphoric acid amide groups (preferably a C₁-C₂₀, more preferably a C₁-C₁₆, particularly preferably a C₁-C₁₂ phosphoric acid amide group, e.g., diethylphosphoric acid aide, phenylphosphoric acid amide), hydroxyl groups, mercapto groups, halogen atoms (e.g., fluorine, chlorine, bromine, iodine), cyano groups, sulfo groups, carboxyl groups, nitro groups, hydroxamic acid groups, sulfino groups, hydrazino groups, imino groups, heterocyclic groups (preferably a C₁-C₃₀, more preferably a C₁-C₁₂ heterocyclic group having nitrogen atom, oxygen atom or sulfur atom as hetero atom, e.g., imidazolyl, pyridyl, quinolyl, furyl, piperidyl, morpholino, benzooxazolyl, benzimidazolyl, benzothiazolyl), and silyl groups (preferably a C₃-C₄₀, more preferably a C₃-C₃₀, particularly preferably a C₃-C₂₄ silyl group, e.g., trimethylsilyl, triphenylsilyl).

These substituents may be further substituted. Two or more of these substituents, if any, may be the same or different. If possible, these substituents may be connected to each other to form a ring.

The added amount of the compound represented by the formula (19), particularly any one of the formulae (20) to (24), is preferably from 1% to 30% by mass, more preferably from 2% to 30% by mass, even more preferably from 25 to 25% by mass, most preferably from 2% to 20% by mass based on the amount of cellulose.

All the compounds to be used in the invention can be produced from known compounds. The compound represented by any one or more of the formulae (19) to (24) can be obtained by the condensation reaction of, e.g., carbonyl chloride with amine.

As a result of their extensive studies, the inventors found that the optical anisotropy can be lowered also by adding a polyvalent alcohols ester compound, carboxylic acid compound, polycyclic carboxylic acid compound or bisphenol derivative having an octanol-water distribution coefficient (Log P) of from 0 to 7 to cellulose acylate.

Specific examples of the polyvalent alcohol ester compound, carboxylic acid ester compound, polycyclic carboxylic acid compound and bisphenol derivative having an octanol-water distribution coefficient (Log P) of from 0 to 7 to cellulose acylate will be given below.

(Polyvalent Alcohol Ester Compound)

The polyvalent alcohol ester of the invention is an ester of a polyvalent alcohol having a valency of 2 or more with one or more monocarboxylic acids. Examples of the polyvalent alcohol ester compound will be given below, the invention is not limited thereto.

(Polyvalent Alcohol)

Preferred examples of the polyvalent alcohol include adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylol ethane, and xylytol. Particularly preferred among these polyvalent alcohols are triethylene glycol, tetraethylene glycol, dipropylene glycol, tripropylene glycol, sorbitol, trimethylolpropane, and xylytol.

(Monocarboxylic Acid)

The monocarboxylic acid in the polyvalent alcohol ester of the invention is not specifically limited. Examples of the monocarboxylic acid employable herein include known aliphatic monocarboxylic acids, alicyclic monocarboxylic acids, and aromatic monocarboxylic acids. The use of the alicyclic monocarboxylic acid or aromatic monocarboxylic acid makes it possible to enhance the moisture permeability, water content and retention of the cellulose acylate film to advantage.

Preferred examples of the monocarboxylic acid will be given below, but the invention is not limited thereto.

As the aliphatic monocarboxylic acid there is preferably used a C₁-C₃₂ aliphatic acid which is straight-chain or has side chains. The aliphatic monocarboxylic acid more preferably has from 1 to 20 carbon atoms, particularly preferably from 1 to 10 carbon atoms. The incorporation of acetic acid makes it possible to enhance the compatibility with cellulose ester to advantage. It is also preferred that acetic acid and other monocarboxylic acids be used in admixture.

Preferred examples of the aliphatic monocarboxylic acid include saturated aliphatic acids such as acetic acid, propionic acid, butyric acid, valeric acid, caproic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanic acid, montanic acid, melissic acid and lacceric acid, and unsaturated aliphatic acids such as undecylenic acid, oleic acid, sorbic acid, linoleic acid, linolenic acid and arachidonic acid. These aliphatic monocarboxylic acids may further have substituents.

Preferred examples of the alicyclic monocarboxylic acid include cyclopentacarboxylic acid, cyclohexane carboxylic acid, cyclooctanecarboxylic acid, and derivatives thereof.

Preferred examples of the aromatic monocarboxylic acid include benzoic acids such as benzoic acid and toluic acid having alkyl group incorporated in its benzene ring, aromatic monocarboxylic acids having two or more benzene rings such as biphenylcarboxylic acid, naphthalenecarboxylic acid and tetralincarboxylic acid, and derivatives thereof. Particularly preferred among these aromatic monocarboxylic acids is benzoic acid.

As the carboxylic acid constituting the aforementioned polyvalent alcohol ester to be used in the invention there may be used a single carboxylic acid or a mixture of two or more acid groups. The groups in the polyvalent alcohol may be entirely esterified or may be partly left as they are. Preferably, the carboxylic acid has two or more aromatic rings or cycloalkyl rings per molecule.

Examples of the polyvalent alcohol ester compound will be given below, but the invention is not limited thereto. 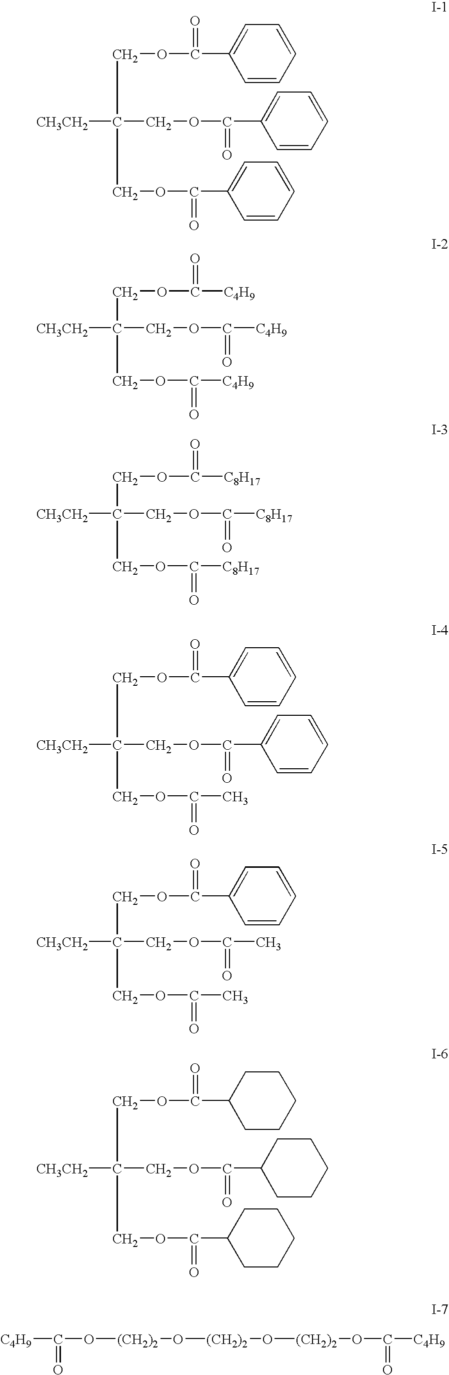 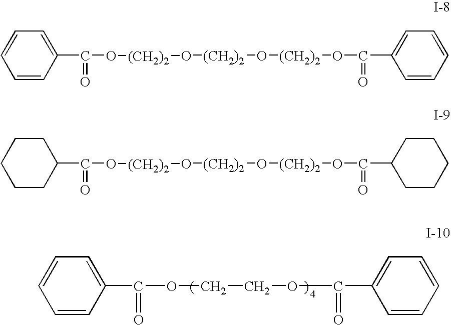
(Carboxylic Acid Ester Compound)

Examples of the carboxylic acid ester compound will be given below, but the invention is not limited thereto. Specific examples of the carboxylic acid ester compound include phthalic acid ester and citric acid ester. Examples of the phthalic acid ester include dimethyl phthalate, diethyl phthalate, dicyclohexyl phthalate, dioctyl phthalate, and diethylhexyl phthalate. Examples of the citric acid ester include acetyl triethyl citrate, and acetyl tributyl citrate. Other examples of the carboxylic acid ester include butyl oleate, methyl acetyl ricinoleate, dibutyl sebacate, triacetin, and trimethylolpropane tribenzoate.

Alkyl phthalyl alkyl glycolate is preferably used for this purpose to advantage. The alkyl in alkyl phthalyl alkyl glycolate has from 1 to 8 carbon atoms. Examples of the alkyl phthalyl alkyl glycolate include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, propyl phthalyl ethyl glycolate, methyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, and octyl phthalyl ethyl glycolate. Preferred among these alkyl phthalyl alkyl glycolates are methyl phthalyl methyl glycolate, ethyl phthalyl ethyl glycolate, propyl phthalyl propyl glycolate, butyl phthalyl butyl glycolate, and octyl phthalyl octyl glycolate. Particularly preferred among these alkyl phthalyl alkyl glycolates is ethyl phthalyl ethyl glycolate. These alkyl phthalyl alkyl glycolates may be used in admixture of two or more thereof.

Further examples of the carboxylic acid ester compound will be given below, but the invention is not limited to the aforementioned compounds or the following compounds. 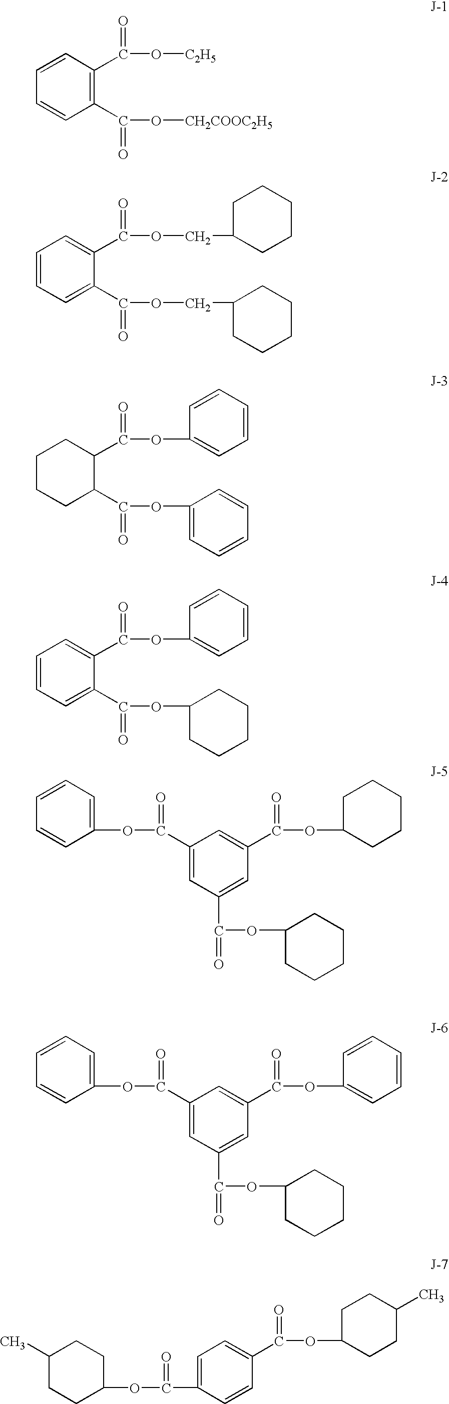 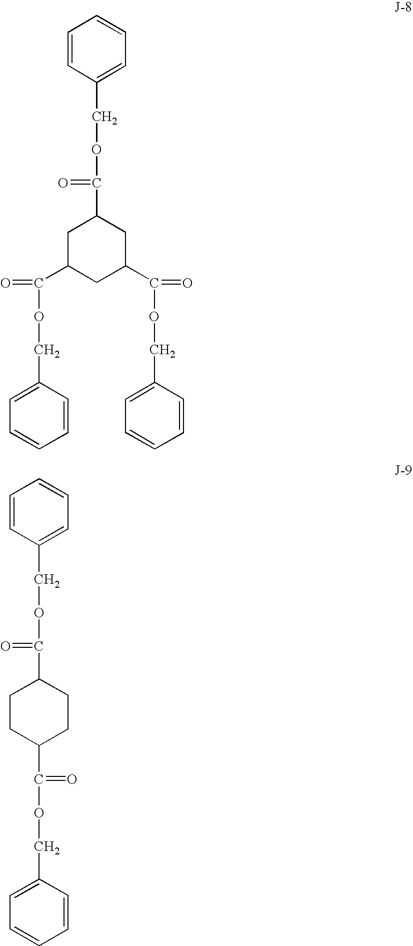
(Polycyclic Carboxylic Acid Compound)

The polycyclic carboxylic acid compound to be used in the invention is preferably a compound having a molecular weight of 3,000 or less, particularly preferably from 250 to not greater than 2,000. Referring to the cyclic structure of the polycyclic carboxylic acid compound, the size of the ring is not specifically limited. However, the polycyclic carboxylic acid compound is preferably composed of from 3 to 8 atoms, particularly preferably a 6-membered ring and/or 5-membered ring. The polycyclic carboxylic acid compound may contain carbon, oxygen, nitrogen, silicon or other atoms. Some of the bonds in the ring may be unsaturated bonds. For example, the 6-membered ring may be a benzene ring or cyclohexane ring. The compound of the invention contains a plurality of such cyclic structures. The compound of the invention may contain both benzene ring and cyclohexane ring or two cyclohexane rings in its molecule. The compound of the invention may be a naphthalene derivative or anthracene derivative. More preferably, the compound of the invention contains three or more such cyclic structures in its molecule. Alternatively, at least one bond in the cyclic structure is preferably free of unsaturated bond. Specific representative examples of the compound of the invention include derivatives of abietic acids such as abietic acid, dehydroabietic acid and parastric acid. 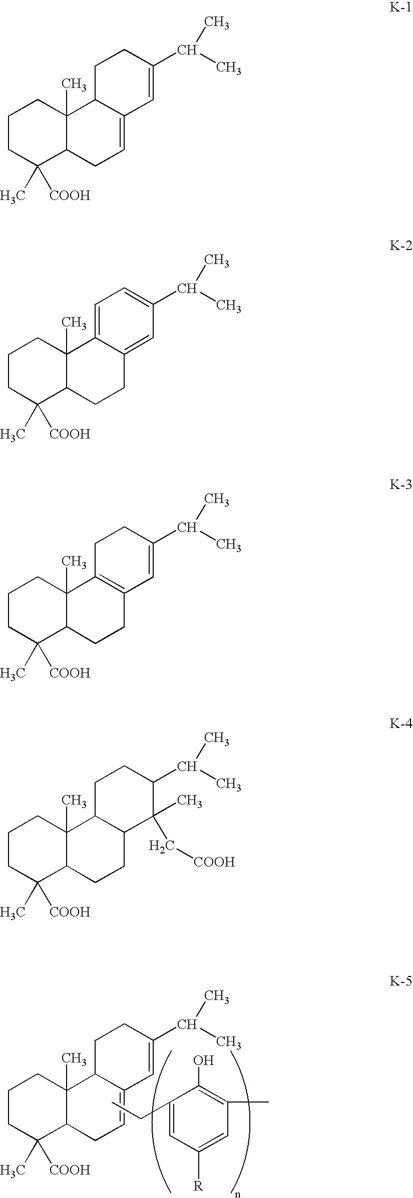
(Bisphenol Derivative)

The bisphenol derivative to be used in the invention preferably has a molecular weight of 10,000 or less. The bisphenol derivative may be a monomer, oligomer or polymer so far as its molecular weight falls within this range. Alternatively, the bisphenol derivative may be used in the form of a copolymer with other polymers. The bisphenol derivative may be modified by a reactive substituent at the end thereof. The chemical formula of these compounds will be given below, but the invention is not limited thereto.

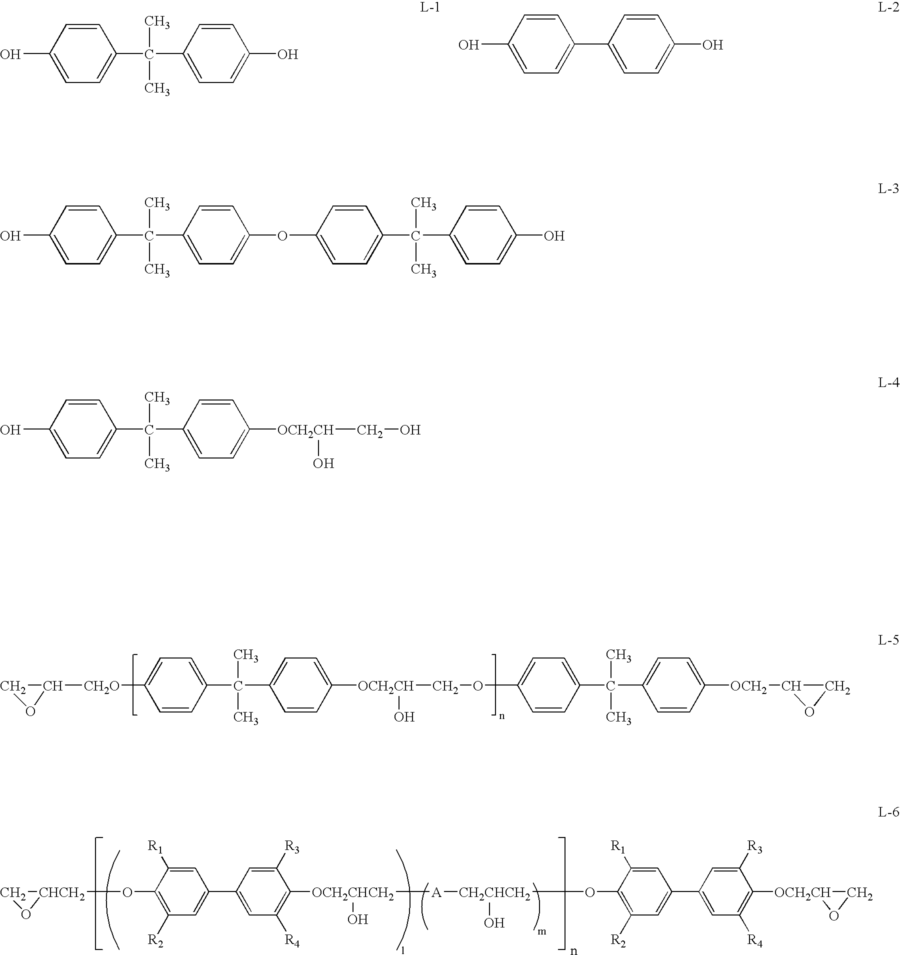

In the aforementioned specific examples of the bisphenol derivative, R¹ to R⁴ each represent a C₁-C₁₀ alkyl group. A represents 2,2-bisphenyleneoxy propylene group. The phenyleneoxy group may be substituted by R1 to R4 in the 2,6-position thereof. The suffixes l, m and n each represent the number of repetition of the unit which is preferably an integer of from 1 to 100, more preferably from 1 to 20.

(Wavelength Dispersion Adjustor)

The compound for lowering the wavelength dispersion of the cellulose acylate film will be further described hereinafter. As a result of extensive studies, the inventors found that the incorporation of at least one compound having absorption in an ultraviolet range of from 200 nm to 400 nm for lowering |Re(400)−Re(700)| and |Rth(400)−Rth(700)| of film in an amount of from 0.01% to 30% by weight based on the solid content of cellulose acylate makes it possible to adjust the wavelength dispersion of Re and Rth.

A cellulose acylate film normally has a Re and Rth wavelength dispersion in which Re and Rth values are greater at long wavelength than at short wavelength. Accordingly, it is required that the wavelength dispersion be smoothened by raising Re and Rth values at short wavelength relatively to long wavelength. On the other hand, a compound having absorption in an ultraviolet range of from 200 nm to 400 nm has a wavelength dispersion in which absorbance is greater at long wavelength than at short wavelength. It is presumed that when this compound itself is isotropically present in the cellulose acylate film, the birefringence and hence Re and Rth wavelength dispersion of the compound itself is greater at short wavelength than at long wavelength as in the wavelength dispersion of absorbance.

Accordingly, the use of a compound having absorption in an ultraviolet range of from 200 nm to 400 nm which is estimated to have Re and Rth wavelength dispersion at short wavelength than at long wavelength makes it possible to adjust the Re and Rth wavelength dispersion of the cellulose acylate film. To this end, the compound for adjusting wavelength dispersion is required to have a sufficient compatibility with cellulose acylate. Such a compound preferably has an ultraviolet absorption band of from 200 nm to 400 nm, more preferably from 220 nm to 395 nm, even more preferably from 240 nm to 390 nm.

In recent years, in order to enhance the brightness of liquid crystal displays such as note personal computer and mobile cellular phone with less electric power, it has been required that the transmittance of the optical members to be used in the liquid crystal displays be higher. In this respect, in the case where the compound having absorption in an ultraviolet range of from 200 nm to 400 nm for lowering |Re(400)−Re(700)| and |Rth(400)−Rth(700)| of film is incorporated in the cellulose acylate film, it is required that the spectral transmittance of the film be excellent. The cellulose acylate film of the invention preferably has a spectral transmittance of from not smaller than 45% to not greater than 95% at a wavelength of 380 nm and a spectral transmittance of from not greater than 10% at a wavelength of 350 nm.

The aforementioned wavelength dispersion adjustor which is preferably used in the invention preferably has a molecular weight of from 250 to 1,000, more preferably from 260 to 800, even more preferably from 270 to 800, particularly preferably from 300 to 800 from the standpoint of volatility. The wavelength dispersion adjustor of the invention may have a specific monomer structure or an oligomer or polymer structure formed by connecting a plurality of these monomer units so far as its molecular weight falls within the above defined range.

The wavelength dispersion adjustor preferably doesn't evaporate at the dope casting step and drying step during the preparation of the cellulose acylate film.

(Added Amount of Compound)

The added amount of the aforementioned wavelength dispersion adjustor which is preferably used in the invention is preferably from 0.01% to 30% by weight, more preferably from 0.1% to 20% by weight, particularly preferably from 0.2% to 10% by weight based on the amount of the cellulose acylate.

(Method for Adding Compound)

These wavelength dispersion adjustors may be used singly or in admixture of two or more thereof in an arbitrary proportion.

These wavelength dispersion adjustors may be added at any time during the preparation of the dope or may be added at the end of the preparation of the dope.

Specific examples of the wavelength dispersion adjustor which is preferably used in the invention include benzotriazole-based compounds, benzophenone-based compounds, compounds containing cyano group, oxybenzophenone-based compounds, salicylic acid ester-based compounds, and nickel complex salt-based compounds. However, the invention is not limited to these compounds.

As the benzotriazole-based compound to be used as wavelength dispersion adjustor of the invention there is preferably used one represented by the formula (101).
Q¹¹-Q¹²-OH (101)
wherein Q¹¹ represents a nitrogen-containing aromatic heterocyclic group; and Q¹² represents an aromatic ring.

Q¹¹ represents a nitrogen-containing aromatic heterocyclic group, preferably a 5- to 7-membered nitrogen-containing aromatic heterocyclic ring, more preferably a 5- or 6-membered nitrogen-containing aromatic heterocyclic ring. Examples of these nitrogen-containing aromatic heterocyclic rings include imidazole, pyrazole, triazole, tetrazole, thiazole, oxazole, selenazole, penzotriazole, benzothiazole, benzoxazole, benzoselenazole, thiadiazole, oxadiazole, naphthothiazole, naphthooxazole, azabenzimidazole, purine, pyridine, pyrazine, pyridazine, triazine, triazaindene, and tetrazaindene. More desirable among these nitrogen-containing aromatic heterocyclic rings are imidazole, pyrazole, triazole, tetrazole, thiazole, oxazole, benzotriazole, benzothiazole, benzoxazole, thiadiazole, and oxadiazole. Particularly preferred among these nitrogen-containing aromatic heterocyclic rings is benzotriazole.

The nitrogen-containing aromatic heterocyclic group represented by Q¹¹ may further contain substituents. As these substituents there may be used the substituents T exemplified later. A plurality of these substituents, if any, may be condensed to further form rings.

The aromatic ring represented by Q¹² may be an aromatic hydrocarbon ring or aromatic heterocyclic ring. These rings may each be monocyclic or may form condensed rings with other rings.

The aromatic hydrocarbon ring is preferably a C₆-C₃₀ monocyclic or bicyclic aromatic hydrocarbon ring (e.g., benzene ring, naphthalene ring), more preferably a C₆-C₂₀ aromatic hydrocarbon ring, even more preferably a C₆-C₁₂ aromatic hydrocarbon ring, still more preferably benzene ring.

The aromatic heterocyclic ring is preferably an aromatic heterocyclic ring containing nitrogen atom or sulfur atom. Specific examples of the heterocyclic ring include thiophene, imidazole, pyrazole, pyridine, pyrazine, pyridazine, triazine, indole, indazole, purine, thiazoline, thiazole, thiadiazole, oxazoline, oxazole, oxadiazole, quinoline, isoquinoline, phthaladine, naphthylidene, quinoxaline, quinazoline, cinnoline, pteridine, acridine, phenanthroline, phenazine, tetrazole, benzimidazole, benzoxazole, benzthiazole, benzotriazole, and tetrazaindene. More desirable among these aromatic heterocyclic rings are pyridine, triazine, and quinoline.

The aromatic ring represented by Q¹² is preferably an aromatic hydrocarbon ring, more preferably a naphthalene ring or benzene ring, particularly preferably a benzene ring. Q¹² may further have substituents which are preferably the substituents T exemplified later.

The substituents T have the same meaning as those described with reference to the formula (16), including their preferred examples. Two or more of these substituents T, if any, may be the same or different. If possible, these substituents T may be connected to each other to form rings.

The compound of the formula (101) is preferably a compound represented by the following formula (101-A). 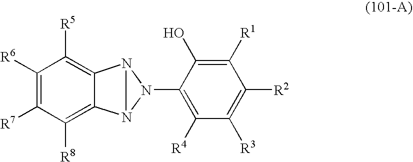
wherein R¹, R², R³, R, R⁵, R⁶, R⁷ and R⁸ each independently represent a hydrogen atom or substituent.

R¹, R², R³, R⁴, R⁵, R⁶, R⁷ and R⁸ each independently represent a hydrogen atom or substituent. As such substituents there may be used the aforementioned substituents T. These substituents may be further substituted by other substituents or may be condensed with each other to form a cyclic structure.

R¹ and R³ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or a C₁-C₁₂ alkyl group, particularly preferably a C₁-C₁₂ alkyl group (preferably a C₄-C₁₂ alkyl group).

R² and R⁴ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or a C₁-C₁₂ alkyl group, particularly preferably a hydrogen atom or methyl group, most preferably a hydrogen atom.

R⁵ and R⁸ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or a C₁-C₁₂ alkyl group, particularly preferably a hydrogen atom or methyl group, most preferably a hydrogen atom.

R⁶ and R⁷ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or halogen atom, particularly preferably a hydrogen atom or chlorine atom.

The compound of the formula (101) is preferably a compound represented by the following formula (101-B). 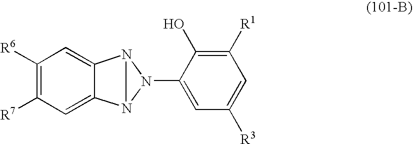
wherein R¹, R³, R⁶ and R⁷ are as defined in the formula (101-A), including their preferred range.

Specific examples of the compound represented by the formula (101) will be given below, but the invention is not limited thereto.

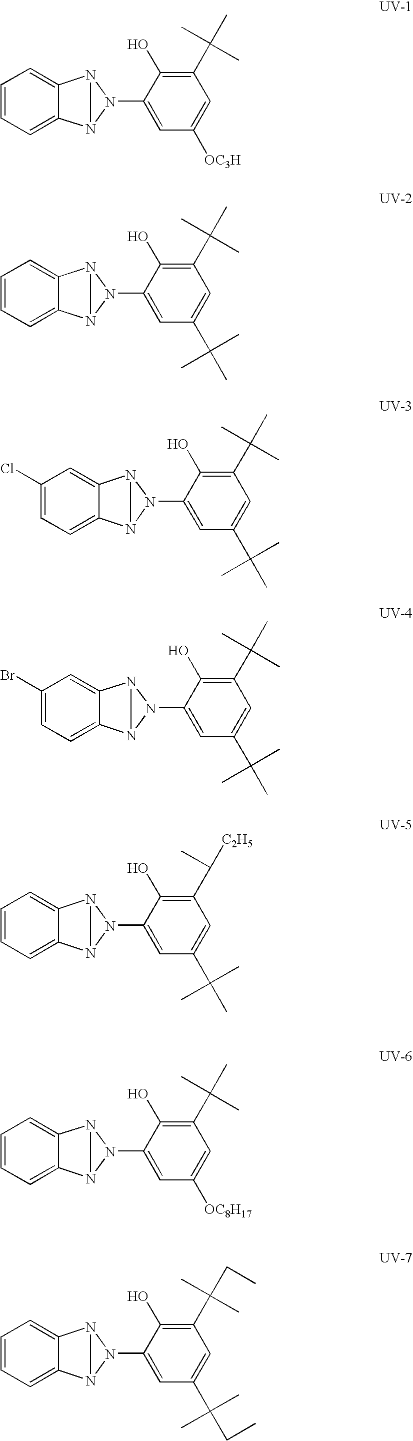

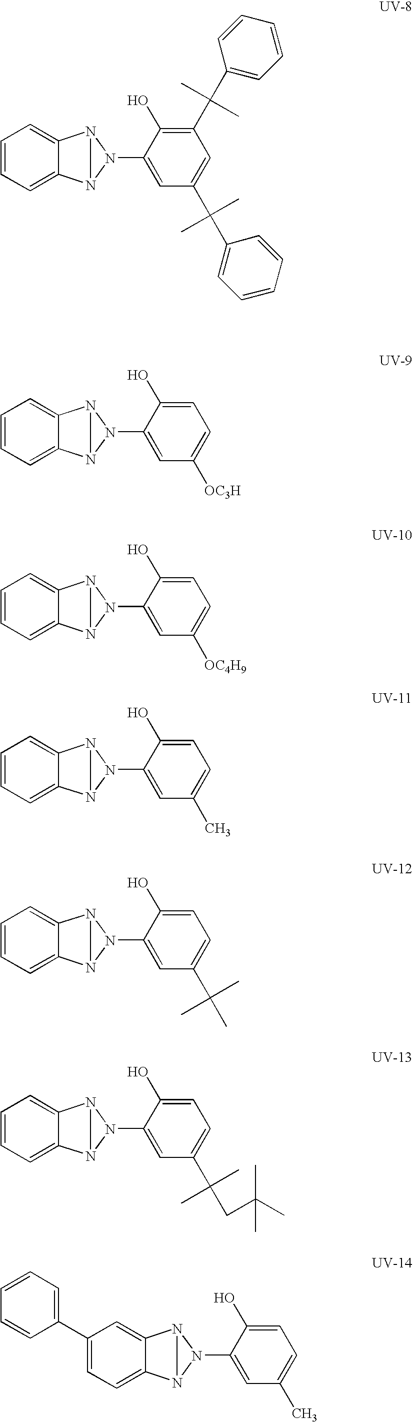

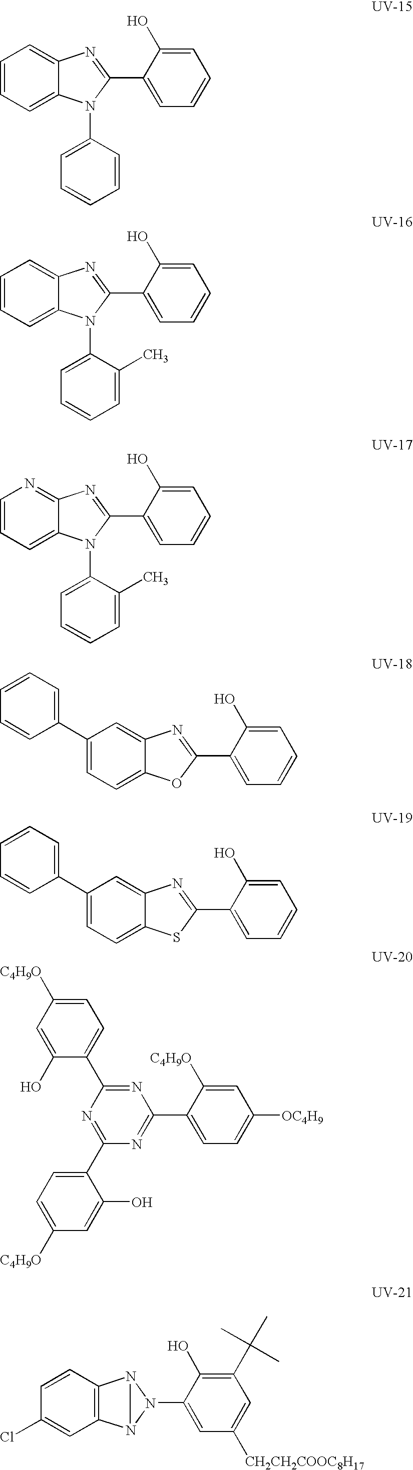

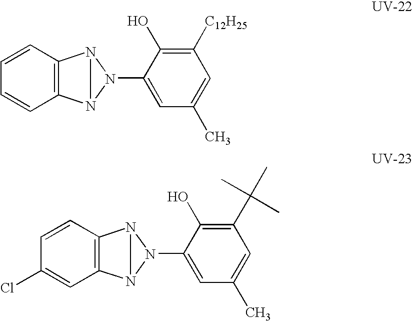

It was confirmed that a cellulose acylate film of the invention prepared free of those having a molecular weight of 320 or less among the above exemplified benzotriazole-based compounds is advantageous in retention.

As the benzophenone-based compound which is one of the wavelength dispersion adjustors to be used in the invention there is preferably used one represented by the formula (102). 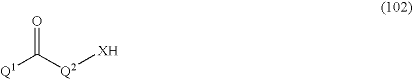
wherein Q¹ and Q² each independently represent an aromatic ring; and X represents NR (in which R represents a hydrogen atom or substituent), oxygen atom or sulfur atom.

The aromatic rings represented by Q¹ and Q² each may be an aromatic hydrocarbon ring or aromatic heterocyclic ring. These rings may be each monocyclic or may form condensed rings with other rings.

The aromatic hydrocarbon rings represented by Q¹ and Q² each are preferably a C₆-C₃₀ monocyclic or bicyclic aromatic hydrocarbon ring (e.g., benzene ring, naphthalene ring), more preferably a C₆-C₂₀ aromatic hydrocarbon ring, even more preferably a C₆-C₁₂ aromatic hydrocarbon ring, still more preferably a benzene ring.

The aromatic heterocyclic groups represented by Q¹ and Q² each are preferably an aromatic heterocyclic group containing at least one of oxygen atom, nitrogen atom and sulfur atom. Specific examples of the heterocyclic group include furane, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthaladine, naphthylidine, quinoxaline, quinazoline, cinnoline, pteridine, acrydine, phenanthroline, phenazine, tetrazole, benzimidazole, benzoxazole, benzthiazole, benzotriazole, and tetrazaindene. Preferred among these aromatic heterocyclic groups are pyridine, triazine, and quinoline.

The aromatic groups represented by Q¹ and Q² each are preferably an aromatic hydrocarbon ring, more preferably a C₆-C₁₀ aromatic hydrocarbon ring, even more preferably a substituted or unsubstituted benzene ring.

Q¹ and Q² may further have substituents which are preferably the substituents T exemplified later, with the proviso that these substituents are free of carboxylic acid, sulfonic acid and quaternary ammonium salt. If possible, these substituents may be connected to each other to form a cyclic structure.

X represents NR (in which R represents a hydrogen atom or substituent which may be one of the substituents T exemplified later), oxygen atom or sulfur atom. X is preferably NR(R is preferably an acyl group or sulfonyl group. These substituents may be further substituted) or oxygen atom, particularly oxygen atom.

The substituents T are as defined in the formula (16), including their preferred examples. Two or more of these substituents T, if any, may be the same or different. If possible, these substituents may be connected to each other to form rings.

The compound of the formula (102) is preferably a compound represented by the following formula (102-A). 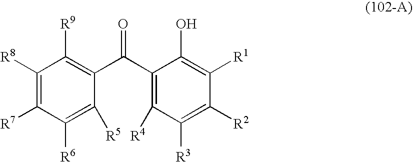
wherein R¹, R², R³, R⁴, R¹, R⁶, R⁷, R⁸ and R⁹ each independently represent a hydrogen atom or substituent.

R¹, R², R³, R⁴, R⁵, R⁶, R⁷, R⁸ and R⁹ each independently represent a hydrogen atom or substituent which may be one of the aforementioned substituents T. These substituents may be further substituted by other substituents. These substituents may be condensed with each other to form a cyclic structure.

R¹, R², R³, R⁴, R⁵, R⁶, R⁷, R⁸ and R⁹ each are preferably a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or C₁-C₁₂ alkyl group, particularly preferably a hydrogen atom or methyl group, most preferably a hydrogen atom.

R² is preferably a hydrogen atom, alkyl group, alkenyl group, alkynyl group, aryl group, substituted or unsubstituted amino group, alkoxy group, aryloxy group, hydroxyl group or halogen atom, more preferably a hydrogen atom, C₁-C₂₀ alkyl group, C₀-C₂₀ amino group, C₁-C₂₀ alkoxy group, C₆-C₁₂ aryloxy group or hydroxyl group, even more preferably a C₁-C₂₀ alkoxy group, particularly preferably a C₁-C₁₂ alkoxy group.

R⁷ is preferably a hydrogen atom, alkyl group, alkenyl group, alkynyl group, aryl group, substituted or unsubstituted amino group, alkoxy group, aryloxy group, hydroxyl group or halogen atom, more preferably a hydrogen atom, C₁-C₂₀ alkyl group, C₀-C₂₀ amino group, C₁-C₂₀ alkoxy group, C₆-C₁₂ aryloxy group or hydroxyl group, even more preferably a hydrogen atom or C₁-C₂₀ alkyl group (preferably a C₁-C₁₂ alkyl group, more preferably a C₁-C₈ alkyl group, even more preferably methyl), particularly preferably a methyl group or hydrogen atom.

The compound of the formula (102) is preferably a compound represented by the following formula (102-B). 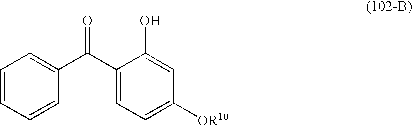
wherein R¹⁰ represents a hydrogen atom or a substituted or unsubstituted alkyl, alkenyl, alkynyl or aryl group.

R¹⁰ represents a hydrogen atom or a substituted or unsubstituted alkyl, alkenyl, alkynyl or aryl group. As the substituents on these groups there may be used the substituents T exemplified above.

R¹⁰ is preferably a substituted or unsubstituted alkyl group, more preferably a C₅-C₂₀ substituted or unsubstituted alkyl group, even more preferably a C₅-C₁₂ substituted or unsubstituted alkyl group (e.g., n-hexyl group, 2-ethynylhexyl group, n-octyl group, n-decyl group, n-dodecyl group, benzyl group), particularly preferably a C₆-C₁₂ substituted or unsubstituted alkyl group (e.g., 2-ethylhexyl group, n-octyl group, n-decyl group, n-dodecyl group, benzyl group).

The compound represented by the formula (102) can be synthesized by a known method disclosed in JP-A-11-12219.

Specific examples of the compound represented by the formula (102) will be given below, but the invention is not limited thereto.

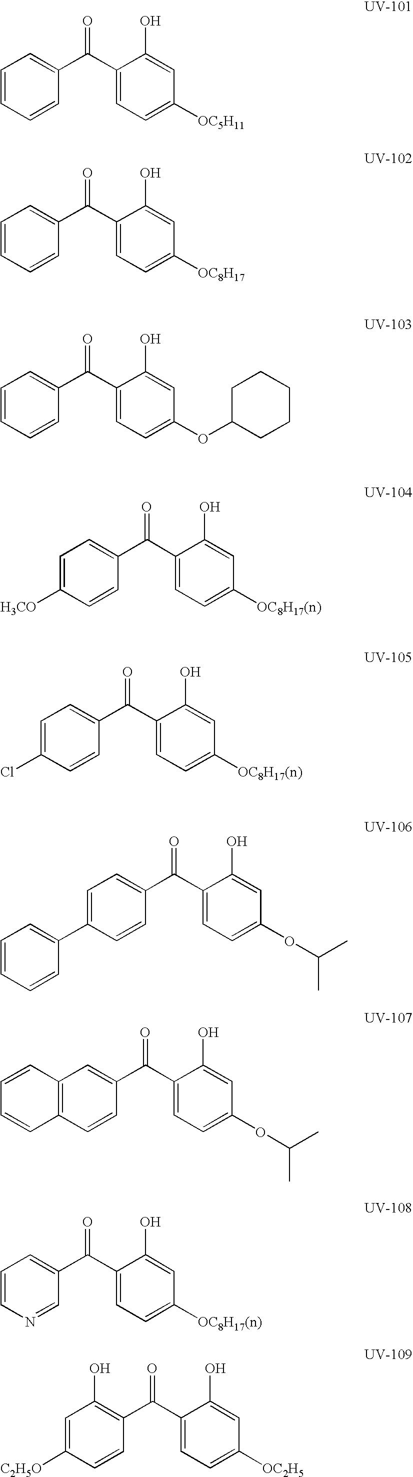

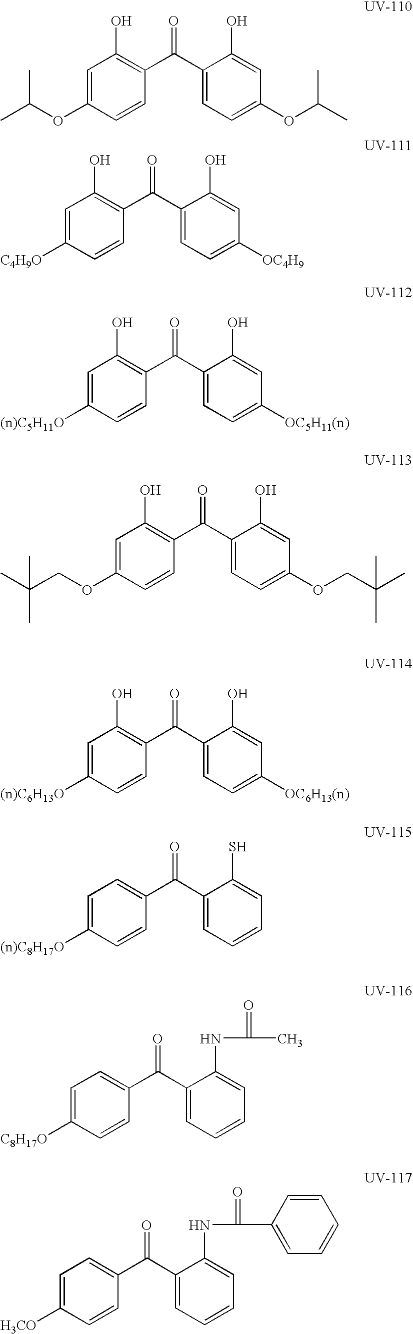

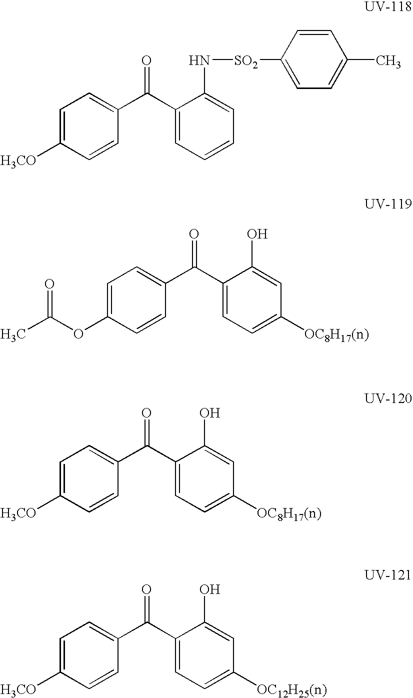

As the compound containing a cyano group which is one of the wavelength dispersion adjustors to be used in the invention there is preferably used one represented by the formula (103). 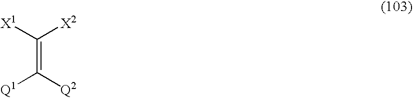
wherein Q¹ and Q² each independently represent an aromatic ring; and X¹ and X² each represent a hydrogen atom or substituent, with the proviso that at least one of X¹ and X² represents a cyano group, carbonyl group, sulfonyl group or aromatic heterocyclic group.

The aromatic rings represented by Q¹ and Q² each may be an aromatic hydrocarbon ring or aromatic heterocyclic group. These rings may be monocyclic or may form condensed rings with other rings.

The aromatic hydrocarbon ring is preferably a C₆-C₃₀ monocyclic or bicyclic aromatic hydrocarbon ring (e.g., benzene ring, naphthalene ring), more preferably a C₆-C₂₀ aromatic hydrocarbon ring, even more preferably a C₆-C₁₂ aromatic hydrocarbon ring, even more preferably a benzene ring.

The aromatic heterocyclic ring is preferably an aromatic heterocyclic group containing nitrogen atom or sulfur atom. Specific examples of the heterocyclic group include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthaladine, naphthylidine, quinoxaline, quinazoline, cinnoline, pteridine, acrydine, phenanthroline, phenazine, tetrazole, benzimidazole, benzoxazole, benzthiazole, benzotriazole, and tetrazaindene. Preferred among these aromatic heterocyclic groups are pyridine, triazine, and quinoline.

The aromatic rings represented by Q¹ and Q² each are preferably an aromatic hydrocarbon ring, more preferably a benzene ring.

Q¹ and Q² each may further have substituents which are preferably the substituents T. The substituents T have the same meaning as those described with reference to the formula (16), including their preferred examples.

Two or more of these substituents T, if any, may be the same or different. If possible, these substituents T may be connected to each other to form rings.

X¹ and X² each represent a hydrogen atom or substituent. At least one of X¹ and X² represents a cyano group, carbonyl group, sulfonyl group or aromatic heterocyclic group. As the substituents represented by X¹ and X² there may be used the aforementioned substituents T. The substituents represented by X¹ and X² may be further substituted by other substituents. X¹ groups and X² groups may be each condensed with each other to form a cyclic structure.

X¹ and X² is preferably a hydrogen atom, alkyl group, aryl group, cyano group, nitro group, carbonyl group, sulfonyl group or aromatic heterocyclic group, more preferably a cyano group, carbonyl group, sulfonyl group or aromatic heterocyclic group, even more preferably a cyano group or carbonyl group, particularly preferably a cyano group or alkoxycarbonyl group (—C(═O)OR (in which R represents a C₁-C₂₀ alkyl group, C₆-C₁₂ aryl group or combination thereof).

The compound of the formula (103) is preferably a compound represented by the following formula (103-A). 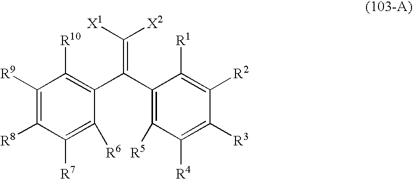
wherein R¹, R², R³, R⁴, R⁵, R⁶, R⁷, R⁸, R⁹ and R¹⁰ each independently represent a hydrogen atom or substituent; and X¹ and X² each are as defined in the formula (103), including their preferred range.

R¹, R², R³, R⁴, R⁵, R⁶, R⁷, R⁸, R⁹ and R¹⁰ each independently represent a hydrogen atom or substituent. As such substituents there may be used the aforementioned substituents T. These substituents may be further substituted by other substituents or may be condensed with each other to form a cyclic structure.

R¹, R², R³, R⁴, R⁵, R⁶, R⁷, R⁸, R⁹ and R¹⁰ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, alkyl group, aryl group, alkyloxy group, aryloxy group or halogen atom, even more preferably a hydrogen atom or a C₁-C₁₂ alkyl group, particularly preferably a hydrogen atom or methyl group, most preferably a hydrogen atom.

R³ and R⁸ each preferably represent a hydrogen atom, alkyl group, alkenyl group, alkynyl group, aryl group, substituted or unsubstituted amino group, alkoxy group, aryloxy group, hydroxyl group or halogen atom, more preferably a hydrogen atom, C₁-C₂₀ alkyl group, C₀-C₂₀ amino group, C₁-C₁₂ alkoxy group, C₆-C₁₂ alkyloxy group or hydroxyl, even more preferably a hydrogen atom, C₁-C₁₂ alkyl group or C₁-C₁₂ alkoxy group, particularly preferably a hydrogen atom.

The compound of the formula (103) is preferably a compound represented by the following formula (103-B). 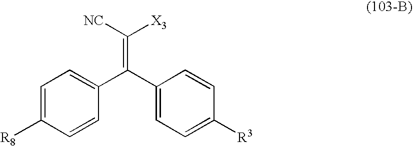
wherein R³ and R⁸ each are as defined in the formula (103-A), including their preferred range; and X³ represents a hydrogen atom or substituent.

X³ represents a hydrogen atom or substituent which may be one of the aforementioned substituents T. If possible, these substituents may be further substituted by other substituents. X³ is preferably a hydrogen atom, alkyl group, aryl group, cyano group, nitro group, carbonyl group, sulfonyl group or aromatic heterocyclic group, more preferably a cyano group, carbonyl group, sulfonyl group or aromatic heterocyclic group, even more preferably a cyano group or carbonyl group, particularly preferably a cyano group or alkoxycarbonyl group (—C(═O)OR (in which R represents a C₁-C₂₀ alkyl group, C₆-C₁₂ aryl group or combination thereof).

The compound of the formula (103) is preferably a compound represented by the following formula (103-C). 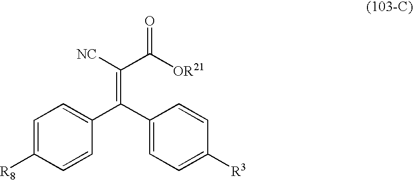
wherein R³ and R⁸ each are as defined in the formula (103-A), including their preferred range; and R²¹ represents a C₁-C₂₀ alkyl group.

When both R³ and R⁸ are a hydrogen atom, R²¹ is preferably a C₂-C₁₂ alkyl group, more preferably a C₄-C₁₂ alkyl group, even more preferably a C₆-C₁₂ alkyl group, particularly preferably n-octyl group, tert-octyl group, 2-ethylhexyl group, n-decyl group or n-dodecyl group, most preferably 2-ethylhexyl group.

When R³ and R⁸ each are a group other than hydrogen atom, R²¹ is preferably an alkyl group represented by the formula (103-C) having a molecular weight of 300 or more and 20 or less carbon atoms.

The compound represented by the formula (103) of the invention can be synthesized by the method disclosed in “Journal of American chemical Society”, vol. 63, page 3,452, 1941.

Specific examples of the compound represented by the formula (103) will be given below, but the invention is not limited thereto. 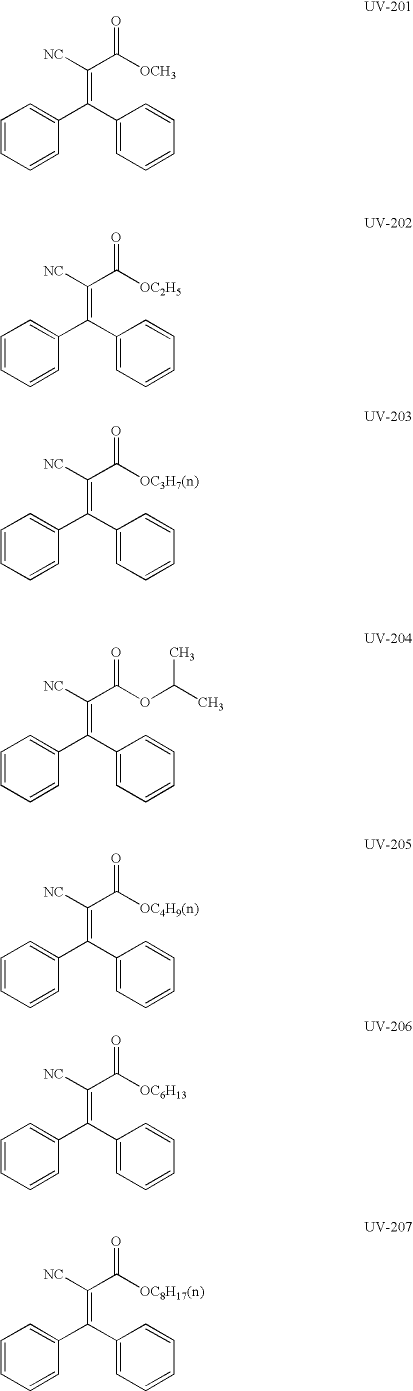 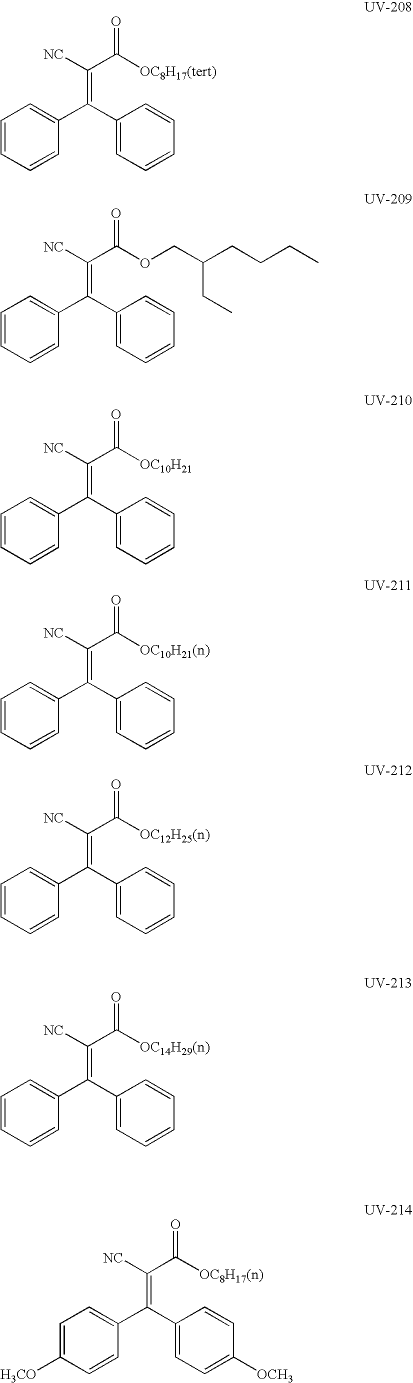 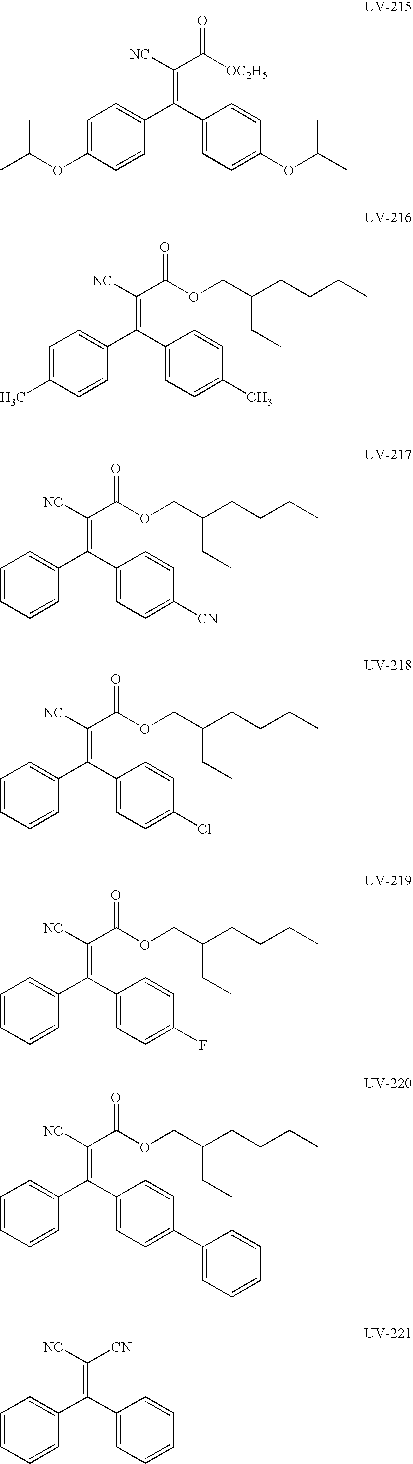 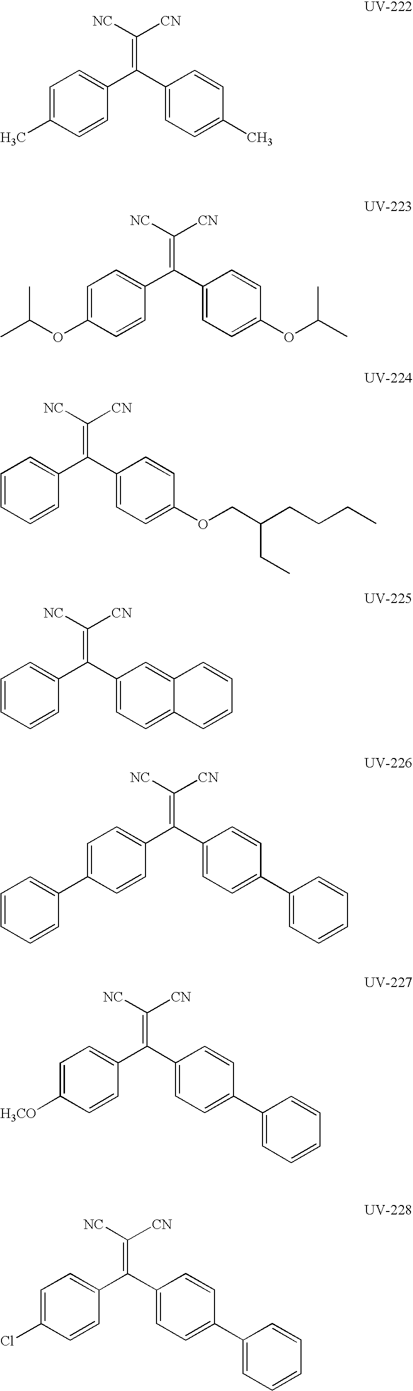 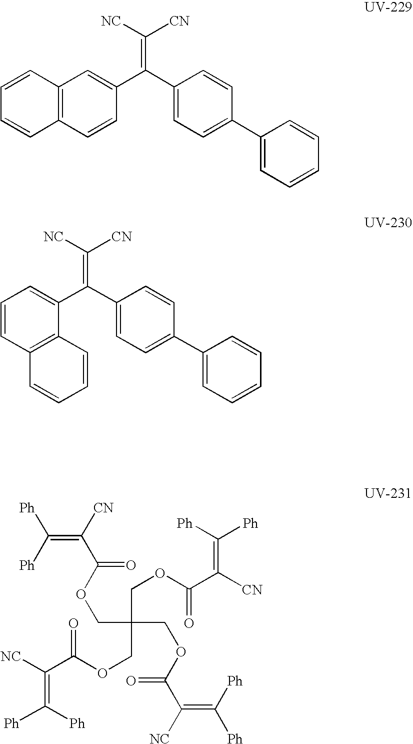
(Particulate Matting Agent)

The cellulose acylate film of the invention preferably has a particulate material incorporated therein as a matting agent. Examples of the particulate material to be used in the invention include silicon dioxide, titanium dioxide, aluminum oxide, zirconium oxide, calcium carbonate, talc, clay, baked kaolin, baked calcium silicate, hydrous calcium silicate, aluminum silicate, magnesium silicate, and calcium phosphate. The particulate material preferably contains silicon to reduce turbidity. Silicon dioxide is particularly preferred. The particulate silicon dioxide preferably has a primary average particle diameter of 20 nm or less and an apparent specific gravity of 70 g/l or more. Particulate silicon dioxide having a primary average particle diameter as small as from 5 nm to 16 nm is more desirable to reduce haze. The apparent specific gravity of the particulate silicon dioxide is preferably from 90 to 200 g/l, more preferably from 100 to 200 g/l. The more the apparent specific gravity of the particulate silicon dioxide is, the more likely can be prepared a high concentration dispersion and the better are haze and properties of agglomerated material.

These finely divided particles normally form secondary particles having an average particle diameter of from 0.1 μm to 3.0 μm. These finely divided particles are present in the form of agglomerate of primary particles in the film to form an unevenness having a size of from 0.1 μm to 3.0 μm on the surface of the film. The secondary average particle diameter of these finely divided particles is preferably from not smaller than 0.2 μm to not greater than 1.5 μm, more preferably from not smaller than 0.4 μm to not greater than 1.2 μm, most preferably from not smaller than 0.6 μm to not greater than 1.1 μm. For the determination of primary and secondary particle diameter, particles in the film are observed under scanning electron microphotograph. The particle diameter is defined by the diameter of the circle circumscribing the particle. 200 particles which are located in dispersed positions are observed. The measurements are averaged to determine the average particle diameter.

As the particulate silicon dioxide there may be used a commercially available product such as Aerosil R972, R972V, R974, R812, 200, 200V, 300, R202, OX50 and TT600 (produced by Nippon Aerosil Co., Ltd.). The particulate zirconium oxide is commercially available as Aerosil R976 and R811 (produced by Nippon Aerosil Co., Ltd.). These products can be used in the invention.

Particularly preferred among these products are Aerosil 200V and Aerosil R972 because they are a particulate silicon dioxide having a primary average particle diameter of 20 nm or less and an apparent specific gravity of 70 g/l or more that exerts a great effect of reducing friction coefficient while keeping the turbidity of the optical film low.

In the invention, in order to obtain a cellulose acylate film containing particles having a small secondary average particle diameter, various methods may be proposed to prepare a dispersion of particles. For example, a method may be employed which comprises previously preparing a particulate dispersion of particles in a solvent, stirring the particulate dispersion with a small amount of a cellulose acylate solution which has been separately prepared to make a solution, and then mixing the solution with a main cellulose acylate dope solution. This preparation method is desirable because the particulate silicon dioxide can be fairly dispersed and thus can be difficulty re-agglomerated. Besides this method, a method may be employed which comprises stirring a solution with a small amount of cellulose ester to make a solution, dispersing the solution with a particulate material using a dispersing machine to make a solution having particles incorporated therein, and then thoroughly mixing the solution having particles incorporated therein with a dope solution using an in-line mixer. The invention is not limited to these methods. The concentration of silicon dioxide during the mixing and dispersion of the particulate silicon dioxide with a solvent or the like is preferably from 5 to 30% by weight, more preferably from 10 to 25% by weight, most preferably from 15 to 20% by weight. As the concentration of dispersion rises, the turbidity of the solution with respect to the added amount decreases to further reduce haze and agglomeration to advantage. The content of the matting agent in the final cellulose acylate dope solution is preferably from 0.01 to 1.0 g, more preferably from 0.03 to 0.3 g, most preferably from 0.08 to 0.16 g per m².

Preferred examples of the solvent which is a lower alcohol include methyl alcohol, ethyl alcohol, propyl alcohol, isopropyl alcohol, and butyl alcohol. The solvent other than lower alcohol is not specifically limited, but solvents which are used during the preparation of cellulose ester are preferably used.

(Plasticizer, Deterioration Inhibitor, Release Agent)

The cellulose acylate film of the invention may comprise various additives (e.g., plasticizer, ultraviolet inhibitor, deterioration inhibitor, release agent, infrared absorber) incorporated therein besides the aforementioned compound decreasing optical anisotropy and wavelength dispersion adjustor depending on the purpose at the various preparation steps. These additives may be in the form of solid or oil-based material. In other words, these additives are not specifically limited in its melting point or boiling point. For example, ultraviolet absorbers having a melting point of not higher than 20° C. and not lower than 20° C. may be used in admixture. Alternatively, plasticizers having different melting points may be used in admixture. For details, reference can be made to JP-A-2001-151901. For the details of infrared absorber, reference can be made to JP-A-2001-194522. These additives may be added at any time during the preparation of the dope but may be added at an additive step of adding them during the final preparation step of preparing the dope. The added amount of the various materials are not specifically limited so far as their function can be exhibited. In the case where the cellulose acylate film is formed by multiple layers, the kind and content of the additives to be incorporated in the various layers may be different. As disclosed in JP-A-2001-151902, these techniques have heretofore been known. For the details of the additives which are preferably used, reference can be made to Kokai Giho 2001-1745, Japan Institute of Invention and Innovation, May 15, 2001, pp. 16-22.

(Mixing Proportion of Compounds)

The total amount of compounds having a molecular weight of 3,000 or less to be incorporated in the cellulose acylate film of the invention is preferably from 5% to 45%, more preferably from 10% to 40%, even more preferably from 15% to 30% based on the weight of the cellulose acylate. Examples of these compounds include compounds for decreasing optical anisotropy, wavelength dispersion adjustors, ultraviolet inhibitors, plasticizers, deterioration inhibitors, particulate materials, release agents, and infrared absorbers as described above. These compounds each preferably have a molecular weight of 3,000 or less, more preferably 2,000 or less, even more preferably 1,000 or less. When the total amount of these compounds is 5% or less, the properties of cellulose acylate in simple body can easily appear. For example, the cellulose acylate film can easily show a change of optical properties or physical strength with the change of temperature or humidity to disadvantage. On the other hand, when the total amount of these compounds is 45% or more, it is beyond the limit at which these compounds can be compatible with the cellulose acylate, causing the deposition of these compounds on the surface of the film and hence the clouding of the film (bleeding from the film) to disadvantage.

(Organic Solvent for Cellulose Acylate Solution)

In the invention, the cellulose acylate film of the invention is preferably produced by a solvent casting method. In the solvent casting method, a solution of cellulose acylate in an organic solvent (dope) is used to produce a film. The organic solvent which is preferably used as a main solvent of the invention is preferably one selected from the group consisting of ester, ketone and ether having from 3 to 12 carbon atoms and halogenated hydrocarbon having from 1 to 7 carbon atoms. The ester, the ketone and the ether may have a cyclic structure. A compound having two or more of functional groups of ester, ketone and ether (i.e., —O—, —CO—, —COO—), too, may be used as a main solvent. This compound may have other functional groups such as alcoholic hydroxyl group. The number of carbon atoms in the main solvent having two or more functional groups preferably falls within the specified range of number of carbon atoms in the solvent having any of these functional groups.

For the aforementioned cellulose acylate film of the invention, a chlorine-based halogenated hydrocarbon may be used as a main solvent. Alternatively, as disclosed in Kokai Giho 2001-1745, Japan Institute of Invention and Innovation, pp. 12-16, a non-chlorine-based solvent may be used as a main solvent. The main solvent to be used for the cellulose acylate film of the invention is not specifically limited.

The solvents for the cellulose acylate solution and film of the invention are disclosed in the following patents with its dissolution method. These disclosures are preferred embodiments. For details, reference can be made to JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752, and JP-A-11-60752. These patents refer to not only solvents suitable for cellulose acylate of the invention but also their solution physical properties and materials to be present therewith. These embodiments are desirable also in the invention.

(Step of Producing Cellulose Acylate Film)

(Dissolving Step)

In the method for the preparation of the cellulose acylate solution (dope) of the invention, the dissolving method is not specifically limited. The dissolution of the raw materials may be effected at room temperature. Alternatively, the dissolution of the raw materials may be effected by either or both of a cold dissolving method or a hot dissolving method. For the steps of preparing the cellulose acylate solution of the invention, concentrating the solution involved in the dissolving step and filtering the solution, reference can be made to Kokai Giho 2001-1745, Japan Institute of Invention and Innovation, pp. 22-25, Mar. 15, 2001, can be preferably employed.

(Transparency of Dope Solution)

The transparency of the cellulose acylate dope solution of the invention is preferably 85% or more, more preferably 88% or more, even more preferably 90% or more. It was confirmed that the cellulose acylate dope solution of the invention has various additives sufficiently dissolved therein. Referring in detail to the method for calculating the dope transparency, a glass cell having a size of 1 cm square filled with the dope solution was measured for absorbance at 550 nm using a Type UV-3150 spectrophotometer (produced by Shimadzu Corporation). The solvent alone had been previously measured for absorbance as a blank. The transparency of the cellulose acylate solution was then calculated from the ratio of absorbance of the dope solution to absorbance of the blank.

(Flow Casting, Drying and Winding Steps)

The method for producing the film from the cellulose acylate solution of the invention will be described hereinafter. As the method and apparatus for the production of the cellulose acylate film of the invention there may be used a solution flow casting film-forming method and a solution flow casting film-forming apparatus which have heretofore been used for the production of cellulose acylate film. In some detail, the dope (cellulose acylate solution) prepared in the dissolving machine (kiln) is stored in a storage kiln so that bubbles contained in the dope are removed to make final adjustment. The dope thus adjusted is then delivered from the dope discharge port to a pressure die through a pressure constant rate gear pump capable of delivering a liquid at a constant rate with a high precision depending on the rotary speed. The dope is then uniformly flow-casted through the slit of the pressure die over a metallic support in the flow casting portion which is being running endlessly. When the metallic support has made substantially one turn, the half-dried dope film (also referred to as “web”) is then peeled off the metallic support. The web thus obtained is then dried while being conveyed by a tenter with the both ends thereof being clamped by a clip to keep its width. Subsequently, the web is conveyed by a group of rolls in the drying apparatus to finish drying. The web is then wound to a predetermined length by a winding machine. The combination of tenter and a group of rolls varies with the purpose. In a solution flow casting/filming method for use in functional protective layer which is an optical member for electronic display or silver halide photographic material, a coating device is often added to the solution flow casting/filming device for the purpose of surface working of film such as subbing layer, antistatic layer, anti-halation layer and protective layer. For details, reference can be made to Kokai Giho 2001-1745, Japan Institute of Invention and Innovation, pp. 22-25, Mar. 15, 2001. These factors can be classified as flow casting (including cocasting), metallic support, drying and peeling and thus can be preferably used in the invention.

The thickness of the cellulose acylate film is preferably from 10 μm to 120 μm, more preferably from 20 μm to 100 μm, even more preferably from 30 μm to 90 μm.

(Peeling)

In the invention, the peeling step is very important and thus will be further described hereinafter. The speed at which the cellulose acylate film is produced varies with the length of the belt, the drying method, the formulation of the dope solvent, etc. but can be determined almost by the residual solvent content at the point of peeling the film (containing an organic solvent; also referred to as “web”). In other words, in the case where the concentration of solvent in the vicinity of the surface of the belt in the thickness direction of the dope film, when the dope film is peeled off the belt, the dope is left on the belt, causing some troubles in subsequent flow casting. Therefore, peel leftover should be absolutely avoided. Further, a web strength high enough to withstand the peel strength is needed. The residual solvent content at the point of peeling depends also on the drying method on the belt or drum. The residual solvent content can be lowered more effectively by the method involving the heat transfer from the back side of the belt or drum than by the method which comprises blowing air against the surface of the dope.

In the following description of peeling, embodiments disclosed in Kokai Giho, etc. will be cited. These citations are preferably used also in the examples of the invention.

JP-A-5-057739 discloses an invention which comprises predetermining the percent volatile content during peeling to a range of from 10% to 30% by mass as calculated in terms of dried amount and keeping the surface temperature of the support at the peeling site to a range of from not lower than 14° C. to not higher than 20° C. for the purpose of providing good planarity and uniform surface conditions.

JP-A-2000-239403 relates to a method for the production of a cellulose acylate film which comprises peeling a web off a metallic support in such a manner that the residual solvent content X during peeling is from not lower than 15 to not greater than 120, and then drying the web to form a film and particularly to a method for drying a thin optically anisotropic cellulose acylate film having a good planarity.

In order to obtain a thin film having an excellent optical isotropy and planarity, JP-A-2000-239403 discloses a film-forming method which comprises partially applying an external force to the web crosswise so that the web can be linearly peeled at equal longitudinal positions along the support to obtain a film having a small thickness and excellent optical anisotropy and planarity.

As further preferred embodiments, there are disclosed:

To make a film in such a manner that T1 satisfies the relationship Tbp−20≦T1≦Tbp+20 and T2 satisfies the relationship Ts≦T2≦Ts+40 supposing that the temperature of drying air against the web on the flow casting support is T1, the temperature of drying air blown against the web for at least 10 seconds after peeling is T2, the boiling point of the main solvent is Tbp and the temperature of the flow casting support at the peeling site is Ts.

To make a film in such a manner that the conveying tension during peeling is from 3 to 40 kg/m width.

JP-A-2002-187146 discloses an invention which comprises specifying the volatile content, draw ratio and roll lap during peeling to prevent the occurrence of flaw on the film and inhibit the haze of the film.

JP-A-2002-282658 discloses an invention which comprises predetermining the residual solvent content in the web during the peeling of the web obtained by flow-casting a cellulose ester solution over a driving metallic endless belt off the endless belt by the peeling roll to a range of from 20% to 150% and the Vickers hardness of the peeling roll and the conveying rolls ranging from the peeling roll to the drying device to a range of from 500 to 800 for the purpose of preventing the attachment of a plasticizer and an ultraviolet absorber to the rolls.

As still further embodiments, there are disclosed:

To heat at least the peeling roll and the peeling roll among the conveying rolls ranging from the peeling roll to the drying device to a temperature of from 100° C. to 300° C. and predetermine the Vickers hardness of the roll thus heated to a range of from 800 to 1,000.

To predetermine the surface roughness Ry of at least the peeling roll of the peeling roll and the conveying rolls to 0.6 μm or less.

To form the surface layer of at least the peeling roll of the peeling roll and the conveying rolls by a Ni alloy.

To use a roll having a surface energy of from 70 to 100 mN/m at 20° C. as at least the peeling roll of the peeling roll and the conveying rolls.

To predetermine the surface temperature of the peeling roll and the conveying rolls to not lower than the melting point of the plasticizer contained in the web when the residual solvent content in the web which has been peeled off the endless belt by the peeling roll and come in contact with the peeling roll and the conveying rolls ranging from the peeling roll to the drying device is from 60% to 80%.

To predetermine the Vickers hardness of the peeling roll and the conveying rolls to a range of from 500 to 800.

To heat the peeling roll and the conveying rolls to a temperature of from 100° C. to 300° C. and

predetermine the Vickers hardness of the rolls thus heated to a range of from 800 to 1,000.

To predetermine the surface roughness Ry of the peeling roll and the conveying rolls to 0.6 μm or less.

To form the surface layer of the peeling roll and the conveying rolls by a Ni alloy.

To use a roll having a surface energy of from 70 to 100 mN/m at 20° C. as the peeling roll and the conveying rolls.

It is further disclosed that the Vickers hardness of the rolls be more preferably from 550 to 800.

For the determination of the peel tension in the invention, the roll for conveying the film shortly after peeling is rendered capable of picking up tension. The peel load (N/m) is determined from the load applied to the rolls.

JP-A-2002-028943, which invention is intended to eliminate crosswise stage unevenness, discloses:

To predetermine the level of a peel noise having from 125 to 250 Hz components generated during the peeling of the web to 90 dB or less when the volume of sound obtained by subtracting noises other than 125 to 250 Hz components from all the noises is measured free from shield at a point of from 100 cm to 150 cm apart from the peeling site.

To peel the web at a peeling tension of from 30 to 240 N/m width, convey the web while the web tension over the process distance between the peeling point and the tension blocking unit being kept constant with the process distance kept at 2 m at minimum and 90 m at maximum along the web, and predetermine the change of residual solvent content in the web over the process distance to a range of from 10% by mass to 140% by mass.

It is also disclosed that the tension blocking unit may be a drive roll.

Further, JP-A-2002-254451 discloses a solution film forming method which comprises predetermining the film peeling angle to a range of from 300 to 800 when the tangential direction and normal direction at the peeling site of the flow casting support at which the film is peeled off the flow casting support are 0° and 90°, respectively, to prevent the occurrence of troubles such as stage unevenness, belt streak, dent-like defect, unevenness in planarity and haze rise due to fine surface roughness, etc.

The peel load in the invention is preferably from 1 to 25 N/m, more preferably from 1 to 20 N/m, even more preferably from 1 to 15 N/m, particularly preferably from 1 to 10 N/m. The above cited inventions concerning the conditions of peeling of the cellulose acylate film off the metallic support, etc. can be used also in the invention.

(Surface Treatment)

The cellulose acylate film of the invention may be optionally subjected to surface treatment to attain the enhancement of the adhesion of the cellulose acylate film to the various functional layers (e.g., undercoat layer and back layer). Examples of the surface treatment employable herein include glow discharge treatment, irradiation with ultraviolet rays, corona treatment, flame treatment, and acid or alkaline treatment. The glow discharge treatment employable herein may involve the use of low temperature plasma developed under a low gas pressure of from 10-3 to 20 Torr, even more preferably plasma under the atmospheric pressure. The plasma-excitable gas is a gas which can be excited by plasma under the aforementioned conditions. Examples of such a plasma-excitable gas include argon, helium, neon, krypton, xenon, nitrogen, carbon dioxide, fluorocarbon such as tetrafluoromethane, and mixture thereof. For the details of these plasma-excitable gases, reference can be made to Kokai Giho No. 2001-1745, Mar. 15, 2001, pp. 30-32, Japan Institute of Invention and Innovation. These plasma-excitable gases can be preferably used in the invention.

(Functional Layer)

The cellulose acylate film of the invention can be applied to optical devices and photographic materials. In particular, the optical devices are preferably liquid crystal displays. More preferably, these liquid crystal displays each comprise a liquid crystal cell having a liquid crystal supported interposed between two sheets of electrode substrates, two sheets of polarizing element disposed on the respective side thereof and at least one sheet of optically compensatory sheet disposed interposed between the liquid crystal cell and the polarizing element. Preferred examples of these liquid crystal displays include TN, IPS, FLC, AFLC, OCB, STN, ECB, VA, and HAN.

In order to use the cellulose acylate film of the invention for the aforementioned optical purpose, the cellulose acylate film may be provided with various functional layers on the surface thereof. Examples of these functional layers include antistatic layer, cured resin layer (transparent hard coat layer), anti-reflection layer, adhesive layer, anti-glare layer, optically compensatory layer, alignment layer, and liquid crystal layer. Examples of these functional layers which can be used in the cellulose acylate film of the invention and their materials include surface active agents, lubricants, matting agents, antistatic layers, and hard coat layers. For details, reference can be made to Kokai Giho 2001-1745, Japan Institute of Invention and Innovation, pp. 32-45, Mar. 15, 2001. These functional layers and materials can be preferably used in the invention.

(Use (Polarizing Plate))

The use of the cellulose acylate film of the invention will be described hereinafter.

The optical film of the invention is useful particularly for polarizing plate protective film. In the case where a cellulose acylate film of the invention is used as a protective layer for polarizer, the method of preparing the polarizing plate is not specifically limited but may be any ordinary method. For example, a method may be employed which comprises subjecting a cellulose acylate film obtained to alkaline treatment, and then sticking the cellulose acylate film to the both surfaces of a polarizer prepared by dipping and stretching a polyvinyl alcohol in an iodine solution with an aqueous solution of a fully-saponified polyvinyl alcohol. A processing for easy adhesion as disclosed in JP-A-6-94915 and JP-A-6-118232 may be effected instead of alkaline treatment.

Examples of the adhesive with which the processed surface of the protective layer and the polarizer are stuck to each other include polyvinyl-based adhesives such as polyvinyl alcohol and polyvinyl butyral, and vinyl-based latexes such as butyl acrylate.

The polarizing plate comprises a polarizer and a protective layer for protecting the both surfaces thereof. The polarizing plate may further have a protective film provided on one surface thereof and a separate film provided on the other. The protective film and the separate film are used for the purpose of protecting the surface of the polarizing plate during the shipment of the polarizing plate and during the inspection of the product. In this case, the protective film is stuck to the polarizing plate for the purpose of protecting the surface of the polarizing plate. The protective film is provided on the side of the polarizing plate opposite the side on which it is stuck to the liquid crystal cell. The separate film is used for the purpose of covering the adhesive layer to be stuck to the liquid crystal cell. The separate film is provided on the side of the polarizing plate on which it is stuck to the liquid crystal plate.

A liquid crystal display normally comprises a substrate containing a liquid crystal disposed interposed between two sheets of polarizing plate. The polarizing plate protective film to which the optical film of the invention is applied can provide excellent display properties whatever site in the liquid crystal display it is disposed. In particular, since the polarizing plate protective film on the outermost surface on the display side of the liquid crystal display has a transparent hard coat layer, an anti-glare layer, an anti-reflection layer, etc. provided therein, it is particularly preferred that the polarizing plate protective film be used in this site.

(Use (Optically Compensatory Film))

The cellulose acylate film of the invention can be used for various purposes. The cellulose acylate film of the invention can exert its effect particularly when used as an optically compensatory film for liquid crystal display. An optically compensatory film is an optical material which is normally used in liquid crystal displays to compensate the retardation thereof and is synonymous with retardation plate, optically compensatory sheet, etc. An optically compensatory film is birefringent and thus is used for the purpose of decoloring the display screen of liquid crystal display or improving the viewing angle properties thereof. The cellulose acylate film of the invention has a small optical anisotropy as well as a small wavelength dispersion of optical anisotropy and thus shows no extra anisotropy. Thus, when the cellulose acylate film of the invention is used in combination with a birefringent optically anisotropic layer, only the optical properties of the optically anisotropic layer can be exhibited.

Accordingly, in the case where the cellulose acylate film of the invention is used as an optically compensatory film for liquid crystal display, Re and Rth of the optically anisotropic layer to be used in combination with the cellulose acylate film of the invention are preferably from 0 nm to 200 nm and from 0 nm to 400 nm, respectively. Any optically anisotropic layer may be used so far as Re and Rth thereof fall within the above defined range. Any optically anisotropic layer which is required as an optically compensatory film can be used in combination with the cellulose acylate film of the invention without being restricted by the optical properties or driving system of the liquid crystal cell of the liquid crystal display comprising the cellulose acylate film of the invention. The optically anisotropic layer to be used in combination with the cellulose acylate film of the invention may be formed by a composition containing a liquid crystal compound or a birefringent polymer film.

The aforementioned liquid crystal compound is preferably a discotic liquid crystal compound or a rod-shaped liquid crystal compound.

(Discotic Liquid Crystal Compound)

Examples of the discotic liquid crystal compound which can be used in the invention include compounds disclosed in various references (C. Destrade et al., “Mol. Crysr. Liq. Cryst.”, vol. 71, page 111, 1981; “Quarterly Review of Chemistry”, The Chemical Society of Japan, No. 22, “Ekisho no Kagaku (Chemistry of Liquid Crystals)”, Chapter 5, Section 2 of Chapter 10, 1994; B. Kohne et al., “Angew. Chem. Soc. Chem. Comm.”, page 1794, 1985; J. Zhang et al., “J. Am. Chem. Soc.”, vol. 1116, page 2655, 1994).

The optically anisotropic layer preferably has discotic liquid crystal molecules fixed aligned therein. Most preferably, these discotic liquid crystal molecules have been fixed by polymerization reaction. For the polymerization of discotic liquid crystal molecules, reference can be made to JP-A-8-27284. In order to fix discotic liquid crystal molecules by polymerization, it is necessary that a polymerizable group be connected as a substituent to the disc-shaped core of the discotic liquid crystal molecules. However, when a polymerizable group is connected directly to the disc-shaped core of the discotic liquid crystal molecules, the discotic liquid crystal molecules can be difficulty kept aligned in the polymerization reaction. In order to avoid this trouble, a connecting group is incorporated in between the disc-shaped core and the polymerizable group. For the details of discotic liquid crystal molecules having a polymerizable group, reference can be made to JP-A-2001-4387.

(Rod-Shaped Liquid Crystal Compound)

Examples of the rod-shaped liquid crystal compound employable herein include azomethines, azoxys, cyanobiphenyls, cyanophenylesters, benzoic acid esters, cyclohexanecarboxylic acid phenyl esters, cyanophenyl cyclophexanes, cyano-substituted phenylpyrimdines, alkoxy-substituted phenylpyrimidines, phenyldioxanes, tolans, and alkenyl cyclohexylbenzonitriles. Not only the aforementioned low molecular liquid crystal compounds but also polymer liquid crystal compounds can be used.

The optically anisotropic layer preferably has rod-shaped liquid crystal molecules fixed aligned therein. Most preferably, these rod-shaped liquid crystal molecules have been fixed by polymerization reaction. Examples of the polymerizable rod-shaped liquid crystal compounds employable herein include compounds disclosed in “Makromol. Chem.”, vol. 190, page 2,255, 1989, “Advanced Materials”, vol. 5, page 107, 1993, U.S. Pat. Nos. 4,683,327, 5,622,648 and 5,770,107, WO95/22586, WO95/24455, WO97/00600, WO98/23580, WO98/52905, JP-A-1-272551, JP-A-6-16616, JP-A-7-110469, JP-A-11-80081, and JP-A-2001-328973.

(Optically Anisotropic Layer Made of Polymer Film)

As mentioned above, the optically anisotropic layer may be formed by a polymer film. The polymer film is formed by a polymer capable of developing optical anisotropy. Examples of such a polymer include polyolefins (e.g., polyethylene, polypropylene, norbornene-based polymer), polycarbonates, polyacrylates, polysulfones, polyvinyl alcohols, polymethacrylic acid esters, polyacrylic acid esters, and cellulose esters (e.g., cellulose triacetate, cellulose diacetate). A copolymer or mixture of these polymers may be used.

The optical anisotropy of the polymer film is preferably obtained by stretching. The stretching of the polymer film is preferably effected monoaxially or biaxially. In some detail, monoaxial longitudinal stretching utilizing the difference in circumferential speed between two or more rolls or tenter stretching involving crosswise stretching with the both sides of the polymer film gripped by the tenter is preferably employed. Alternatively, biaxial stretching involving the two stretching methods in combination is preferably employed. Two or more sheets of polymer film may be used so far as the entire optical properties thereof satisfy the aforementioned requirements. The polymer film is preferably produced by solvent casting method to eliminate unevenness in birefringence. The thickness of the polymer film is preferably from 20 μm to 500 μm, most preferably from 40 μm to 100 μm.

(Examples of Configuration of Liquid Crystal Display)

In the case where the cellulose acylate film is used as an optically compensatory film, the transmission axis of the polarizing element and the slow axis of the optically compensatory film made of cellulose acylate film may be disposed at any angle. A liquid crystal display comprises a liquid crystal cell having a liquid crystal supported interposed between two sheets of electrode substrates, two sheets of polarizing element disposed on the respective side thereof and at least one sheet of optically compensatory sheet disposed interposed between the liquid crystal cell and the polarizing element.

The liquid crystal layer of the liquid crystal cell is normally formed by enclosing a liquid crystal in a space defined by interposing a spacer between two sheets of substrate. The transparent electrode layer is formed on a substrate as a transparent film containing an electrically-conductive material. The liquid crystal cell may further have a gas barrier layer, a hard coat layer or an undercoat layer (subbing layer) (to be used for the adhesion of the transparent electrode layer) provided therein. These layers are normally provided on the substrate. The substrate of the liquid crystal cell normally has a thickness of from 50 μm to 2 mm.

(Kind of Liquid Crystal Display)

The cellulose acylate film of the invention may be used in various display mode liquid crystal cells. There have been proposed various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned), ECB (Electrically Controlled Birefringence), and HAN (Hybrid Alignment Nematic). There has also been proposed display modes obtained by domain division. The cellulose acylate film of the invention is effective for liquid crystal displays of any display mode. The cellulose acylate film of the invention is effective also for any of transmission type, reflection type and semi-transmission type liquid crystal displays.

(TN Type Liquid Crystal Display)

The cellulose acylate film of the invention may be used as support for optically compensatory sheet of TN type liquid crystal display comprising a TN mode liquid crystal cell. TN mode liquid crystal cells and TN type liquid crystal displays have long been known. For the details of optically compensatory sheet to be used in TN type liquid crystal displays, reference can be made to JP-A-3-9325, JP-A-6-148429, JP-A-8-50206, and JP-A-9-26572. Reference can be made also to Mori et al, “Jpn. J. Appl. Phys.”, Vol. 36 (1997), p. 143, and “Jpn. J. Appl. Phys.”, Vol. 36 (1997), p. 1,068.

(STN Type Liquid Crystal Display)

The cellulose acylate film of the invention may be used as a support for optically compensatory sheet of STN type liquid crystal display having an STN mode liquid crystal cell. In general, in an STN type liquid crystal display, rod-shaped liquid crystal molecules in the liquid crystal cell are twisted at an angle of from 90° to 360° and the product (Δnd) of the refractive anisotropy (Δn) of the rod-shaped liquid crystal molecules and the cell gap (d) is from 300 nm to 1,500 nm. For the optically compensatory sheet to be incorporated in STN type liquid crystal display, reference can be made to JP-A-2000-105316.

(VA Type Liquid Crystal Display)

The cellulose acylate film of the invention may be used as a support for optically compensatory sheet of VA type liquid crystal display having a VA mode liquid crystal cell. Re retardation value and Rth retardation value of the optically compensatory sheet to be incorporated in VA type liquid crystal display are preferably from 0 nm to 150 nm and from 70 nm to 400 nm, respectively. Re retardation value of the optically compensatory sheet is more preferably from 20 nm to 70 nm. In the case where the VA type liquid crystal display comprises two sheets of optically anisotropic polymer film incorporated therein, Rth retardation value of the optically anisotropic polymer film is preferably from 70 nm to 250 nm. In the case where the VA type liquid crystal display comprises one sheet of optically anisotropic polymer film incorporated therein, Rth retardation value of the optically anisotropic polymer film is preferably from 150 nm to 400 nm. The VA type liquid crystal display may be of a domain division type as disclosed in JP-A-10-123576.

(IPS Type Liquid Crystal Display)

The cellulose acylate film of the invention can be used as a support for optically compensatory sheet or polarizing plate protective film of IPS type liquid crystal display having an IPS mode liquid crystal cell to great advantage. In these modes, the liquid crystal molecules are aligned substantially parallel to the surface of the substrate during black display. When no voltage is applied to the liquid crystal, the liquid crystal molecules are aligned parallel to the surface of the substrate to make black display. In these embodiments, the polarizing plate comprising the cellulose acylate film of the invention contributes to the enhancement of viewing angle and the improvement of contrast. In this embodiment, the retardation value of the aforementioned protective film for polarizing plate and the optically anisotropic layer disposed between the protective film and the liquid crystal are preferably predetermined to twice or less Δn·d (difference in refractive index×thickness) of the liquid crystal layer. Since the absolute Rth value |Rth| is preferably predetermined to 20 nm or less, more preferably 15 nm or less, the cellulose acylate film of the invention can be used to advantage.

(OCB Type Liquid Crystal Display and HAN Type Liquid Crystal Display)

The cellulose acylate film of the invention may be used also as a support for optically compensatory sheet of OCB type liquid crystal display having an OCB mode liquid crystal cell or HAN type liquid crystal display having an HAN mode liquid crystal cell. The optically compensatory sheet to be incorporated in OCB type liquid crystal display or HAN type liquid crystal display preferably has no direction in which the absolute retardation value is minimum regardless of which it is in the plane of the optically compensatory sheet or normal to the optically compensatory sheet. The optical properties of the optically compensatory sheet to be incorporated in OCB type liquid crystal display or HAN type liquid crystal display are determined by the optical properties of the optically anisotropic layer, the optical properties of the support and the arrangement of the optically anisotropic layer and the support with respect to each other. For the details of the optically compensatory sheet to be incorporated in OCB type liquid crystal display or HAN type liquid crystal display, reference can be made to JP-A-9-197397. Reference can be made also to Mori et al, “Jpn. J. Appl. Phys.”, Vol. 38 (1999), p. 2,837.

(Reflection Type Liquid Crystal Display)

The cellulose acylate film of the invention can be used as an optically compensatory sheet for TN type, STN type, HAN type or GH (Guest-Host) type reflective liquid crystal display. These display modes have long been known. For the details of TN type reflective liquid crystal display, reference can be made to JP-A-10-123478, WO9848320 and Japanese Patent No. 3,022,477. For the details of the optically compensatory sheet to be incorporated in reflective liquid crystal display, reference can be made to WO00-65384.

(Other Liquid Crystal Displays)

The cellulose acylate film of the invention can be used also as a support for optically compensatory sheet of ASM type liquid crystal display having an ASM (Axially Symmetric Aligned Microcell) mode liquid crystal cell to advantage. An ASM mode liquid crystal cell is characterized in that the thickness of the cell is maintained by a positionable resin spacer. Other properties of ASM mode liquid crystal cell are the same as that of TN mode liquid crystal cell. For the details of ASM mode liquid crystal cell and ASM mode liquid crystal display, reference can be made to Kume et al., “SID98 Digest”, 1089, 1998.

(Hard Coat Film, Anti-Glare Film, Anti-Reflection Film)

The cellulose acylate film of the invention can be preferably applied also to hard coat film, anti-glare film or anti-glare film. For the purpose of enhancing the viewability of flat panel display such as LCD, PDP, CRT and EL, any or all of hard coat layer, anti-glare layer and anti-reflection layer can be added to either or both sides of the cellulose acylate film of the invention. For preferred embodiments of these anti-glare films and anti-reflection films, reference can be made to Kokai Giho 2001-1745, Japan Institute of Invention and Innovation, pp. 54-57, Mar. 15, 2001. The cellulose acylate film of the invention can be used as such to advantage.

(Support for Photographic Film)

The cellulose acylate film of the invention can be used also as a support for silver halide photographic material. To this end, the various materials, formulations and treatment methods disclosed herein can be applied. For the details of color negative among these techniques, reference can be made to JP-A-2000-105445. The cellulose acylate film of the invention can be used for this purpose to advantage. The cellulose acylate film of the invention can be used also as a support for color reversal silver halide photographic material to advantage. To this end, various materials, formulations and treatment methods disclosed in JP-A-11-282119 can be applied.

(Transparent Substrate)

The cellulose acylate film of the invention has substantially zero optical anisotropy and hence an excellent transparency and thus can be used as a substitute for liquid crystal cell glass in liquid crystal display, i.e., transparent substrate in which a driving liquid crystal is enclosed.

Since the transparent substrate in which a liquid crystal is enclosed needs to have excellent gas barrier properties, a gas barrier layer may be provided on the surface of the cellulose acylate film of the invention as necessary. The form and material of the gas barrier layer are not specifically limited. However, there can be proposed a method which comprises vacuum deposition of SiO2 or the like on at least one side of the cellulose acylate film of the invention or a method which comprises providing a polymer coat layer having relatively high gas barrier properties such as vinylidene chloride-based polymer and vinyl alcohol-based polymer layers. These methods may be properly employed. In order to use the cellulose acylate film of the invention as a transparent substrate in which a liquid crystal is enclosed, a transparent electrode for driving the liquid crystal by the application of voltage may be provided. The transparent electrode to be provided is not specifically limited. However, the transparent electrode can be provided by laminating a metallic film, metal oxide film or the like on at least one surface of the cellulose acylate film of the invention. Preferred among these films is metal oxide film from the standpoint of transparency, electrical conductivity and mechanical properties. In particular, a thin indium oxide film mainly composed of tin oxide containing zinc oxide in an amount of from 2% to 15% can be used to advantage. For the details of these techniques, reference can be made to JP-A-2001-125079 and JP-A-2000-227603.

The invention will be further described in the following examples, but the invention is not limited thereto. In the invention, as cellulose acetate there was used one derived from linter.

### EXAMPLE 1

(Preparation of Cellulose Acetate Solution)

The following compositions were charged in a mixing tank where they were then stirred so that the components were dissolved to make a cellulose acetate solution A. The cellulose acylate used had a total sulfuric acid content of 93 ppm and an alkaline earth metal content of 52 ppm.

(Formulation of Cellulose Acetate Solution A)

| | |
|---|---|
| Cellulose acetate having average acetylation degree | 110.0 parts by mass |
| of 61.5% | |
| Methylene chloride (first solvent) | 438.0 parts by mass |
| Methanol (second solvent) | 75.0 parts by mass |

(Formulation of Release Accelerator Solution)

| | |
|---|---|
| Release accelerator (citric acid methyl ethyl | 43.0 parts by mass |
| ester) | |
| Methylene chloride (first solvent) | 781.0 parts by mass |
| Methanol (second solvent) | 38.0 parts by mass |

(Preparation of Matting Agent Solution)

20 parts by mass of a particulate silica having an average particle diameter of 16 nm (AEROSIL R972, produced by NIPPON AEROSIL CO., LTD.) and 80 parts by mass of methanol were thoroughly mixed for 30 minutes to make a particulate silica dispersion. The dispersion was charged in a dispersing machine with the following compositions. The mixture was then stirred for 30 minutes or more so that the components were dissolved to prepare a matting agent solution.

(Formulation of Matting Agent Solution)

| | |
|---|---|
| Dispersion of particulate silica having average | 12.0 parts by mass |
| particle diameter of 16 nm | |
| Methylene chloride (first solvent) | 78.1 parts by mass |
| Methanol (second solvent) | 3.8 parts by mass |
| Cellulose acetate solution A | 11.3 parts by mass |

(Preparation of Additive Solution)

<Formulation of Additive Solution>

| | |
|---|---|
| Compound (A-19) having optical anisotropy | 49.1 parts by mass |
| Wavelength dispersion adjustor (UV-102) | 7.3 parts by mass |
| Methylene chloride (first solvent) | 57.8 parts by mass |
| Methanol (second solvent) | 8.1 parts by mass |
| Cellulose acetate solution A | 12.8 parts by mass |

(Preparation of Cellulose Ester Film 001)

93.8 parts by mass of the aforementioned cellulose acetate solution A, 9.3 parts by mass of the aforementioned release accelerator solution, 1.8 parts by mass of the aforementioned matting agent solution and 4.4 parts by mass of the additive solution were filtered, and then charged in a mixing tank where they were then heated with stirring so that they were dissolved to prepare a cellulose acetate dope 001. The dope 001 which had been adjusted to a temperature of 30° C. was then flow-casted over an endless stainless steel belt which had been heated with 29° C. (T2) hot air on the back side thereof. The dope film (web) thus flow-casted on the belt was blown with 20° C. (T1) hot air so that it was dried. After 35 seconds from flow casting, the web was then heated by blowing the belt with 45° C. (T4) hot air on the back side thereof while being dried with 45° C. (T3) hot air on the front side thereof. After 80 seconds from flow casting, the web was then peeled off the belt. The web thus peeled was then dried while feeding the web over a number of rolls. The temperature of the endless stainless steel belt at the peeling position was 15° C. The residual solvent content during peeling was 15% by mass. The film thus peeled was conveyed through a first drying zone which had been predetermined to a temperature of 45° C. for 1 minute, conveyed through a second drying zone which had been predetermined to a temperature of 80° C. for 30 seconds, and then conveyed through a third drying zone which had been predetermined to a temperature of 130° C. for 10 minutes so that it was dried. In the second drying zone, the film was crosswise retained at a rate of 1.00 by a tenter so that it was not stretched. The film thus dried was then wound in a rolled form to obtain a cellulose ester film 001 of the invention having a thickness of 82 μm. During winding, the film showed a residual solvent content of 0.4% by mass. The cellulose acylate film 001 thus obtained had a residual sulfuric acid content of 84 ppm and an alkaline earth metal content of 47 ppm.

(Evaluation of Peelability)

The cellulose acylate film thus prepared was observed for surface conditions under crossed nicols and the stainless steel band was observed to evaluate the peelability of the film.
P: Film is observed to have some unevenness in transmitted light at a constant interval, band is observed to have stain thereon;
F: Film is observed to have slight unevenness in transmitted light at a constant interval;
G: Film is observed to have no unevenness in transmitted light

### EXAMPLES 2 TO 7

(Preparation of Cellulose Acylate Films 002 to 007)

Cellulose acylate films 002 to 007 of the invention having properties set forth in Table 1 and a thickness of 80 μm were prepared in the same manner as in Example 1 except that the average acetylation degree, the total sulfuric acid content, the alkaline earth metal content, the kind and content of the compound for lowering optical anisotropy, the content of the wavelength dispersion adjustor and the kind and content of the release accelerator were as set forth in Table 1.

### COMPARATIVE EXAMPLES 1 TO 4

(Preparation of Cellulose Acylate Films 101 to 104)

Comparative cellulose acylate films 101 to 104 having properties set forth in Table 1 and a thickness of 80 gm were prepared in the same manner as in Example 1 except that the average acetylation degree, the total sulfuric acid content, the alkaline earth metal content, the kind and content of the compound for lowering optical anisotropy, the content of the wavelength dispersion adjustor and the kind and content of the release accelerator were as set forth in Table 1.

TABLE 1

| | Cellulose acetate | | | Film | | Optical | | | | | |
|---|---|---|---|---|---|---|---|---|---|---|---|
| | | Total | Alkaline | Total | Alkaline | anisotropy | Wavelength | | | | |
| | | sulfuric | earth | sulfuric | earth | decreasing | dispersion | Peel | | | |
| | % | acid | metal | acid | metal | agent | adjustor | accelerator | | | |
| | Acetylation | content | content | content | content | (% based | (% based | (ppm based | | Stability of | |
| No. | degree | (ppm) | (ppm) | (ppm) | (ppm) | on cotton) | on cotton) | on film) | Remarks | peelability | Durability |
| 001 | 61.3 | 93 | 52 | 84 | 47 | A-19 (13) | UV-102 (1) | c.m.e.e.*1 | Invent. | G | G |
| | | | | | | | | (100) | | | |
| 002 | 61.5 | 99 | 48 | 89 | 43 | A-9 (17) | UV-102 (1) | c.m.e.e. | Invent. | G | G |
| | | | | | | | | (100) | | | |
| 003 | 61.5 | 52 | 34 | 47 | 31 | A-19 (11) | UV-102 (1) | c.d.e.*2 | Invent. | G | G |
| | | | | | | | | (50) | | | |
| 004 | 61.8 | 98 | 42 | 88 | 38 | A-19 (12) | UV-102 (1) | c.d.e. (50) | Invent. | G | G |
| 005 | 61.8 | 57 | 39 | 51 | 35 | A-9 (17) | UV-102 (1) | c.d.e. (50) | Invent. | G | G |
| 006 | 62 | 39 | 24 | 35 | 22 | A-9 (17) | UV-102 (1) | c.d.e. (50) | Invent. | G | G |
| 007 | 62 | 94 | 89 | 85 | 80 | A-19 (5) | UV-102 (1) | c.e. | Invent. | G | G |
| | | | | | | | | mixture*3 | | | |
| | | | | | | | | (50) | | | |
| 101 | 60.8 | 90 | 44 | 81 | 40 | None | None | None | Compar. | P | G |
| 102 | 61.8 | 144 | 78 | 130 | 70 | A-19 (5) | UV-102 (1) | None | Compar. | F | F |
| 103 | 61.8 | 500 | 102 | 450 | 92 | None | None | None | Compar. | G | P |
| 104 | 62 | 109 | 92 | 98 | 83 | A-19 (10) | None | None | Compar. | P | G |

| | | | \|Re(400) − | \|Rth(400) − | Stability of | | |
|---|---|---|---|---|---|---|---|
| No. | Re(630) | Rth(630) | Re(700)\| | Rth(700)\| | peelability | Durability | Remarks |
| 001 | 0 | 1 | 2 | 13 | G | G | Inventive |
| 002 | 1 | −2 | 0 | 15 | G | G | Inventive |
| 003 | 0 | 1 | 1 | 12 | G | G | Inventive |
| 004 | 0 | −1 | 1 | 12 | G | G | Inventive |
| 005 | 0 | −3 | 1 | 14 | G | G | Inventive |
| 006 | 1 | −5 | 2 | 15 | G | G | Inventive |
| 007 | 1 | 7 | 1 | 13 | G | G | Inventive |
| 101 | 4 | 33 | 5 | 40 | P | G | Inventive |
| 102 | 3 | 7 | 1 | 13 | F | F | Comparative |
| 103 | 5 | 17 | 2 | 43 | G | P | Comparative |
| 104 | 1 | −7 | 2 | 20 | P | G | Comparative |

*1Citric acid methyl ethyl ester
*2Citric acid diethyl ester
*3Citric acid ester mixture (mixture of citric acid, citric acid monoethyl ester, citric acid diethyl ester and citric acid triethyl ester)

As can be seen in the results of Table 1 above, the cellulose acylate films 001 to 007 of the invention show a small retardation in the in-plane direction and thickness direction and a small wavelength dispersion of retardation, demonstrating that they are excellent in optical anisotropy. Further, they show a light peel load in the high volatile content range and hence excellent peelability and stability, demonstrating that they are excellent in productivity. It can be also seen that the films 001 to 007 of the invention are excellent in durability because they are made of cellulose acylate having a small residual sulfuric acid content. On the other hand, it can be seen that the comparative films 101 to 104 are poor in any of optical properties, peelability and durability.

### EXAMPLE 8

(Preparation of Polarizing Plate)

The cellulose acylate film 001 of the invention obtained in Example 1 was dipped in a 1.5 N aqueous solution of sodium hydroxide at 55° C. for 2 minutes. The film was washed in a rinsing bath at room temperature, and then neutralized with a 0.1 N sulfuric acid at 30° C. The film was again washed in a rinsing bath, and then dried with 100° C. hot air. Thus, the surface of the cellulose acylate film 001 was saponified.

Subsequently, a rolled polyvinyl alcohol film having a thickness of 80 μm was continuously stretched by a factor of 5 in an aqueous solution of iodine, and then dried to obtain a polarizing film. Two sheets of alkali-saponified cellulose acylate films 001 were then stuck to each other with a 3% aqueous solution of a polyvinyl alcohol (PVA-117H, produced by KURARAY CO., LTD.) with the polarizing film interposed therebetween to obtain a polarizing plate protected by the cellulose acylate film 001 on the both sides thereof. During this sticking procedure, arrangement was made such that the slow axis of the cellulose acylate film 001 is disposed parallel to the transmission axis of the polarizing film. Similarly, the inventive samples 002 to 007 and the comparative samples 101 to 104 were used to prepare polarizing plates. All the cellulose acylate film samples 001 to 007 and the comparative samples 101 to 104 showed a sufficient stickability to the stretched polyvinyl alcohol and an excellent adaptability to production of polarizing plate.

### COMPARATIVE EXAMPLE 5

A polarizing plate was prepared in the same manner as in Example 8 except that the polarizing film was protected by two sheets of Type Panlite C1400 commercially available polycarbonate film (produced by TEIJIN LIMITED) instead of two sheet of the inventive cellulose acylate film. However, the polycarbonate film showed an insufficient stickability to the stretched polyvinyl alcohol. The polyvinyl carbonate film couldn't act as a protective film for polarizing film, leaving something to be desired in adaptability to production of polarizing plate.

### COMPARATIVE EXAMPLE 6

A polarizing plate was prepared in the same manner as in Example 8 except that the polarizing film was protected by two sheets of Arton Film having a thickness of 80 μm (produced by JSR) instead of two sheet of the inventive cellulose acylate film. However, Arton Film showed an insufficient stickability to the stretched polyvinyl alcohol. Arton Film couldn't act as a protective film for polarizing film, leaving something to be desired in adaptability to production of polarizing plate.

### EXAMPLE 9

(Durability of Polarizing Plate)

The polarizing plates comprising the inventive cellulose acylate films 001 to 007 and the comparative samples 101 to 104 prepared in Example 8 were each allowed to stand at 60C-95% RH for 500 hours, and then evaluated for polarization. As a result, the polarizing plates comprising the samples 001 to 007, 101 and 104 showed a good durability.

However, the polarizing plate comprising the sample 103 showed a deteriorated durability. This is presumably because the sample 103 had an excessive residual sulfuric acid content as set forth in Table 1 above. The sample 102, too, showed some deterioration in durability.

### EXAMPLE 10

(Evaluation for Mounting on IPS Type Liquid Crystal Display)

The polarizing plates comprising the cellulose acylate films (Samples 001 to 007) obtained in Examples 1 to 7 and the cellulose acylate films obtained in Example 8 were each mounted on a liquid crystal display on which they were then evaluated for optical properties such as viewability and viewing angle dependence. As a result, it was confirmed that these samples have sufficient optical properties.

While the invention has been described with reference to the case where an IPS type liquid crystal cell was used and will be described with reference to the case where VA and OCB type liquid crystal cells were used, the purpose of the polarizing plates or optically compensatory films comprising cellulose acylate films of the invention is not limited by the operation mode of the liquid crystal display.

### EXAMPLE 11

(Evaluation for Mounting on VA and OCB Type Liquid Crystal Displays)

The cellulose acylate film samples (Samples 001 to 007) of the invention obtained in Examples 1 to 7 were evaluated on the liquid crystal display disclosed in Example 1 of JP-A-10-48420, the optically anisotropic layer comprising a discotic liquid crystal molecule and the alignment layer having a polyvinyl alcohol spread thereover disclosed in Example 1 of JP-A-9-26572, the VA type liquid crystal display shown in FIGS. 2 to 9 of JP-A-200-154261 and the OCB type liquid crystal display shown in FIGS. 10 to 15 of JP-A-2000-154261. As a result, all the arrangements showed good contrast viewing angle properties.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-262186 filed Sep. 9 of 2005, the contents of which are incorporated herein by reference.

What is claimed is:

1. A cellulose acylate film comprising a release accelerator in an amount of 10 ppm to 2,000 ppm, wherein the cellulose acylate film has a residual sulfuric acid content of 0 ppm to 100 ppm, and the cellulose acylate film satisfies relationships (I) and (II):
0≦Re(630)≦10 and |Rth(630)|≦25 (I)

|Re(400)−Re(700)|≦10 and |Rth(400)−Rth(700)|≦35 (II)
wherein Re(λ) is an in-plane retardation value at a wavelength of λ nm; and Rth(λ) is a thickness-direction retardation value at a wavelength of λ nm.

2. The cellulose acylate film according to claim 1, which has an alkaline earth metal content of 1 ppm to 60 ppm.

3. The cellulose acylate film according to claim 1, which is formed from a cellulose acylate having a residual sulfuric acid content of 0 ppm to 110 ppm.

4. The cellulose acylate film according to claim 1, which is formed from a cellulose acylate having an average acetylation degree of 61.0% to 62.5%.

5. The cellulose acylate film according to claim 1, which is formed from a cellulose acylate made of cotton linter.

6. The cellulose acylate film according to claim 1, comprising at least one compound satisfying relationships (III) and (IV):
(Rth(A)−Rth(0))/A≦−1.0 (III)
0.1≦A≦30 (IV)
wherein Rth(A) is Rth(630) of a film containing a compound lowering Rth in an amount of A % by weight; Rth(0) is Rth(630) of a film free of the compound flowering Rth; and A is a content of the compound lowering Rth based on a weight of a raw material polymer of the cellulose acylate film.

7. An optically compensatory film comprising: a cellulose acylate film according to claim 1; and an optically anisotropic layer having Re(630) of 0 nm to 200 nm and |Rth(630)| of 0 nm to 400 nm.

8. The optically compensatory film according to claim 7, wherein the optically anisotropic layer comprises a layer formed from a discotic liquid crystal compound.

9. The optically compensatory film according to claim 7, wherein the optically anisotropic layer comprises a layer formed from a rod-shaped liquid crystal compound.

10. The optically compensatory film according to claim 7, wherein the optically anisotropic layer comprises a polymer film.

11. A polarizing plate comprising: a polarizer; and a protective film of a cellulose acylate film according to claim 1.

12. The polarizing plate according to claim 11, comprising at least one of a hard coat layer, an anti-glare layer and an anti-reflection layer.

13. A liquid crystal display comprising a cellulose acylate film according to claim 1.

14. The liquid crystal display according to claim 13, which is one of a VA mode liquid crystal display and an IPS mode liquid crystal display.
